(19) United States
(12) Patent Application Publication
(10) Pub. No.: US 2013/0002948 A1
(43) Pub. Date: Jan. 3, 2013

(54) DISPLAY DEVICE AND TELEVISION RECEIVER

(75) Inventor: Yoshiki Takata, Osaka-shi (JP)

(73) Assignee: SHARP KABUSHIKI KAISHA, Osaka-shi, Osaka (JP)

(21) Appl. No.: 13/581,004

(22) PCT Filed: Jan. 24, 2011
(86) PCT No.: PCT/JP2011/051171

§ 371 Date: Aug. 24, 2012

(30) Foreign Application Priority Data
Feb. 26, 2010 (JP) 2010-041445

(51) Int. Cl. F21V 8/00; H04N 5/44; H04N 7/01; G02F 1/13357

(52) U.S. Cl. 348/453; 362/602; 349/65; 348/725; 348/E05.096; 348/E07.003

(57) ABSTRACT

It is an object of the present invention to obtain high brightness and appropriately correct the chromaticity of a display image, based on the configuration of a lighting device. A liquid crystal display device 10 includes: a liquid crystal panel 11 including a pair of substrates 11a and 11b with a liquid crystal layer 11c between, of which optical characteristics vary by application of an electric field; and a backlight unit 12 that emits light toward the liquid crystal panel 11. The backlight unit 12 includes a light guide member 26 having an end opposed to light sources 24 or 31. Light from the light sources 24 or 31 is guided toward the liquid crystal panel 11 through the light guide member 26. The liquid crystal panel 11 includes a CF substrate 11a including a color filter 19 constituted by a plurality of color sections R, G, B, and Y exhibiting the respective colors of blue, green, red, or yellow. The blue color section B or the red color section R has relatively large areas compared to the yellow color section Y or the green color section G.

### TECHNICAL FIELD

The present invention relates to a display device and a television receiver.

### BACKGROUND ART

Generally, a liquid crystal panel as a main component of a liquid crystal display device includes a pair of glass substrates between which liquid crystal is sealed in. One of the glass substrates is an array substrate on which active elements, such as TFTs, are provided. The other substrate is a CF substrate on which a color filter and the like are provided. On an inner surface of the CF substrate opposed to the array substrate, a color filter including a plurality of color sections corresponding to the respective colors of red, green, or blue is formed. The color sections are arranged side by side correspondingly to the respective pixels of the array substrate. Between the color sections, a light blocking layer preventing mixing of the colors is provided. Light emitted by a backlight and transmitted through the liquid crystal has its wavelength selectively transmitted through the corresponding red, green, or blue color section in the color filter such that an image can be displayed on the liquid crystal panel.

In order to enhance the display quality of the liquid crystal display device, it is effective to increase color reproducibility. For this purpose, another color, such as yellow, may be included in the color sections in the color filter, in addition to the red, green, and blue as the three primary colors of light. However, for the color sections with such four colors, the number of sub-pixels constituting each pixel increases from three to four. As a result, the area of the individual sub-pixels decreases, resulting in problems such as a decrease in the color lightness of red light in particular. In order to overcome such problems, Patent Document 1 proposes increasing the area ratio of the red color section compared to the others of the four color sections, thereby to restrain the decrease in color lightness of the red light.
Patent Document 1: WO2007/148519

### PROBLEM TO BE SOLVED BY THE INVENTION

While Patent Document 1 provides a detailed analysis of the area ratio of the four-color color sections, the analysis does not include a sufficient discussion in view of the configuration of a backlight unit. Specifically, there are substantially two types of backlight unit, a direct type and an edge light type. Depending on the type, the constituent components to be used (particularly the constituent components of the optical system) differ from each other. In addition, there are various types of light sources, including an LED and a cold cathode tube. The effects such different constituent components or the various types of light sources may have on the brightness or chromaticity of a display image have not been sufficiently analyzed.

### DISCLOSURE OF THE PRESENT INVENTION

The present invention was made in view of the foregoing circumstances, and it is an object of the present invention to obtain high brightness and appropriately correct chromaticity of the display image, based on the configuration of the lighting device.

### MEANS FOR SOLVING THE PROBLEM

A display device according to the present invention includes a display panel including a pair of substrates with a substance between. The substance has optical characteristics that vary according to application of an electric field. The display device further includes a lighting device including a light source and configured to emit light toward the display panel. The lighting device includes a light guide member with an end opposed to the light source. The light guide member is configured to guide the light from the light toward the display panel. One of the substrates in the display panel includes a color filter including a plurality of respective blue, green, red, and yellow color sections, of which the blue or red color section has a relatively large area compared to the yellow or green color section.

Thus, the color filter is formed on one of the pair of substrates in the display panel, and the color filter includes the yellow color section in addition to the blue, green, and red color sections as the three primary colors of light. Thus, the color reproduction range that the human eye can perceive, i.e., the color gamut, can be expanded, and also the color reproducibility for the object color in the natural world can be increased, thereby improved display quality can be obtained. In addition, the light through the yellow color section of the color sections included in the color filter has a wavelength close to the peak of luminosity factor. Therefore, such light tends to be perceived by the human eye as being bright, i.e., as having high brightness, even when the amount of energy of the light is small. Thus, sufficient brightness can be obtained even when the output of the light sources is restrained, reducing the electric power consumption by the light sources thereby to achieve superior environmental friendliness. In other words, the resulting high brightness can be utilized for providing a sharp sense of contrast, leading to further improvement in display quality.

On the other hand, when the yellow color section is included in the color filter, the transmitted light from the display panel, i.e., the display image, tends to have yellowishness as a whole. In order to avoid this, the chromaticity of the light sources used in the backlight unit may be adjusted toward blue as a complementary color to yellow to correct the chromaticity of the display image. However, a research by the present inventor indicates that, when the chromaticity of the light sources is adjusted in accordance with the display panel having the yellow color section, sufficient brightness may not be obtained depending on the type of the light sources, due to compatibility regarding such as the chromaticity and brightness characteristics of the light sources or spectral characteristics with respect to the display panel. In addition, a further research by the present inventor indicates that the problem may be exacerbated when, as the backlight unit for irradiating the display panel with light, the so-called edge light type is used, which includes the light guide member with the end opposed to the light sources. Namely, in the edge light backlight unit, compared to the direct backlight unit, the optical path length of the light emitted from the light sources to the liquid crystal panel is long. During this process, the light may be absorbed by the light guide member as the light travels therein. Therefore, a decrease in brightness may occur. In addition, the light guide member generally has yellowishness, although very little. For this reason, as the light from the light sources becomes yellowish after transmitting through the light guide member, and the transmitted yellowish light, and the display panel with the yellow color section is irradiated with the yellowish light. Thus, in order to correct the chromaticity of the display image, the chromaticity of the light sources needs to be further adjusted toward blue, possibly resulting in a further decrease in brightness due to chromaticity adjustment.

In view of the above problems, according to the present invention, with regard to the color sections included in the color filter, the blue or red color section has relatively large area compared to the yellow or green color section. In this way, the light through the color filter in the display panel tends to contain relatively more of blue light than yellow or green light. Thus, the configuration allows the color filter to transmit relatively more of blue light, which is the complementary color to yellow, to restrain the tone of the display image with yellowishness even when the light from the light sources becomes more or less yellowish after through the light guide member. Accordingly, the chromaticity of the light sources does not need to be adjusted toward blue for correcting the chromaticity of the display image. As a result, the decrease in brightness of transmitted light due to chromaticity adjustment of the light sources can be restrained. In this way, the various light sources with different chromaticity and brightness characteristics or spectral characteristics can be suitably used in the backlight unit, and thereby higher configurational freedom in designing the backlight unit, for example, can be obtained.

Further, according to the above configuration, the transmitted light through the color filter in the liquid crystal panel tends to contain relatively more red light than yellow or green light. Therefore, the decrease in color lightness of red light, which may be caused by using the four-color type of the display panel, can be restrained.

Preferable embodiments of the present invention may include the following configurations.

(1) The blue or red color section may have an area ratio in the range of 1.1 to 2.0 to the yellow or green color section. When the area ratio of the blue or red color section is less than 1.1, the brightness in the case where the cold cathode tube is used as the light source may become too low. When the area ratio is larger than 2.0, the brightness in the case where the LED is used as the light source may become too low. According to the present invention, the area ratio in the range of 1.1 to 2.0 may result in high brightness whichever the LED or the cold cathode tube is used as the light source.

(2) The area ratio may be in the range of 1.1 to 1.62. In the liquid crystal panel according to the present invention, the optical characteristics of the substance between the substrates vary by applying an electric field to control the transmittance of light with respect to the respective color sections. For example, when the area ratio of the blue or red color section is greater than 1.62, control of the transmittance may become difficult. In addition, when the area ratio is greater than 1.62, brightness may decrease when the LED is used as the light source. According to the present invention, by limiting the area ratio within the range of 1.1 to 1.62, the transmittance of light with respect to the respective color sections can be appropriately controlled, and the LED can be suitably used as the light source.

(3) The area ratio may be in the range of 1.3 to 1.62. In this way, higher brightness can be obtained whichever the LED or the cold cathode tube is used as the light source.

(4) The area ratio may be in the range of 1.5 to 1.6. In this way, extremely high brightness can be obtained when the LED is used as the light source. Further, sufficiently high brightness can be obtained when the cold cathode tube is used as the light source.

(5) The area ratio may be 1.6. In this way, extremely high brightness can be obtained whichever the LED or the cold cathode tube is used as the light source. Further, the display panel can be advantageously designed.

(6) The area ratio may be 1.5. In this way, the highest brightness can be obtained when the LED is used as the light source.

(7) The area ratio may be in the range of 1.4 to 1.5. In this way, substantially the same brightness can be obtained whichever the LED or the cold cathode tube is used as the light source.

(8) The area ratio may be 1.46. In this way, the same level of brightness can be obtained whichever LED or the cold cathode tube is used as the light source.

(9) The area ratio may be in the range of 1.1 to 1.46. In this way, relatively high brightness can be obtained when the LED is used as the light source compared to when the cold cathode tube is used as the light source.

(10) The area ratio may be in the range of 1.46 to 2.0. In this way, relatively high brightness can be obtained when the cold cathode tube is used as the light source compared to when the LED is used as the light source.

(11) The area ratio may be 2.0. In this way, the highest brightness can be obtained when the cold cathode tube is used as the light source.

(12) The area of the blue color section may be the same as the area of the red color section. In this way, the capacitance formed between the substrates can be made substantially the same in both the blue and red color sections. As a result, the optical characteristics of the substance between the substrates can be more easily controlled by the application of an electric field. Thus, the transmittance of light with respect to the blue or red color section can be more easily controlled, thereby to provide an extremely simple circuit design of the display panel with high color reproducibility.

(13) The area of the yellow color section may be the same as the area of the green color section. In this way, in both the yellow and green color sections, the capacitance formed between the substrates can be made substantially the same. Thus, the optical characteristics of the substance between the substrates can be more easily controlled by application of an electric field. Accordingly, the transmittance of light with respect to the yellow or green color section can be more easily controlled, thereby to provide an extremely simple circuit design of the display panel with high color reproducibility.

(14) The respective color sections may have substantially the same film thickness. In this way, the capacitance formed between the substrates becomes substantially the same among the color sections with same area. Therefore, the optical characteristics of the substance between the substrates can be more easily controlled by application of an electric field. Accordingly, the transmittance of light with respect to the respective color sections can be more easily controlled, thereby to provide an extremely simple circuit design of the liquid crystal panel with high color reproducibility.

(15) The light source may be a cold cathode tube. In this way, when adjusting chromaticity of the cold cathode tube in accordance with the display panel having the yellow color section, the chromaticity of the cold cathode tube can be shifted more toward yellow, which is the complementary color to blue, as the area ratio of the blue or red color section to the yellow or green color section is increased. In this way, the decrease in brightness due to chromaticity adjustment of the cold cathode tube can be restrained. Further, cost reduction can be achieved compared to the case where the LED is used as the light source.

(16) The light source may be an LED. In this way, when chromaticity adjustment of the LED is performed in accordance with the display panel having the yellow color section, the chromaticity of the LED can be shifted more toward yellow, which is the complementary color of blue, as the area ratio of the blue or red color section to the yellow or green color section is increased. In this way, the decrease in brightness due to the chromaticity adjustment of the LED can be restrained. Further, electric power consumption can be reduced compared to the case where the cold cathode tube is used as the light source, for example.

(17) The LED may include an LED element as the light emitting source and a phosphor emitting light upon excitation by the light from the LED element. Thus, by appropriately adjusting the type, amount, or the like of the phosphor included in the LED, the chromaticity of the LED can be finely adjusted and thereby made more adapted to the display panel having the yellow color section.

(18) The LED element may include a blue LED element emitting blue light, whereas the phosphor may include at least one of a green phosphor emitting green light upon excitation by the blue light and a yellow phosphor emitting yellow light upon excitation by the blue light, and a red phosphor emitting red light upon excitation by the blue light. In this way, the LED as a whole can emit a predetermined color based on the blue light emitted by the blue LED element, at least one of the green light emitted by the green phosphor upon excitation by the blue light from the blue LED element and the yellow light emitted by the yellow phosphor upon excitation by the blue light from the blue LED element, and the red light emitted by the red phosphor upon excitation by the blue light from the blue LED element. In this configuration of the LED, blue light can be emitted with extremely high efficiency because of the use of the blue LED element as the light emitting source. Thus, the chromaticity of the LED can be adjusted toward blue in accordance with the display panel having the yellow color section without much decrease in brightness, and therefore, high brightness can be maintained.

(19) At least one of the green and yellow phosphors may be a SiAlON-based phosphor. By thus using a SiAlON-based phosphor, which is a nitride, in at least one of the green phosphor and the yellow phosphor, high efficiency of light emission can be obtained compared to the case where, for example, a sulfide or oxide phosphor is used. In addition, the light emitted by a SiAlON-based phosphor has high color purity compared to a YAG-based phosphor, for example. Therefore, chromaticity adjustment of the LED can be more easily performed.

(20) The green phosphor may be a β-SiAlON. In this way, green light can be emitted with high efficiency. In addition, the light emitted by a β-SiAlON has particularly high color purity. Therefore, the chromaticity adjustment of the LED can be even more easily performed.

The β-SiAlON uses Eu (europium) as an activator and is expressed by the general formula, Si6-zAlzOzN8-z:Eu (z is the amount of solid solution).

(21) The yellow phosphor may be an α-SiAlON. In this way, yellow light can be emitted with high efficiency.

The α-SiAlON uses Eu (europium) as an activator and is expressed by the general formula, Mx(Si, Al)12(O, N)16:Eu (M is a metal ion and x is the amount of solid solution).

(22) The red phosphor may be a CASN-based phosphor. Thus, because a CASN-based phosphor, which is a nitride, may be used as the red phosphor, red light can be emitted with high efficiency compared to the case where, for example, a sulfide or oxide phosphor is used.

(23) The red phosphor may be a CASN (CaAlSiN3:Eu). In this way, red light can be emitted with high efficiency.

(24) At least one of the green and yellow phosphors may be a YAG-based phosphor. Thus, a YAG-based phosphor may be used as at least one of the green and yellow phosphors. Therefore, extremely high brightness of the LED can be obtained compared to the case where other types of phosphor are used.

The YAG-based phosphor may have a garnet structure including a complex oxide of yttrium and aluminum and expressed by the chemical formula: Y3Al5O12, with a rare-earth element (such as Ce, Tb, Eu, or Nd) used as an activator. The YAG-based phosphor may have a part or all of the Y site of the chemical formula: Y3Al5O12 substitutable by Gd, Tb, or the like, or a part of the Al site thereof substitutable by Ga or the like. Therefore, the dominant emission wavelength of the YAG-based phosphor can be appropriately adjusted.

Concrete examples of the YAG-based phosphor include Y3Al5O12:Ce, Y3Al5O12:Tb, (Y, Gd)3Al5O12:Ce, Y3(Al, Ga)5O12:Ce, Y3(Al, Ga)5O12:Tb, (Y, Gd)3(Al, Ga)5O12:Ce, (Y, Gd)3(Al, Ga)5O12:Tb, and Tb3Al5O12:Ce.

(25) The yellow phosphor may be a BOSE-based phosphor. Thus, as the yellow phosphor, a BOSE-based phosphor including barium and strontium may be used.

(26) The light guide member may include an elongated light entrance surface on an end facing the LED. The LED may include a lens member covering the light output side of the LED and diffusing light. The lens member may be opposed to the light entrance surface of the light guide member and curved along the longitudinal direction of the light entrance surface to be convex toward the light guide member. In this way, the light emitted by the LED is caused to spread by the lens member in the longitudinal direction of the light entrance surface to reduce dark portions that could be formed at the light entrance surface of the light guide member. Thus, even when the distance between the LED and the light guide member is short and the number of the LED is small, light with uniform brightness can be incident on over the entire light entrance surface of the light guide member.

(27) The color filter may be configured such that the chromaticity of blue, green, red, or yellow transmitted light obtained by passing the light from the light source through the color sections in the color filter is outside a common region of a NTSC chromaticity region according to the NTSC standard and a EBU chromaticity region according to a EBU standard in at least one of a CIE1931 chromaticity diagram and a CIE1976 chromaticity diagram. In this way, the common region can be substantially contained in the chromaticity region of the transmitted light to ensure sufficient color reproducibility.

The “NTSC chromaticity region according to the NTSC standard” indicates a region within a triangle with the vertices at the three points in which the values of (x, y) are located at (0.14, 0.08), (0.21, 0.71), and (0.67, 0.33) in the CIE1931 chromaticity diagram, and a region within a triangle with the vertices at the three points in which the values of (u′, v′) are located (0.0757, 0.5757), (0.1522, 0.1957), and (0.4769, 0.5285) in the CIE1976 chromaticity diagram.

The “EBU chromaticity region according to the EBU standard” indicates a region within a triangle with the vertices at the three points in which the values of (x, y) are located of (0.15, 0.06), (0.3, 0.6), and (0.64, 0.33) in the CIE1931 chromaticity diagram, and a region within a triangle with the vertices at the three points in which the values of (u′, v′) are located of (0.1250, 0.5625), (0.1754, 0.1579), and (0.4507, 0.5229) in the CIE1976 chromaticity diagram.

The “common region” indicates a region within a quadrangle with the vertices at the four points in which the values of (x, y) are located of (0.1579, 0.0884), (0.3, 0.6), (0.4616, 0.2317), and (0.64, 0.33) in the CIE1931 chromaticity diagram, and a region within a quadrangle with the vertices at the four points in which the values of (u′, v′) are located of (0.125, 0.5625), (0.1686, 0.2125), (0.3801, 0.4293), and (0.4507, 0.5229) in the CIE1976 chromaticity diagram.

(28) The light guide member may include an elongated light entrance surface on an end facing the light source. The lighting device may include a reflection sheet between the light source and the light guide member along the longitudinal direction of the light entrance surface. In this way, the light emitted by the light source can be reflected by the reflection sheets to be incident on the light entrance surface of the light guide member efficiently. Thus, the efficiency with which the light emitted by the light source is incident on the light guide member can be increased.

(29) The light guide member may include a substance with a refractive index higher than that of air. In this way, the light entering into the light guide member from the light source can be efficiently caused to travel toward the display panel.

(30) The display panel may be a liquid crystal panel including liquid crystal as the substance of which the optical characteristics vary by application of an electric field. In this way, the display panel can be used for various purposes, such as for television or personal computer displays, particularly for large screens.

In order to solve the problem, a television receiver according to the present invention includes the display device and a reception unit configured to receive a television signal.

According to the television receiver, the display device that displays a television image on the basis of the television signal is configured to appropriately correct the chromaticity of the display image while high brightness is obtained. Therefore, excellent display quality of the television image can be obtained.

In addition, the television receiver may include an image conversion circuit converting the television image signal output from the reception unit into an image signal for the respective colors of red, green, blue, or yellow. Thus, the television image signal is converted by the image conversion circuit into the image signals for respective colors corresponding to the respective color sections R, G, B, or Y of the red, green, blue, or yellow included in the color filter. Therefore, the television image can be displayed with high display quality.

### ADVANTAGEOUS EFFECT OF THE INVENTION

According to the present invention, the chromaticity of the display image can be appropriately corrected while high brightness is obtained based on the configuration of the lighting device.

### BRIEF DESCRIPTION OF THE DRAWINGS

FIG. 1 is a an exploded perspective view illustrating a schematic configuration of a television receiver according to the first embodiment of the present invention;

FIG. 2 is a cross sectional view illustrating a cross sectional configuration of a liquid crystal panel along a long side direction;

FIG. 3 is a cross sectional view illustrating a cross sectional configuration of the liquid crystal panel along a short side direction;

FIG. 4 is an enlarged plan view illustrating a planar configuration of an array substrate;

FIG. 5 is an enlarged plan view illustrating a planar configuration of a CF substrate;

FIG. 6 is an exploded perspective view illustrating a schematic configuration of a liquid crystal display device with an edge light backlight unit using an LED as a light source;

FIG. 7 is a cross sectional view illustrating a cross sectional configuration of the liquid crystal display device of FIG. 6 along a short side direction;

FIG. 8 is a cross sectional view illustrating a cross sectional configuration of the liquid crystal display device along a long side direction;

FIG. 9 is an enlarged perspective view of an LED board;

FIG. 10 is an exploded perspective view illustrating a schematic configuration of a liquid crystal display device with an edge light backlight unit using a cold cathode tube as a light source;

FIG. 11 is a cross sectional view illustrating a cross sectional configuration of the liquid crystal display device of FIG. 10 along the short side direction;

FIG. 12 is a cross sectional view illustrating a cross sectional configuration of the liquid crystal display device of FIG. 10 along the long side direction;

FIG. 13 is a CIE1931 chromaticity diagram illustrating the relationship between chromaticity and brightness of the LED;

FIG. 14 is a CIE1931 chromaticity diagram illustrating the relationship between chromaticity and brightness of the cold cathode tube;

FIG. 15 is a graph illustrating the relationship between the area ratio of red or blue color section to yellow or green color section and the brightness of the transmitted light from the liquid crystal panel, according to the first and second experiment examples;

FIG. 16 is a CIE1931 chromaticity diagram illustrating the respective chromaticity coordinates of Table 1 and Table 2 (the first experiment example);

FIG. 17 is a CIE1976 chromaticity diagram illustrating the respective chromaticity coordinates of Table 1 and Table 2 (the first experiment example);

FIG. 18 is a CIE1931 chromaticity diagram illustrating the respective chromaticity coordinates of Table 1 and Table 3 (the second experiment example);

FIG. 19 is a CIE1976 chromaticity diagram illustrating the respective chromaticity coordinates of Table 1 and Table 3 (the second experiment example);

FIG. 20 is a graph illustrating the relationship between the area ratio of the red or blue color section to the yellow or green color section and the brightness of the transmitted light from the liquid crystal panel, according to the third and fourth experiment examples;

FIG. 21 is an exploded perspective view illustrating a schematic configuration of a liquid crystal display device with a direct backlight unit using an LED as a light source;

FIG. 22 is a plan view of a chassis of the backlight unit of FIG. 21;

FIG. 23 is a cross sectional view illustrating a cross sectional configuration of the liquid crystal display device of FIG. 21 along the long side direction;

FIG. 24 is a cross sectional view illustrating a cross sectional configuration of the liquid crystal display device of FIG. 21 along the short side direction;

FIG. 25 is an exploded perspective view illustrating a schematic configuration of a liquid crystal display device with a direct backlight unit using a cold cathode tube as a light source;

FIG. 26 is a cross sectional view illustrating a cross sectional configuration of the liquid crystal display device of FIG. 24 along the short side direction;

FIG. 27 is a cross sectional view illustrating a cross sectional configuration of the liquid crystal display device of FIG. 24 along the long side direction;

FIG. 28 is an enlarged plan view illustrating a planar configuration of a CF substrate according to the first modification of the first embodiment;

FIG. 29 is an enlarged plan view illustrating a planar configuration of an array substrate;

FIG. 30 is an enlarged plan view illustrating a planar configuration of the CF substrate according to the second modification of the first embodiment;

FIG. 31 is an enlarged plan view illustrating a planar configuration of the CF substrate according to the third modification of the first embodiment;

FIG. 32 is an exploded perspective view of a liquid crystal display device according to the third embodiment of the present invention; and

FIG. 33 is a horizontal cross sectional view of the liquid crystal display device.

### BEST MODE FOR CARRYING OUT THE INVENTION

### First Embodiment

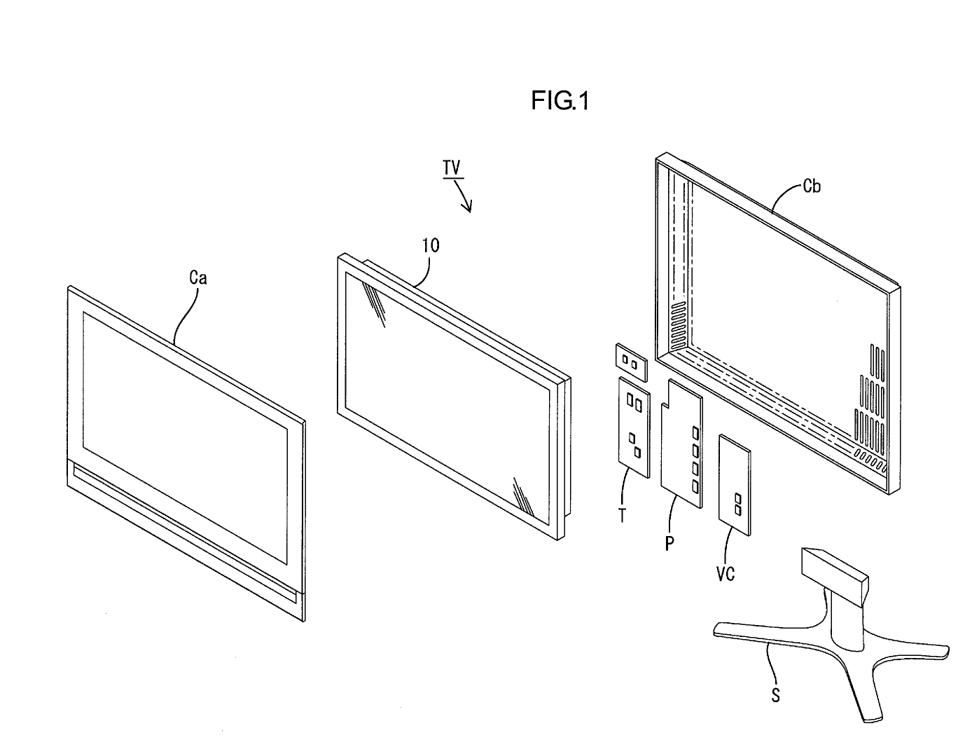

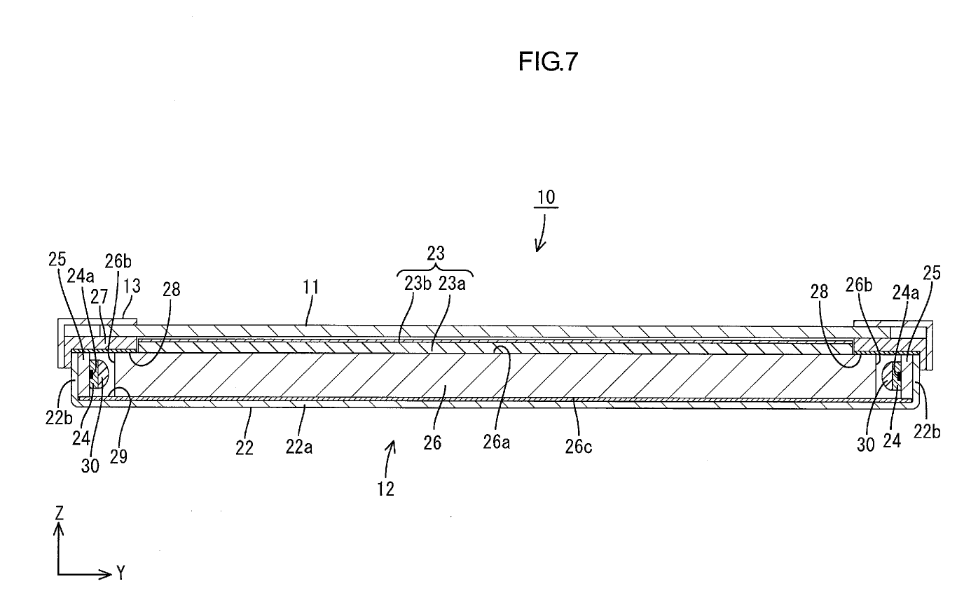

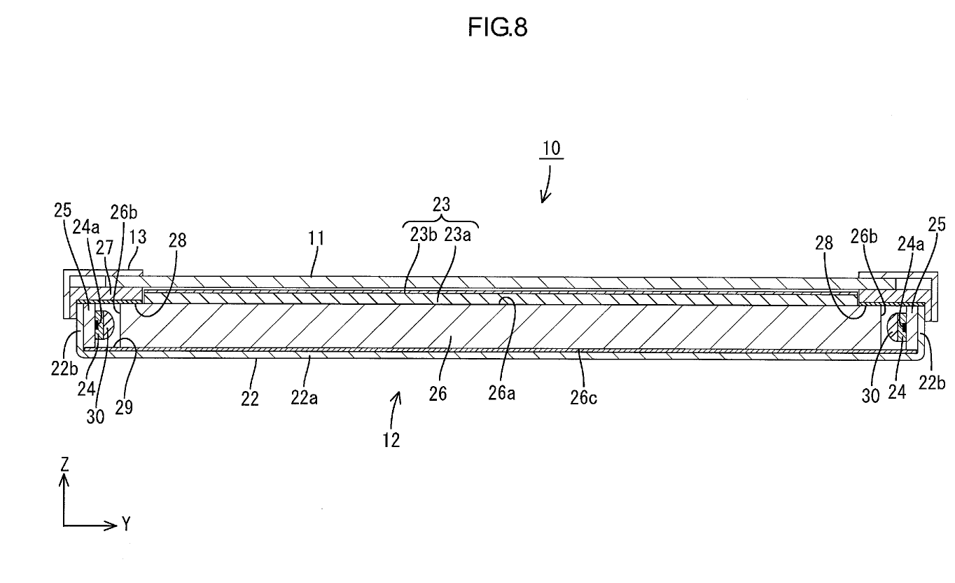

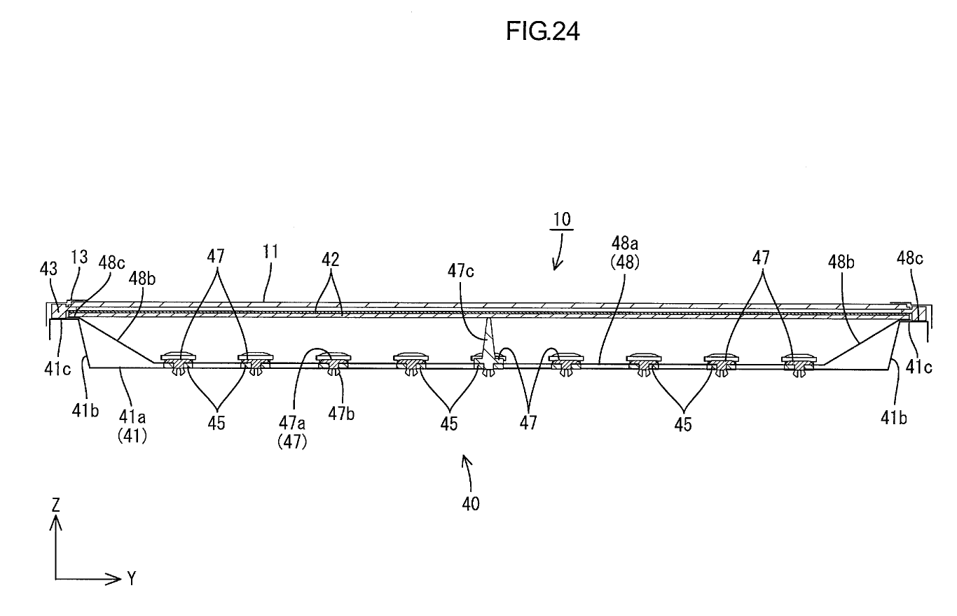

A first embodiment of the present invention will be described with reference to FIGS. 1 to 27. According to the present embodiment, a liquid crystal display device 10 will be described by way of example. In some parts of the drawings, an X-axis, a Y-axis, and a Z-axis are shown as the respective axial directions corresponding to the directions shown in the respective drawings. The upper side and the lower side shown in FIGS. 7, 8, 11, and 12 correspond to the front side and the rear side, respectively.

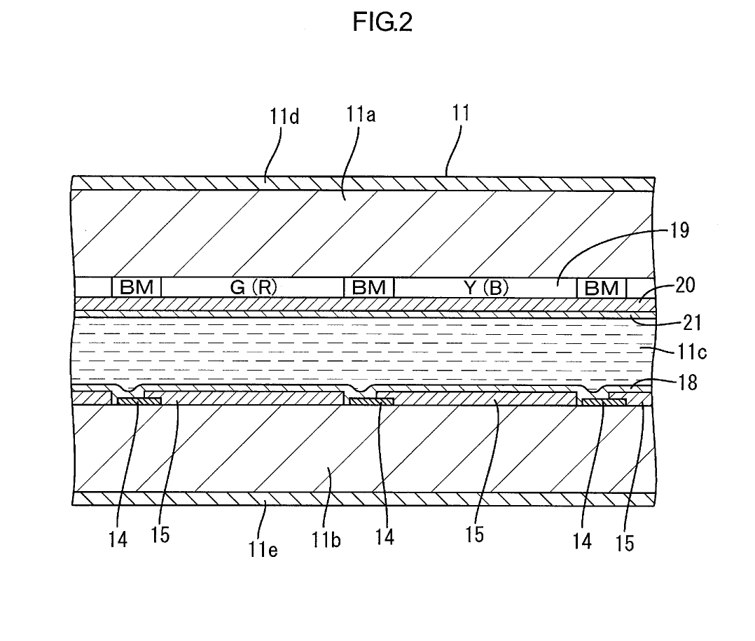

A television receiver TV according to the present embodiment, as shown in FIG. 1, includes the liquid crystal display device 10; front and rear cabinets Ca and Cb housing the liquid crystal display device 10 in a sandwiching manner; a power supply circuit board P supplying electric power; a tuner (reception unit) T configured to receive a television image signal; an image conversion circuit board VC converting the television image signal output from the tuner T into an image signal for the liquid crystal display device 10; and a stand S. The liquid crystal display device (display device) 10 as a whole has a horizontally long (elongated) square shape (rectangular shape). The liquid crystal display device 10 is housed with its long side direction and short side direction substantially aligned with the horizontal direction (X-axis direction) and the vertical direction (Y-axis direction; perpendicular direction), respectively. The liquid crystal display device 10, as shown in FIG. 2, includes a liquid crystal panel 11 as a display panel and a backlight unit (lighting device) 12 as an external light source, which are integrally held by a frame-shaped bezel 13 or the like.

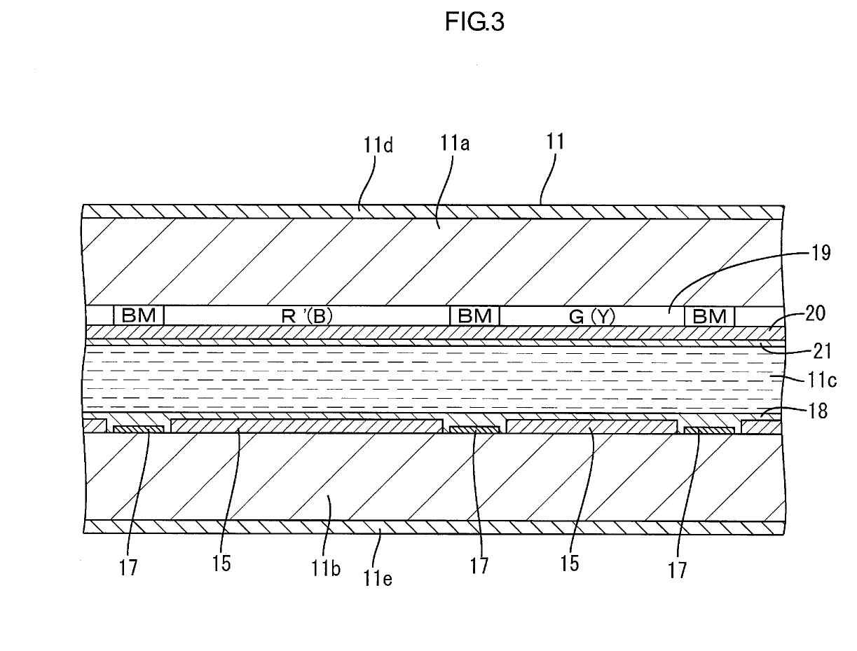

A configuration of the liquid crystal panel 11 of the liquid crystal display device 10 will be described. The liquid crystal panel 11 as a whole has a horizontally long (elongated) square shape (rectangular shape). As shown in FIGS. 2 and 3, the liquid crystal panel 11 includes a pair of transparent (light transmissive) glass substrates 11a and 11b, and a liquid crystal layer 11c between the substrates 11a and 11b. The liquid crystal layer 11c includes liquid crystal. The liquid crystal is a substance whose optical characteristics vary by application of an electric field. The substrates 11a and lib are affixed to each other with a sealing agent, which is not shown, with a gap corresponding to the thickness of liquid crystal layer 11c maintained between the substrates. To the outer surfaces of the substrates 11a and lib, polarizing plates 11d and 11e, respectively, are affixed. The liquid crystal panel 11 has a long side direction and a short side direction aligned with the X-axis direction and the Y-axis direction, respectively.

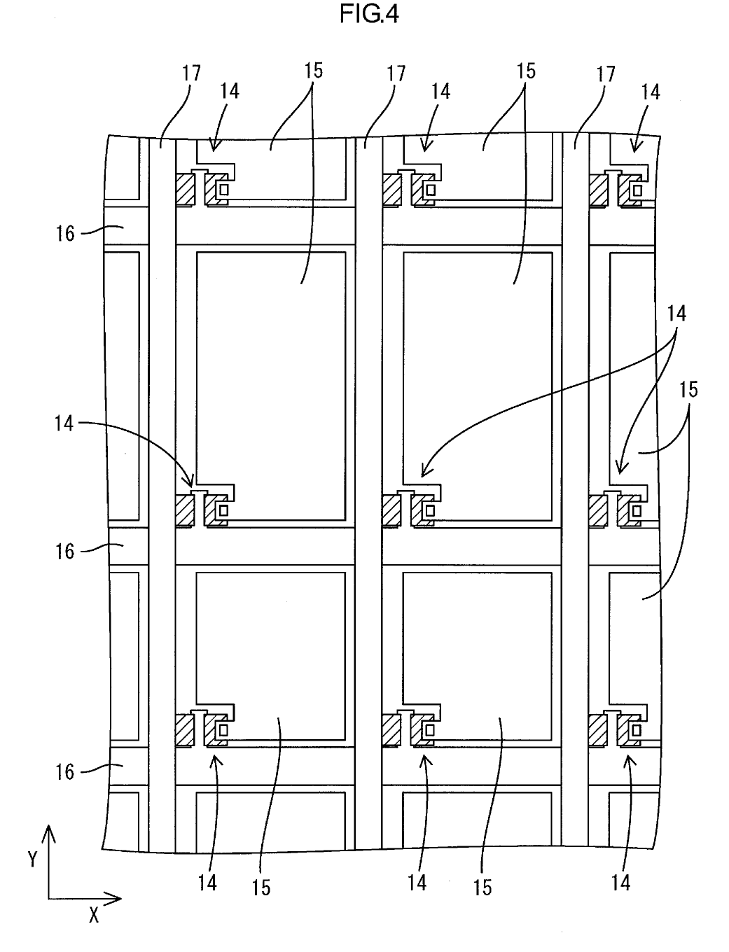

The front side (front surface side) one of the substrates 11a and 11b is a CF substrate 11a, and the rear side (back surface side) one of the substrates 11a and 11b is an array substrate 11b. On an inner surface of the array substrate 11b, i.e., the surface facing the liquid crystal layer 11c (or opposed to the CF substrate 11a), as shown in FIG. 4, a number of TFTs (Thin Film Transistors) 14 and pixel electrodes 15 as switching elements are disposed side by side in a matrix (rows and columns). Around the TFTs 14 and the pixel electrodes 15, gate wires 16 and source wires 17 are disposed in a lattice shape. The pixel electrodes 15 have a vertically long (elongated) square shape (rectangular shape) with a long side direction and a short side direction aligned with the Y-axis direction and the X-axis direction, respectively. The pixel electrodes 15 may be transparent electrodes of ITO (Indium Tin Oxide) or ZnO (Zinc Oxide). The gate wires 16 and the source wires 17 are connected to the gate electrodes and the source electrodes of the TFTs 14, respectively. The pixel electrodes 15 are connected to the drain electrodes of the TFTs 14. On the side of the TFTs 14 and the pixel electrodes 15 facing the liquid crystal layer 11c, as shown in FIGS. 2 and 3, an alignment film 18 aligning the liquid crystal molecules is disposed. At the ends of the array substrate 11b, terminal portions drawn out from the gate wires 16 and the source wires 17 are formed. To the terminal portions, a driver IC, which is not shown, driving the liquid crystal is crimped via an anisotropic conductive film (ACF). The liquid crystal driving driver IC is electrically connected to a display control circuit board, which is not shown, via various wiring substrates and the like. The display control circuit board is connected to the image conversion circuit board VC of the television receiver TV to supply a drive signal via the driver IC to the wires 16 and 17 on the basis of an output signal from the image conversion circuit board VC.

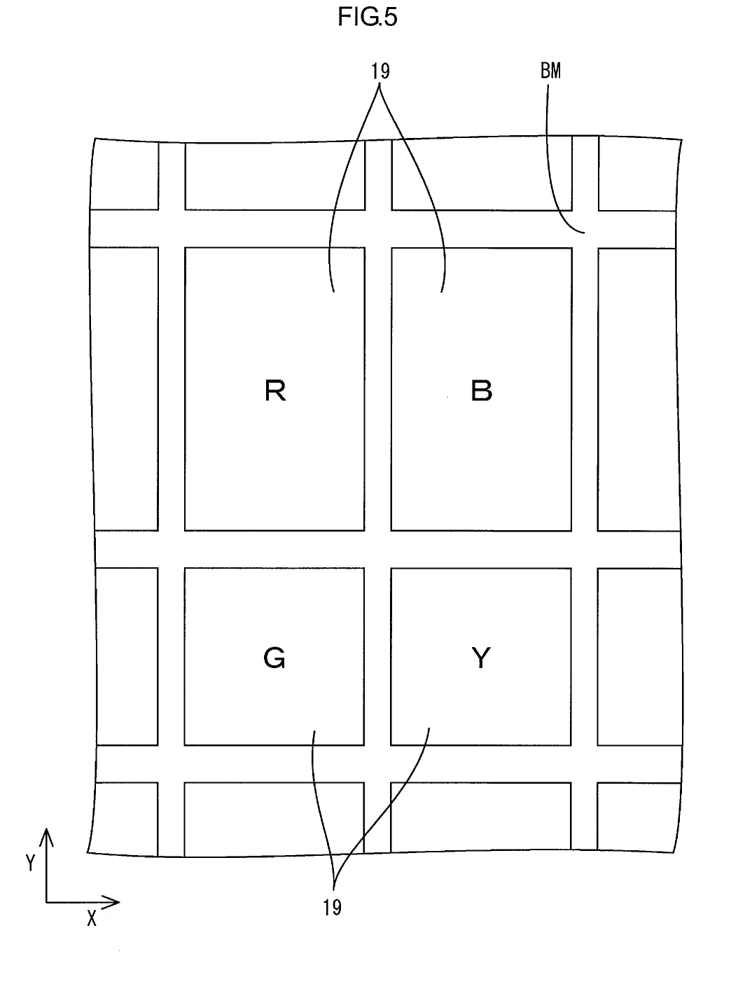

On the inner surface of the CF substrate 11a, i.e., on the surface facing the liquid crystal layer 11c (or opposed to the array substrate 11b), as shown in FIG. 5, a color filter 19 including a plurality of each of color sections R, G, B, or Y arranged in a matrix (rows and columns) corresponding to the respective pixels on the array substrate 11b is disposed. According to the present embodiment, the color filter 19 includes a yellow color section Y in addition to the red color section R, the green color section G, and the blue color section B as the three primary colors of light. The respective color sections R, G, B, and Y selectively transmit light of the respective corresponding colors (respective wavelengths). The color sections R, G, B, and Y have a vertically long (elongated) square shape (rectangular shape) similar to the pixel electrodes 15, with their long side direction and short side direction aligned with the Y-axis direction and the X-axis direction, respectively. Between the color sections R, G, B, and Y, a lattice-shaped light blocking layer (black matrix) BM is provided for preventing the mixing of colors. On the side of the color filter 19 on the CF substrate 11a facing the liquid crystal layer 11c, as shown in FIGS. 2 and 3, a counter electrode 20 and an alignment film 21 are layered in order.

Thus, according to the present embodiment, the liquid crystal display device 10 has the liquid crystal panel 11 with the color filter 19 including the four color sections R, G, B, and Y. For this reason, the television receiver TV includes the dedicated image conversion circuit board VC. The image conversion circuit board VC is configured to convert the television image signal output from the tuner T into an image signal for the respective colors of red, green, blue, or yellow to output the image signal generated for the respective colors to the display control circuit board. On the basis of the image signals, the display control circuit board drives the TFTs 14 corresponding to the respective colors of the pixels on the liquid crystal panel 11 via the wires 16 and 17 to appropriately control the amount of light transmitted through the color section R, G, B, or Y for the respective colors.

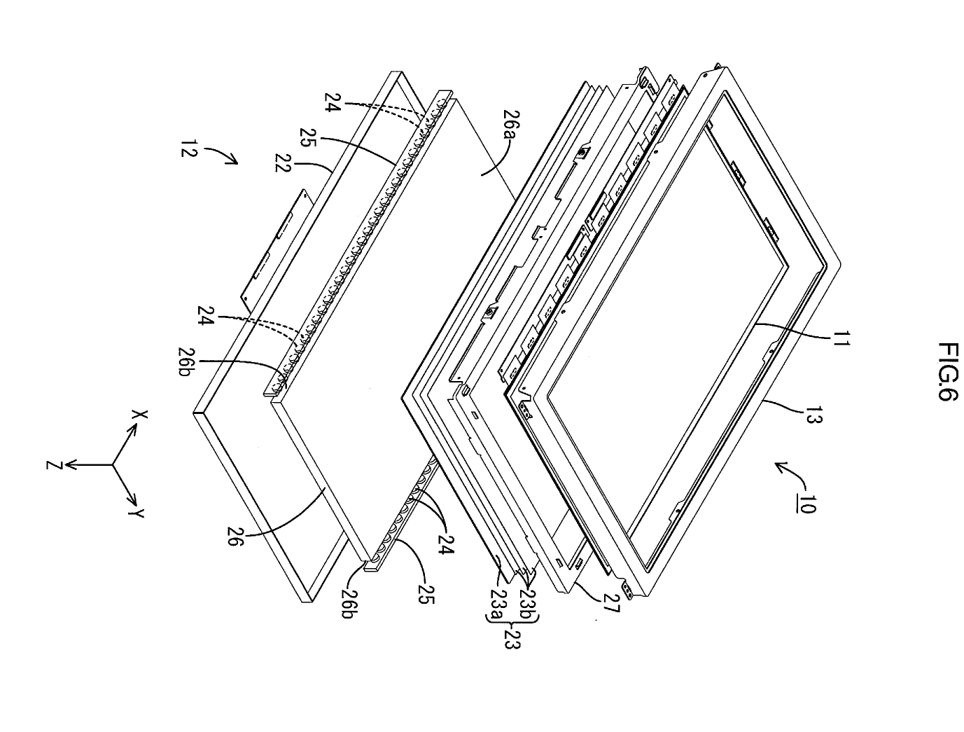

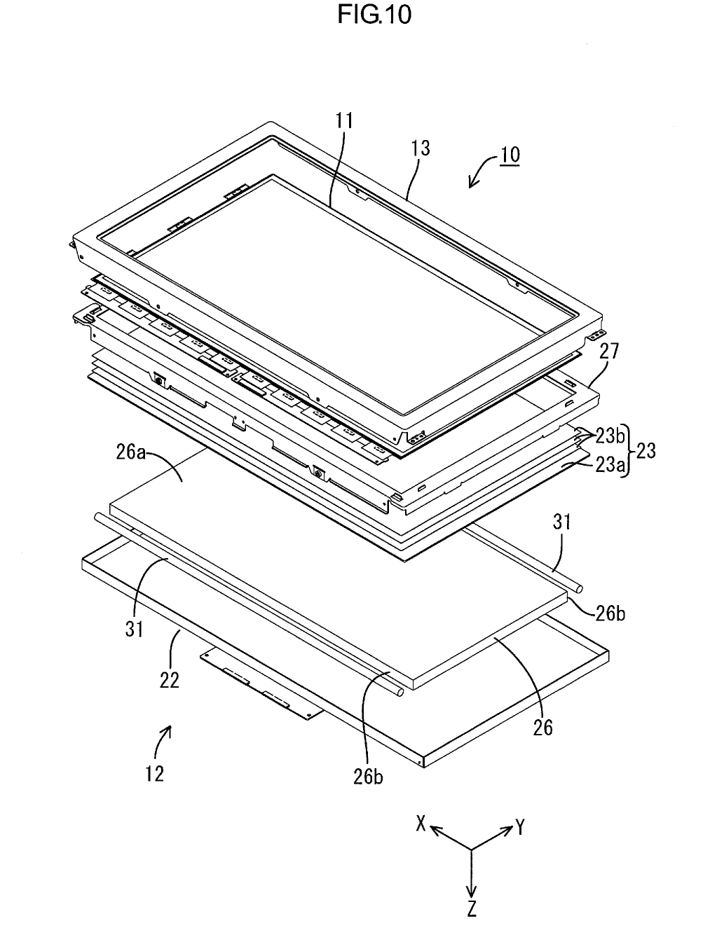

Next, a configuration of the backlight unit 12 will be described. According to the present embodiment, the backlight unit 12 includes a light guide member 26 of a synthetic resin with light sources 24 or 31 disposed at the ends thereof. Thus, the backlight unit 12 is of the so-called edge light type. As the light source, LEDs (Light Emitting Diode) 24 or the cold cathode tubes 31 may be selectively used. In the following, common configurations of the backlight unit 12 other than the light sources 24 or 31 will be described in detail first, followed by detailed description of the light sources 24 or 31. The configuration of the backlight unit 12 using the LEDs 24 as the light sources is shown in FIGS. 6 to 9. The configuration of the backlight unit 12 using the cold cathode tubes 31 as the light sources are shown in FIGS. 10 to 12.

The backlight unit 12, as shown in FIGS. 6 and 10, includes a substantially box-shaped chassis 22 with an opening facing the light output surface side (or the liquid crystal panel 11); and a group of optical members 23 (including a diffuser plate (light diffuser member) 23a and a plurality of optical sheets 23b disposed between the diffuser plate 23a and the liquid crystal panel 11) disposed to cover the opening of the chassis 22. In the chassis 22, there are provided the light sources 24 or 31; the light guide member 26 guiding the light from the light sources 24 or 31 to the optical members 23 (liquid crystal panel 11); and a frame 27 for retaining the light guide member 26 from the front side. The light sources 24 or 31 are disposed at the ends of the backlight unit 12 on the long sides thereof to form a pair, with sandwiching the light guide member 26 between at the center. Thus, the backlight unit 12 is of the so-called edge light type (side light type).

The chassis 22 is made of a metal and, as shown in FIGS. 7, 8, 11, and 12, includes a bottom plate 22a with a horizontally long square shape similar to the liquid crystal panel 11; and side plates 22b rising from the outer ends on the sides of the bottom plate 22a. Thus, the chassis 22 as a whole has a shallow substantially box-like shape opening toward the front side. The chassis 22 (bottom plate 22a) has a long side direction aligned with the X-axis direction (horizontal direction) and a short side direction aligned with the Y-axis direction (vertical direction). To the side plates 22b, the frame 27 and the bezel 13 can be secured by screws.

The optical members 23, as shown in FIGS. 6 and 10, has a horizontally long square shape in plan view, similar to the liquid crystal panel 11 and the chassis 22. The optical members 23 are mounted on the front side (light output side) of the light guide member 26, between the liquid crystal panel 11 and the light guide member 26. The optical members 23 include the diffuser plate 23a disposed on the rear side (facing the light guide member 26; opposite to the light output side), and the optical sheets 23b disposed on the front side (facing the liquid crystal panel 11; the light output side). The diffuser plate 23a includes a substantially transparent plate-like base substrate made of a resin with a predetermined thickness, in which a number of diffusing particles are dispersed. The diffuser plate 23a has the function of diffusing transmitted light. The optical sheets 23b are formed of a stack of three sheets each with a thickness smaller than the one of the diffuser plate 23a. Specific types of the optical sheets 23b may include a diffuser sheet, a lens sheet, and a reflection type polarizing sheet, from which one or more may be appropriately selected and used.

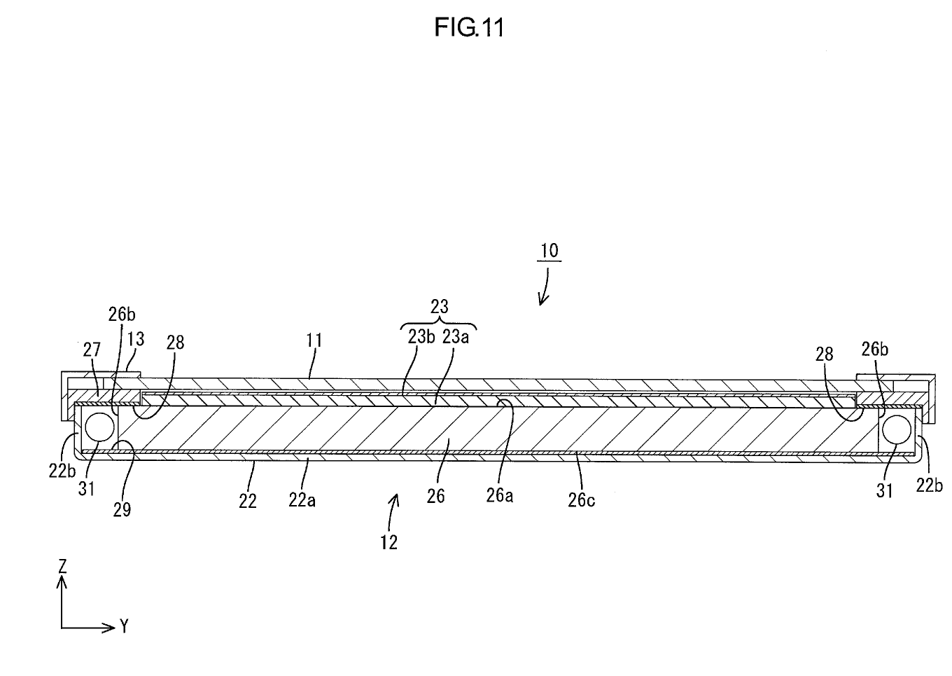

The frame 27, as shown in FIGS. 6 and 10, has a frame shape extending along the outer peripheral ends of the light guide member 26 to retain substantially the entire outer peripheral ends of the light guide member 26 from the front side. The frame 27 is made of a synthetic resin and has a black surface, for example, thus providing light blocking property. To the rear side surfaces of the frame 27 on the long side portions thereof, i.e., on the surfaces facing the light guide member 26 and the light sources 24 or 31, as shown in FIGS. 7 and 11, first reflection sheets 28 reflecting light are attached. The first reflection sheets 28 are dimensioned to extend over substantially the entire length of the long side portions of the frame 27. Thus, the first reflection sheets 28 are directly abutted on the ends of the light guide member 26 on the side of the light sources 24 or 31, and cover both the ends of the light guide member 26 and the light sources 24 or 31 from the front side. The frame 27 is also configured to receive the outer peripheral ends of the liquid crystal panel 11 from the rear side.

The light guide member 26 is made of a substantially transparent (highly light transmissive) synthetic resin (such as acrylic) material with a refractive index higher than air. The light guide member 26, as shown in FIGS. 6 and 10, has a horizontally long square shape in plan view similar to the liquid crystal panel 11 and the chassis 22, with a long side direction and a short side direction aligned with the X-axis direction and the Y-axis direction, respectively. The light guide member 26 is disposed immediately under the liquid crystal panel 11 and the optical members 23 in the chassis 22. A pair of the light sources 24 or 31 is disposed at the ends of the chassis 22 on the long sides to sandwich the light guide member 26 between with respect to the Y-axis direction. Thus, the arrangement direction of the light sources 24 or 31 and the light guide member 26 is aligned with the Y-axis direction, while the arrangement direction of the optical members 23 (liquid crystal panel 11) and the light guide member 26 is aligned with the Z-axis direction, the both arrangement directions orthogonal to each other. The light guide member 26 has the function of introducing the light emitted from the light sources 24 or 31 in the Y-axis direction and outputting the light up toward the optical members 23 (in the Z-axis direction) while allowing the light to travel therein. The light guide member 26 is slightly larger than the optical members 23 with the outer peripheral ends extending outward beyond the outer peripheral end surfaces of the optical members 23, which is retained by the frame 27 (FIGS. 7, 8, 10, and 11).

The light guide member 26 has a substantially flat plate-like shape extending along the respective plate surfaces of the bottom plate 22a of the chassis 22 and the optical member 23, with main plate surfaces parallel with the X-axis direction and the Y-axis direction. Of the main plate surfaces of the light guide member 26, the surface facing the front side constitutes alight output surface 26a outputting the internal light toward the optical members 23 and the liquid crystal panel 11. Of the outer peripheral end surfaces of the light guide member 26 adjacent to the main plate surfaces, the elongated end surfaces on the long sides along the X-axis direction are opposed to the light sources 24 or 31 via a predetermined interval, constituting light entrance surfaces 26b through which the light emitted from the light sources 24 or 31 enters. The light entrance surfaces 26b are parallel with the X-axis direction and the Z-axis direction and are substantially orthogonal to the light output surface 26a. The arrangement direction of the light sources 24 or 31 and the light entrance surfaces 26b is aligned with the Y-axis direction and is parallel with the light output surface 26a. A second reflection sheet 29, configured to reflect the light within the light guide member 26 up toward the front side, covers substantially the entire area of a surface 26c of the light guide member 26 on the opposite side to the light output surface 26a. The second reflection sheet 29 extends to overlap with the light sources 24 or 31 in plan view, while sandwiching the light sources 24 or 31 with the first reflection sheets 28 on the front side. Thus, the light from the light sources 24 or 31 is repeatedly reflected between the reflection sheets 28 and 29 to be efficiently incident on the light entrance surfaces 26b. On at least one of the light output surface 26a of the light guide member 26 and the opposite surface 26c thereto, a reflecting portion (not shown) reflecting the internal light or a scattering portion (not shown) scattering the internal light is patterned with a predetermined in-plane distribution. Thereby, the output light from the light output surface 26a is controlled to have a uniform distribution in the surface.

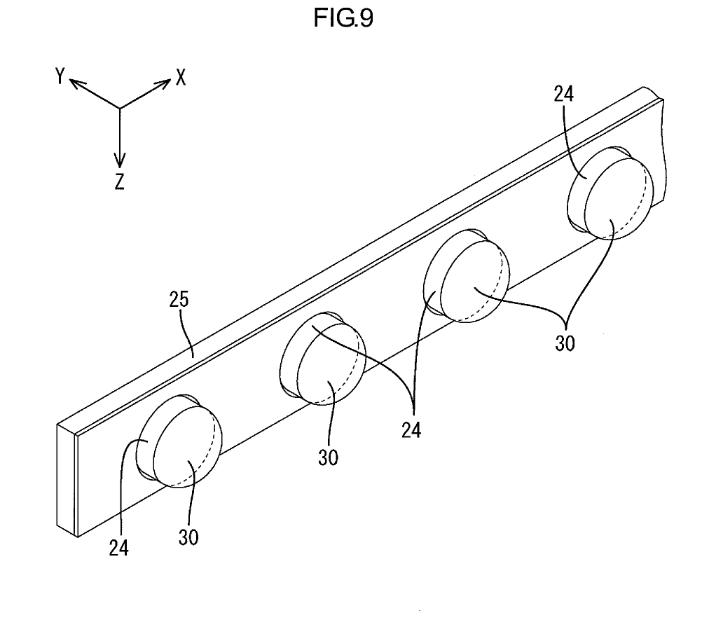

Next, the LEDs 24 as the light sources will be described. The LEDs 24 are mounted on LED boards 25 and the surface on the opposite side to the mounting surface on the LED boards 25 constitutes the light emitting surface as shown in FIG. 6, which is of the top type. On the light emitting side of the LEDs 24, as shown in FIGS. 7 and 9, lens members 30 outputting the light while being diffused at large angles are provided. The lens members 30 are disposed between the LEDs 24 and the light entrance surfaces 26b of the light guide member 26, and have a spherical light output surface to be convex toward the light guide member 26. The light output surface of the lens members 30 is curved along the longitudinal direction of the light entrance surfaces 26b of the light guide member 26, and has a substantially arched cross section. The detailed configuration of the LEDs 24 will be described later.

The LED board 25, as shown in FIG. 6, has a long plate-like shape extending along the long side direction of the chassis 22 (the X-axis direction; the longitudinal direction of the light entrance surfaces 26b of the light guide member 26). The LED boards 25 are housed in the chassis 22 with the main plate surfaces thereof being parallel with the X-axis direction and the Z-axis direction; namely, the main plate surfaces are orthogonal to the plate surfaces of the liquid crystal panel 11 and the light guide member 26 (optical members 23). The LED boards 25 are provided in a pair corresponding to the ends of the chassis 22 on the long sides, and are attached to the inner surfaces of the both side plates 22b on the long sides. The LEDs 24 with the above-described configuration are surface-mounted on the inner one of the main plate surfaces of the LED boards 25, that is the surface facing the light guide member 26 (the surface opposed to the light guide member 26). On the mounting surface of the LED boards 25, a plurality of the LEDs 24 is arranged side by side in a line along the length direction (X-axis direction). Thus, it can be said that a plurality of the LEDs 24 is arranged side by side in a line on each of the ends of the backlight unit 12 on the long sides along the long side direction. The pair of LED boards 25 is housed in the chassis 22 with the mounting surfaces of the LEDs 24 opposed to each other. Therefore, the light emitting surfaces of the LEDs 24 mounted on the LED boards 25 are opposed to each other with the optical axes of the LEDs 24 substantially aligned with the Y-axis direction.

The base member of the LED boards 25 may be made of a metal, same as the chassis 22, such as an aluminum based material. A wiring pattern (not shown) of a metal film, such as copper foil, is formed on a surface of the base member via an insulating layer. On an outer-most surface, a white reflective layer (not shown) with high light reflectivity is formed. By the wiring pattern, the LEDs 24 arranged side by side in a line on the LED boards 25 are connected in series. The material of the base member of the LED boards 25 may be an insulating material, such as ceramic material.

The configuration of the LEDs 24 will be described in detail. The LEDs 24 include blue LED chips 24a emitting blue light as light emitting sources, and a green phosphor and a red phosphor as phosphors emitting light upon excitation by the blue light. Specifically, the LEDs 24 include board portions fixed on the LED boards 25, on which the blue LED chips 24a are sealed with a resin material. The blue LED chip 24a mounted on the board portion has a dominant emission wavelength in a range of 420 nm to 500 nm, i.e., in the blue wavelength region, to emit blue light with high color purity. Preferably, the dominant emission wavelength of the blue LED chips 24a may be 451 nm. The resin material with which the LED chips are sealed contains the green phosphor that emits green light upon excitation by the blue light emitted by the blue LED chips 24a, and the red phosphor that emits red light upon excitation by the blue light emitted by the blue LED chips 24a, the green phosphor and the red phosphor being dispersed at a predetermined ratio. On the basis of the blue light (light of blue component) emitted by the blue LED chips 24a, the green light (light of green component) emitted from the green phosphor, and the red light (light of red component) emitted from the red phosphor, the LEDs 24 as a whole can emit a predetermined color, such as white or bluish white. By combining the light of green component from the green phosphor and the light of red component from the red phosphor, yellow light can be obtained. Thus, it can be said that the LEDs 24 have both the light of blue component from the blue LED chips 24a and the light of yellow component. The chromaticity of the LEDs 24 may vary depending on the absolute or relative values of the contained amounts of the green phosphor and red phosphor. Thus, by appropriately adjusting the contained amounts of the green phosphor and the red phosphor, the chromaticity of the LEDs 24 can be adjusted. According to the present embodiment, the green phosphor has a dominant emission peak in a green wavelength region of 500 nm to 570 nm, while the red phosphor has a dominant emission peak in a red wavelength region of 600 nm to 780 nm.

The green phosphor and the red phosphor of the LEDs 24 will be described. Preferably, as the green phosphor, a β-SiAlON, which is a SiAlON-based nitride, may be used. Thereby, green light can be emitted with higher efficiency than when a sulfide or oxide phosphor is used. In addition, green light of very high color purity can be emitted, which is very useful in adjusting chromaticity of the LEDs 24. Specifically, the β-SiAlON, which uses Eu (europium) as an activator, is expressed by the general formula, Si6-zAlzOzN8-z:Eu (where z indicates the amount of solid solution) or (Si, Al)6(O, N)8:Eu. On the other hand, as the red phosphor, CASN, which is a CASN-based nitride, may be preferably used. Thereby, red light can be emitted with higher efficiency than when a sulfide or oxide phosphor is used. Specifically, CASN, which uses Eu (europium) as an activator, is expressed by CaAlSiN3:Eu.

The green phosphor may be changed from the β-SiAlON as appropriate. Preferably, a YAG-based phosphor may be used as it enables high efficiency emission of light. A YAG-based phosphor has a garnet structure including a complex oxide of yttrium and aluminum, expressed by the chemical formula: Y3Al5O12, where a rare-earth element (such as Ce, Tb, Eu, or Nd) is used as an activator. The YAG-based phosphor may have a part or all of the Y site substitutable by Gd, Tb, or the like, or a part of the Al site substitutable by Ga, in the chemical formula Y3Al5O12, for example. In this way, the dominant emission wavelength of the YAG-based phosphor can be shifted toward the longer wavelength side or shorter wavelength side for adjustment. Specific examples of the YAG-based phosphor include Y3Al5O12:Ce, Y3Al5O12:Tb, (Y, Gd)3Al5O12:Ce, Y3(Al, Ga)5O12:Ce, Y3(Al, Ga)5O12:Tb, (Y, Gd)3(Al, Ga)5O12:Ce, (Y, Gd)3(Al, Ga)5O12:Tb, and Tb3Al5O12:Ce.

Other examples of the green phosphor include inorganic phosphors such as (Ba, Mg)Al10O17:Eu, Mn, SrAl2O4:Eu, Ba1.5Sr0.5SiO4:Eu, BaMgAl10O17:Eu, Mn, Ca3(Sc, Mg)2Si3O12:Ce, Lu3Al5O12:Ce, CaSc2O4:Ce, ZnS:Cu, Al, (Zn, Cd)S:Cu, Al, Y2SiO5:Tb, Zn2SiO4:Mn, (Zn, Cd)S:Cu, ZnS:Cu, Gd2O2S:Tb, (Zn, Cd)S:Ag, Y2O2S:Tb, (Zn, Mn)2SiO4, BaAl12O19:Mn, (Ba, Sr, Mg)O.aAl2O3:Mn, LaPO4:Ce, Tb, Zn2SiO4:Mn, CeMgAl11O19:Tb, and BaMgAl10O17:Eu, Mn.

Similarly, the red phosphor may be appropriately changed from CASN. For example, inorganic phosphors such as (Sr, Ca)AlSiN3:Eu, Y2O2S:Eu, Y2O3:Eu, Zn3(PO4)2:Mn, (Y, Gd, Eu)BO3, (Y, Gd, Eu)2O3, YVO4:Eu, and La2O2S:Eu, Sm may be used.

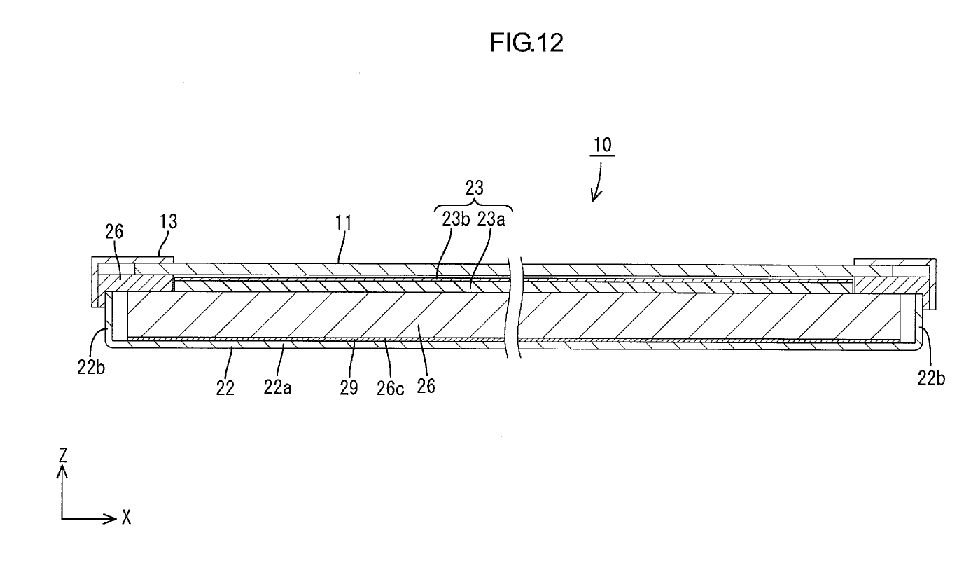

Next, the cold cathode tubes 31 as the light sources will be described. The cold cathode tubes 31, as shown in FIGS. 10 and 11, are long tubes and housed in the chassis 22 with their length direction (axial direction) aligned with the long side direction (X-axis direction) of the chassis 22 and the light guide member 26. The cold cathode tubes 31 are disposed in a pair corresponding to the both ends of the chassis 22 on the long sides, sandwiching the light guide member 26 therebetween. The cold cathode tubes 31, which are a type of discharge tube, include long glass tubes of a circular cross section with electrode portions are enclosed in the both ends thereof. Thus, the cold cathode tubes 31 are of the so-called straight tube type, in which the glass tubes are straight. In the glass tubes constituting the cold cathode tubes 31, light emitting substance, such as mercury, is enclosed. In addition, the internal walls of the glass tubes are coated with a phosphor (which is not shown, same as mercury). When an output voltage is applied to the electrode portions from an inverter substrate, which is not shown, electrons jump out of the electrode portions and collide with the mercury atoms within the glass tubes. As a result, ultraviolet rays are emitted from the mercury molecules, and the ultraviolet rays are converted by the phosphor into visible rays. Then, the visible rays are radiated out of the glass tubes, thereby emitting light. The chromaticity of the output light of the cold cathode tubes 31 may be appropriately changed by adjusting the type of the phosphors to be used and the contained amounts of the various phosphors. For example, white or bluish white can be obtained. The phosphors to be used in the cold cathode tubes 31 may be appropriately selected from the various phosphors described with reference to the configuration of the LEDs 24; thus, redundant description of the phosphors is omitted herein. In FIG. 12, illustration of the cold cathode tubes 31 is omitted.

As described above, according to the present embodiment, the color filter 19 of the liquid crystal panel 11, as shown in FIGS. 3 and 5, includes the yellow color section Y in addition to the color sections R, G, and B as the three primary colors of light. Thus, the color gamut of the display image displayed by the transmitted light is expanded. Therefore, the image can be displayed with excellent color reproducibility. Further, the light transmitted through the yellow color section Y has wavelengths close to the peak of luminosity factor, and therefore, tends to be perceived by the human eye as being bright even at small energy level. Thus, sufficient brightness can be obtained even when the output from the light sources 24 or 31 of the backlight unit 12 is restrained. Accordingly, the electric power consumption by the light sources 24 or 31 can be decreased and thereby improved environmental friendliness can be obtained.

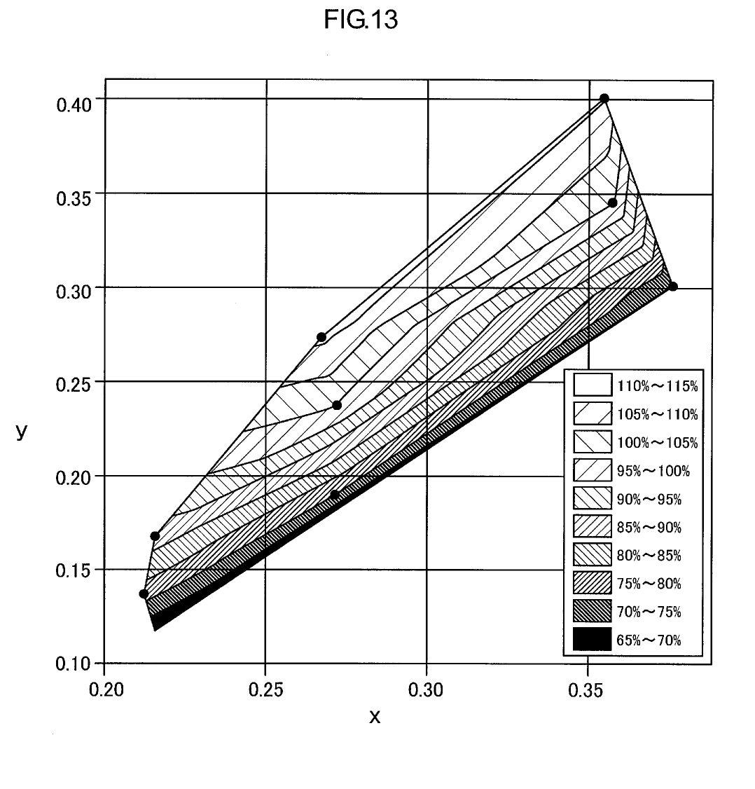

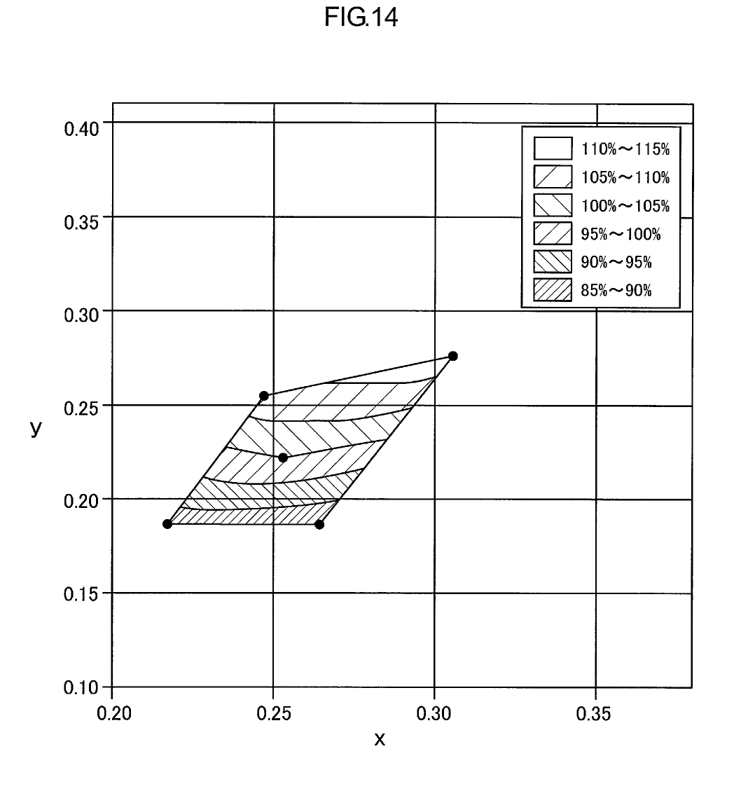

On the other hand, when the four-color liquid crystal panel 11 is used, the display image of the liquid crystal panel 11 may tend to become yellowish as a whole. This problem may be overcome by adjusting the chromaticity of the light sources 24 or 31 of the backlight unit 12 toward blue, which is the complementary color of yellow, to correct the chromaticity of the display image. However, a research by the present inventor indicates that, when the chromaticity of the light sources 24 or 31 is adjusted in accordance with the liquid crystal panel 11 including the yellow color section Y sufficient brightness may not be obtained depending on the type of the light sources 24 or 31 because of the compatibility concerning the chromaticity and brightness characteristics of the light sources 24 or 31 or spectral characteristics with the liquid crystal panel 11. Now, the chromaticity and brightness characteristics of the light sources 24 or 31 will be described with reference to FIGS. 13 and 14. In the chromaticity and brightness characteristics of the LEDs 24 shown in FIG. 13, the lines dividing the regions with equal brightness, or “brightness contour lines”, so to speak, are generally inclined toward upper-right with respect to the x-axis and the y-axis. Thus, the brightness of the LEDs 24 tends not to decrease so much even when the chromaticity is shifted toward blue for chromaticity adjustment. On the other hand, in the chromaticity and brightness characteristics of the cold cathode tubes 31 shown in FIG. 14, the brightness contour lines are generally parallel to the x-axis. Thus, when the chromaticity of the cold cathode tubes 31 is shifted toward blue for chromaticity adjustment, the brightness tends to be relatively decreased compared to that of the LEDs 24. As a result, the brightness may become lower than that of the output light from the LEDs 24. Further, the cold cathode tubes 31, compared to the LEDs 24, have low compatibility with the four-color liquid crystal panel 11 in terms of spectral characteristics, which may further contribute to the relatively low brightness of the transmitted light. The values (%) in the legends shown in FIGS. 13 and 14 are relative brightness values.

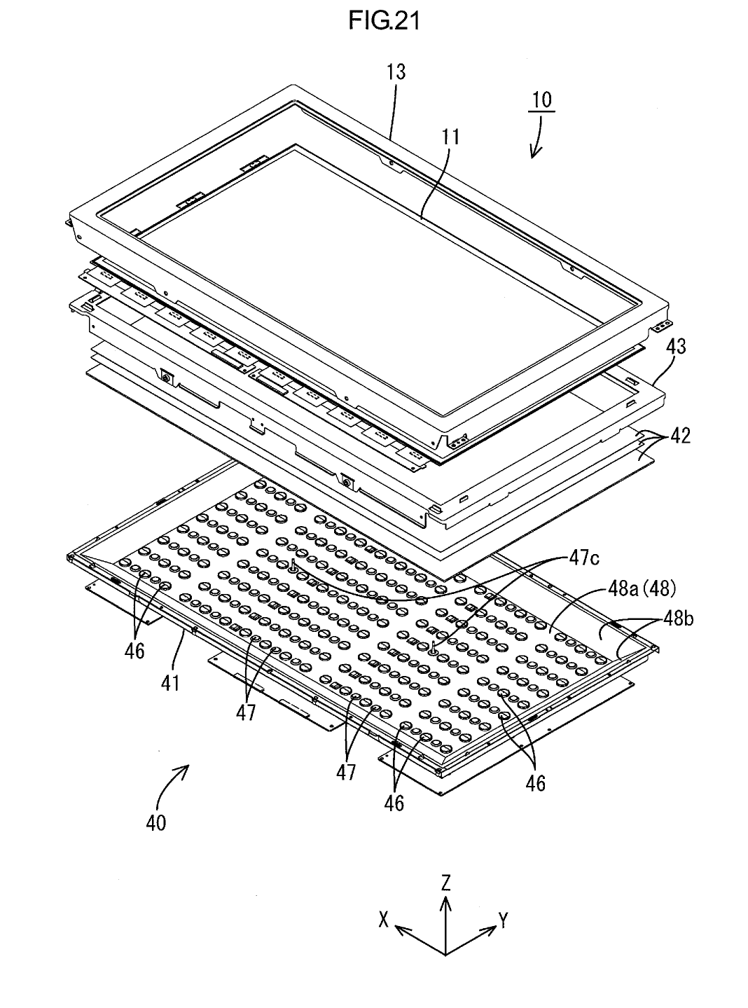

A further research by the present inventor also indicates that, in the edge light backlight unit 12 according to the present embodiment, the brightness decrease as a result of the chromaticity adjustment of the light sources 24 or 31 is more serious than in the case of the direct backlight unit 40 (FIGS. 21 to 27) that does not include the light guide member 26, because of the use of the light guide member 26 as a constituent component of the optical system. Specifically, in the edge light backlight unit 12, compared to the direct backlight unit 40, the length of the optical path the light emitted from the light sources 24 or 31 must travel to reach the liquid crystal panel 11 is long. In addition, in the process, the light guide member 26 may absorb light as it travel therein, resulting in a decrease in brightness. In addition, the light absorbed by the light guide member 26, generally for material reasons, tends to have shorter wavelength light, i.e., blue light, more than longer wavelength light, such as yellow light and red light. Thus, the transmitted light from the light guide member 26 tends to be yellowish. Accordingly, in order to correct the chromaticity of the display image, the chromaticity of the light sources 24 or 31 needs to be adjusted toward blue. As a result, the decrease in brightness due to chromaticity adjustment may be more pronounced.

The present inventor conducted further research and has devised a technique maintaining high transmitted light brightness whichever the LEDs 24 or the cold cathode tubes 31 are used as the light sources in the edge light backlight unit 12 with the light guide member 26, as will be described below. According to the present embodiment, of the color sections R, G, B, and Y included in the color filter 19, the areas of the red color section R and the blue color section B are increased compared to the areas of the yellow color section Y and the green color section G. In this way, the transmitted light through the color filter 19 tends to contain relatively more blue or red light than yellow or green light. Thus, even when the light from the light sources 24 or 31 becomes rather yellowish by being transmitted through the light guide member 26, the display image can be restrained from becoming yellowish due to the configuration of the color filter 19, which transmits a relatively large amount of blue light, which is the complementary color to yellow. Accordingly, chromaticity of the light sources 24 or 31 does not need to be adjusted toward blue for display image chromaticity correction, thereby restraining the decrease in brightness of transmitted light as a result of chromaticity adjustment of the light sources 24 or 31.

The configuration of the color filter 19 will be described. In the CF substrate 11a, the color sections R, G, B, and Y included in the color filter 19 are, as shown in FIG. 5, arranged in rows and columns with the rows lying in the X-axis direction and the columns in the Y-axis direction. The color sections R, G, B, and Y have the same dimensions in the row direction (X-axis direction)(FIGS. 2 and 5), but have different dimensions in the column direction (Y-axis direction) with the color sections R, G, B, and Y disposed in adjacent rows (FIGS. 3 and 5). Specifically, in the rows with the relatively large dimensions in the column direction, the red color section R and the blue color section B are disposed adjacent to each other in the row direction. In the rows with the relatively small dimensions in the column direction, the yellow color section Y and the green color section G are disposed adjacent to each other in the row direction. Thus, first rows with the relatively small dimensions in the column direction in which the red color section R and the blue color section B are disposed alternately in the row direction, and second rows with the relatively large dimensions in the column direction in which the yellow color section Y and the green color section G are disposed alternately in the row direction, are alternately and repeatedly disposed in the column direction. In this way, the area of the red color section R and the blue color section B is made larger than the area of the yellow color section Y and the green color section G. The blue color section B and the red color section R have the same area. Similarly, the yellow color section Y and the green color section G have the same area. The green color section G is disposed adjacent to the red color section R in the column direction. The yellow color section Y is disposed adjacent to the blue color section B in the column direction. Because of the above described configuration of the color filter 19, in the array substrate 11b, as shown in FIG. 4, the pixel electrodes 15 disposed in adjacent rows have different dimensions in the column direction. Namely, among the pixel electrodes 15, for those overlapping with the red color section R or the blue color section B, the area is larger than the area of those overlapping with the yellow color section Y or the green color section G. The color sections R, G, B, and Y have the same film thickness. All the source wires 17 are arranged at a regular pitch, while the gate wires 16 are arranged at two different pitches depending on the measurement of the pixel electrodes 15. In FIGS. 3 and 5, the area of the red color section R or the blue color section B is approximately 1.6 times as large as the area of the yellow color section Y and the green color section G.

In order to verify the effect provided by the configuration of the color filter 19 above described, a first comparative experiment was conducted as described below. In the first comparative experiment, it is verified how the brightness and chromaticity of the light sources 24 or 31 and transmitted light vary, when the area ratio of the respective color sections R, G, B, and Y is changed in the edge light backlight unit 12 (the first experiment example and the second experiment example) and in the direct backlight unit 40 (the third experiment example and the fourth experiment example).

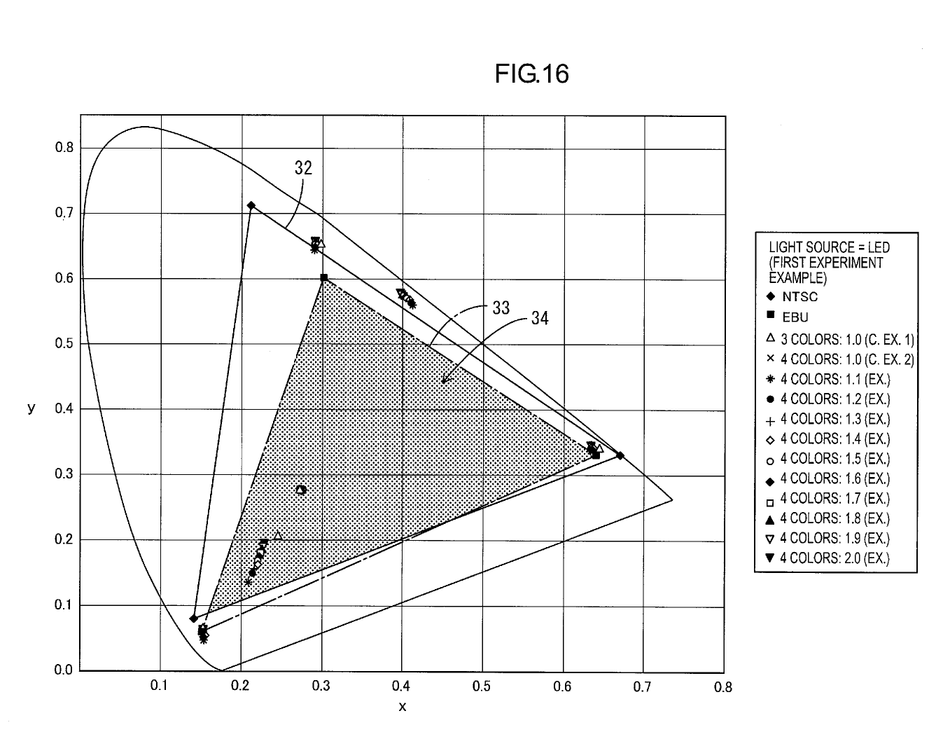

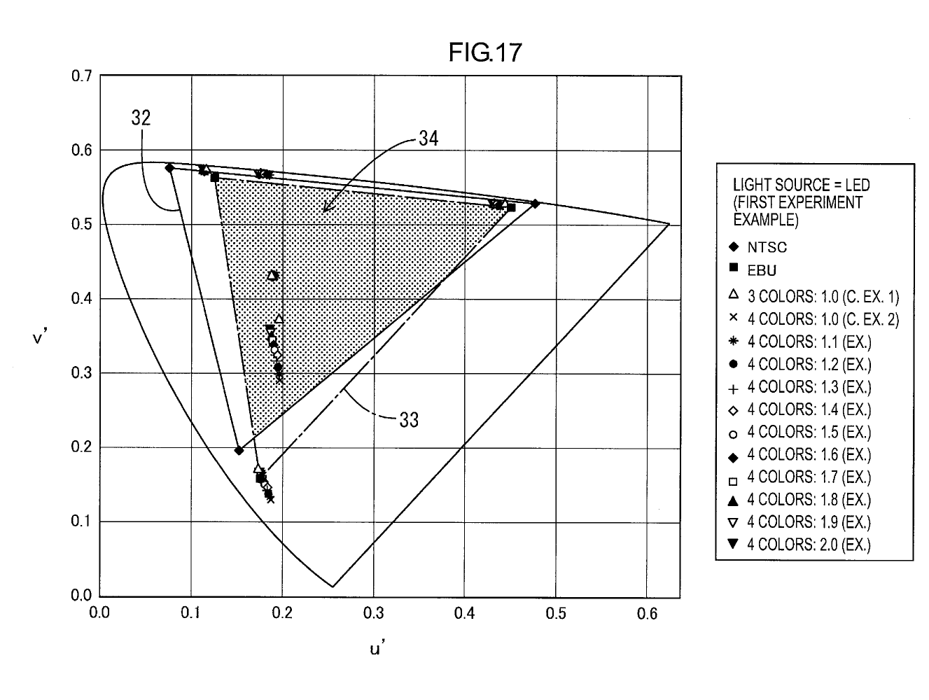

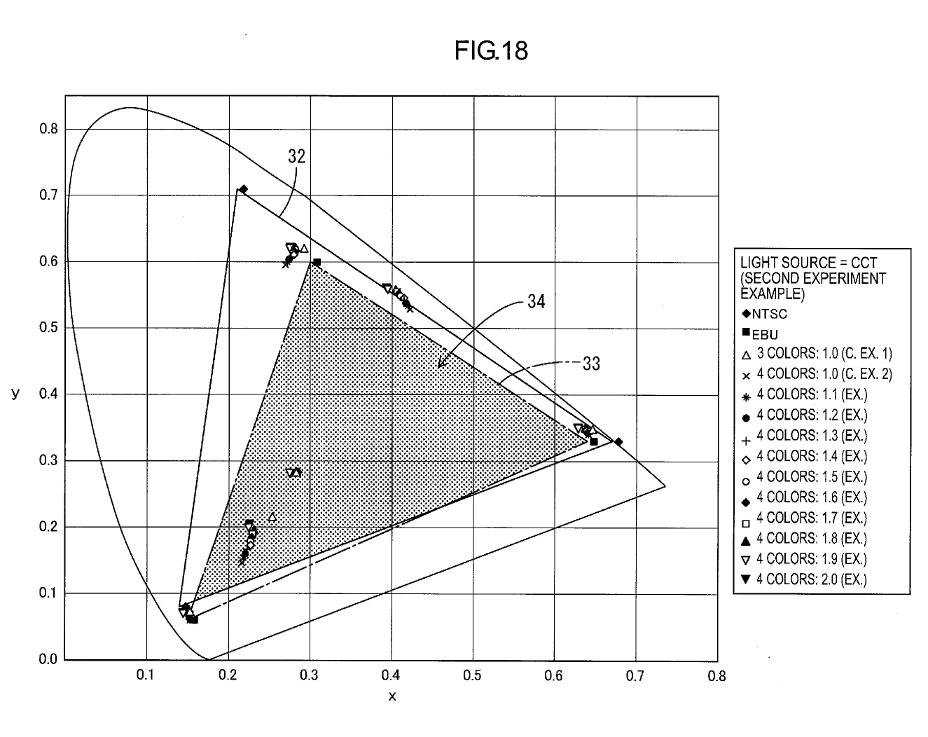

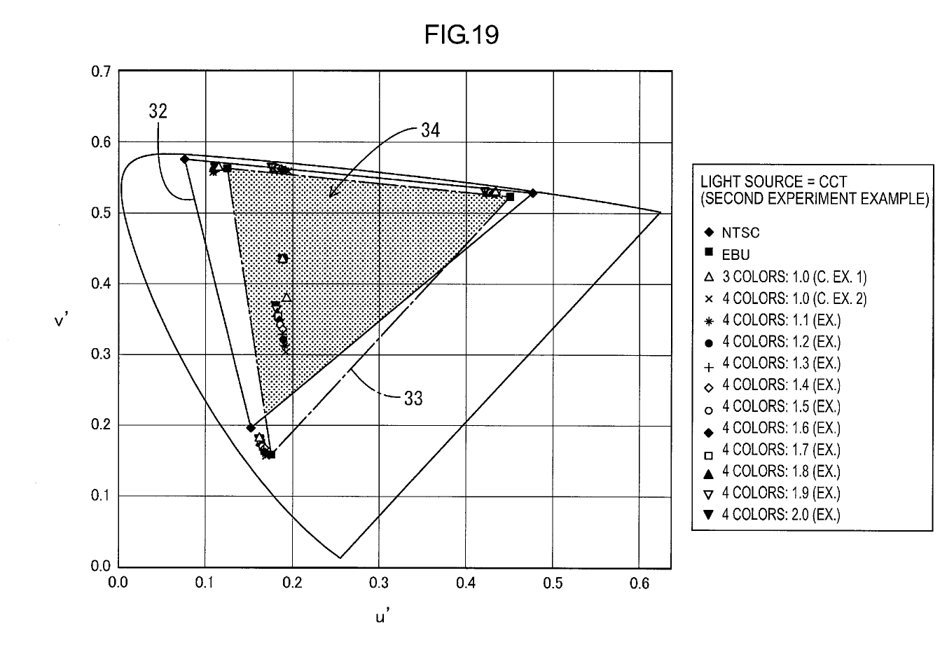

Prior to giving a detailed description of the first comparative experiment, CIE (Commission Internationale de l'Eclairage) 1931 chromaticity diagrams shown in FIGS. 16 and 18, and CIE1976 chromaticity diagrams shown in FIGS. 17 and 19 will be described. The triangles drawn in solid lines in FIGS. 16 to 19 indicate a NTSC chromaticity region 32 according to the NTSC (National Television System Committee) standard. The triangles drawn in dot and dash lines in FIGS. 16 to 19 indicate an EBU chromaticity region 33 according to the EBU (European Broadcasting Union) standard. The shaded quadrangles in FIGS. 16 to 19 indicate a common region 34 of the NTSC chromaticity region 32 and the EBU chromaticity region 33. The NTSC chromaticity region 32, the EBU chromaticity region 33, and the common region 34 are defined by the chromaticity coordinates shown in Table 1.

TABLE 1

| | | CIE1931 | | CIE1976 | |
|---|---|---|---|---|---|
| | | COORDINATES | | COORDINATES | |
| | | x | y | u′ | v′ |
| NTSC | R | 0.6700 | 0.3300 | 0.4769 | 0.5285 |
| | G | 0.2100 | 0.7100 | 0.0757 | 0.5757 |
| | B | 0.1400 | 0.0800 | 0.1522 | 0.1957 |
| EBU | R | 0.6400 | 0.3300 | 0.4507 | 0.5229 |
| | G | 0.3000 | 0.6000 | 0.1250 | 0.5625 |
| | B | 0.1500 | 0.0600 | 0.1754 | 0.1579 |
| INTERSECTION | RB LINE- | 0.4616 | 0.2317 | 0.3801 | 0.4293 |
| B/W NTSC AND | RB LINE | | | | |
| EBU | RB LINE- | 0.1579 | 0.0884 | 0.1686 | 0.2125 |
| | BG LINE | | | | |

The x and y values in Table 1 are the values of the chromaticity coordinates in the CIE1931 chromaticity diagram shown in FIGS. 16 and 18. According to the present embodiment, the coordinates as a reference for “white” are at (0.272, 0.277) in the CIE1931 chromaticity diagrams shown in FIGS. 16 and 18. As the x value and the y value are decreased from the white reference coordinates, the chromaticity is shifted toward blue (i.e., bluishness is enhanced). Conversely, as the x value and the y value increase, the chromaticity is shifted toward the yellow side (i.e., yellowishness is enhanced). The u′ and v′ values in Table 1 are the values of the chromaticity coordinates in the CIE1976 chromaticity diagrams shown in FIGS. 17 and 19. According to the present embodiment, the coordinates as a reference for “white” are at (0.1882, 0.4313) in the CIE1976 chromaticity diagrams shown in FIGS. 17 and 19. As the v′ value are decreased from the white reference coordinates, the chromaticity is shifted toward blue (i.e., bluishness is enhanced). Conversely, as the v′ value increases, the chromaticity is shifted to the yellow side (i.e., yellowishness is enhanced).

The NTSC chromaticity region 32, the EBU chromaticity region 33, and the common region 34 will be described in detail. The NTSC chromaticity region 32 is defined by the chromaticity coordinates shown in Table 1. Specifically, in the CIE1931 chromaticity diagram shown in FIGS. 16 and 18, the NTSC chromaticity region 32 has the values of (x, y) in a region within a triangle with the vertices at the three points of a blue primary color point (0.14, 0.08), a green primary color point (0.21, 0.71), and a red primary color point (0.67, 0.33); in the CIE1976 chromaticity diagram shown in FIGS. 17 and 19, the NTSC chromaticity region 32 has the values of (u′, v′) in a region within a triangle with the vertices at the three points of a green primary color point (0.0757, 0.5757), a blue primary color point (0.1522, 0.1957), and a red primary color point (0.4769, 0.5285). The EBU chromaticity region 33 is defined by the chromaticity coordinates shown in Table 2. Specifically, in the CIE1931 chromaticity diagram of FIGS. 16 and 18, the EBU chromaticity region 33 has the values of (x, y) in a region within a triangle with the vertices at the three points of a blue primary color point (0.15, 0.06), a green primary color point (0.3, 0.6), and a red primary color point (0.64, 0.33); in the CIE1976 chromaticity diagram of FIGS. 17 and 19, the EBU chromaticity region 33 has the values of (u′, v′) in a region within a triangle with the vertices at the three points of a green primary color point (0.1250, 0.5625), a blue primary color point (0.1754, 0.1579), and a red primary color point (0.4507, 0.5229).

The common region 34 is defined by the quadrangular region in which the two triangles of the NTSC chromaticity region 32 and the EBU chromaticity region 33 overlap with each other. The common region 34 is a chromaticity region required by both the NTSC standard and the EBU standard and is therefore a very important region for maintaining more than predetermined level of display image display quality (color reproducibility). Specifically, the common region 34, in the CIE1931 chromaticity diagrams of FIGS. 16 and 18, is the region within the quadrangle with the vertices at the four points where the values of (x, y) are (0.1579, 0.0884) where the line (RB line) connecting the red primary color point and the blue primary color point of the NTSC chromaticity region 32 intersects the line (BG line) connecting the blue primary color point and the green primary color point of the EBU chromaticity region 33, (0.3, 0.6), (0.4616, 0.2317) where the RB line of the NTSC chromaticity region 32 intersects the RB line of the EBU chromaticity region 33, and (0.64, 0.33). In the CIE1976 chromaticity diagrams shown in FIGS. 17 and 19, the common region 34 is the region within the quadrangle with the vertices at the four points where the values of (u′, v′) are (0.125, 0.5625), (0.1686, 0.2125) where the RB line of the NTSC chromaticity region 32 intersects the BG line of the EBU chromaticity region 33, (0.3801, 0.4293) where the RB line of the NTSC chromaticity region 32 intersects the RB line of the EBU chromaticity region 33, and (0.4507, 0.5229).

<First Comparative Experiment>

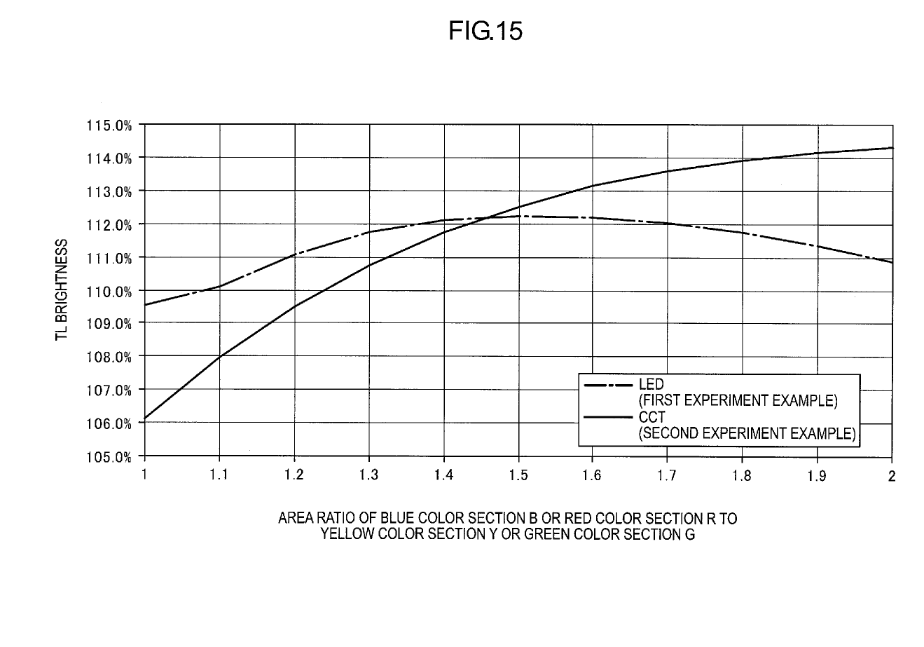

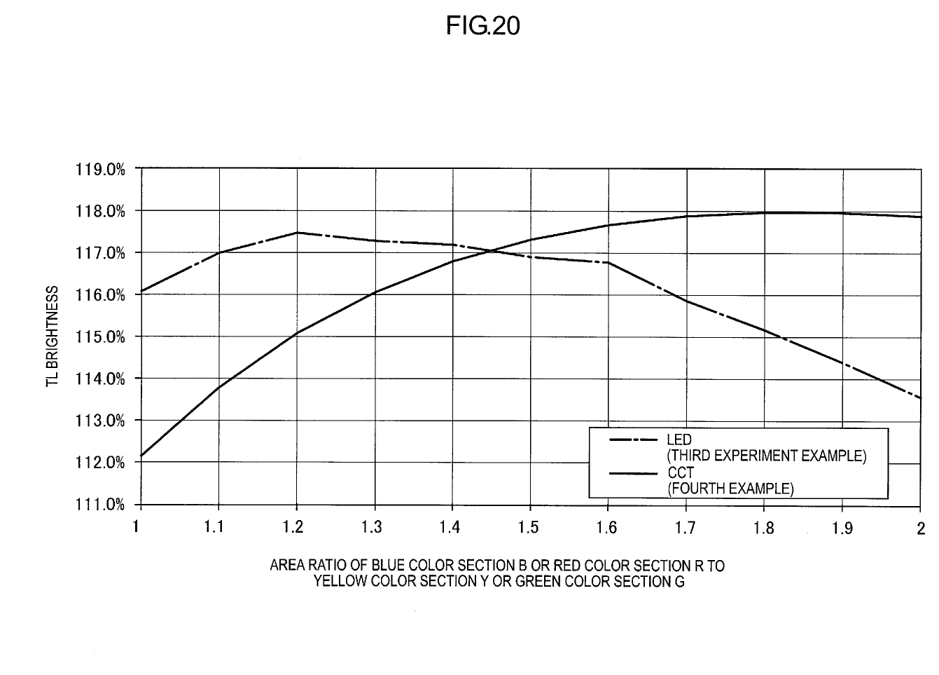

A first comparative experiment will be described in detail. The first comparative experiment involves a first experiment example in which the LEDs 24 are used as the light sources in the edge light backlight unit 12; a second experiment example in which the cold cathode tubes 31 are used as the light sources in the edge light backlight unit 12; a third experiment example in which LEDs 44 are used as the light sources in the direct backlight unit 40; and a fourth experiment example in which cold cathode tubes 52 are used as the light sources in the direct backlight unit 40. In each of the experiment examples, the chromaticity and brightness of the light sources 24 or 31 after chromaticity adjustment as a result of changes in the area ratio of the color sections R, G, B, and Y are measured, and also the chromaticity and brightness of the transmitted light from the liquid crystal panel 11 are measured. The results of the measurements are shown in the following Tables 2 to 5 and in FIGS. 15 to 20. Specifically, the experimental result from the first experiment example is shown in Table 2 and FIGS. 15 to 17; the experimental result from the second experiment example is shown in Table 3 and FIGS. 15, 18, and 19; the experimental result from the third experiment example is shown in Table 4 and FIG. 20; and the experimental result from the fourth experiment example is shown in Table 5 and FIG. 20.

In each of the experiment examples, chromaticity and brightness are measured in a first comparative example in which a three-color liquid crystal panel (not shown) with three color sections R, G, and B of the same area (i.e., with equal area ratios) is used; a second comparative example in which a four-color liquid crystal panel (not shown) with four color sections R, G, B, and Y of the same area (i.e., with equal area ratios) is used; and an example in which the four-color liquid crystal panel 11 with a relatively large area ratio of the blue color section B and the red color section R with respect to the yellow color section Y and the green color section G. In the exemplary examples in each experiment example, each of chromaticity and brightness is repeatedly measured by incrementing the area ratio of the blue color section B and the red color section R by 0.1 until it reaches 2.0 at the maximum where their area is twice as large as the area of the yellow color section Y and the green color section G. In Tables 2 to 5, as for the area ratios of the color sections R, G, B, and Y, the area of the yellow color section Y or the green color section G id defined as 1 (reference).

In the experiment examples, chromaticity is appropriately adjusted as the area ratios of the color sections R, G, B, and Y for the light sources 24 or 31 are changed to correct chromaticity of the transmitted light (display image) from the liquid crystal panel to be white. The chromaticity of the colors of transmitted light shown in Tables 2 to 5 is obtained by measurement with a spectrophotometer, for example, of the transmitted light which is transmitted through the color sections R, G, B, and Y included in the color filter 19 while controlling the driving of the TFTs 14 to display the respective colors. In FIGS. 15 and 20, the dot and dash line indicates the graph according to the LEDs (the first experiment example or the third experiment example), and the solid line indicates the graph according to the cold cathode tubes (CCT) (the second experiment example or the fourth experiment example). The legends for the chromaticity diagrams shown in FIGS. 16 to 19 note the number of colors (3 or 4 colors) of the color sections of the liquid crystal panels according to the comparative example and the exemplary example, and the values of the area ratio (1.0 to 2.0) of the blue color section B and the red color section R to the yellow color section Y and the green color section G.

The X, Y, and Z values shown in Tables 2 to 5 indicate the tristimulus values in an XYZ color system. Particularly, the Y value is used as an index of luminance, i.e., brightness. According to the present embodiment, the brightness of the light source (LS BRIGHTNESS) and transmitted light (TL BRIGHTNESS) are calculated on the basis of the Y value, and the brightness shown in Tables 2 to 5 indicates relative values with respect to the brightness of the comparative example as 100% (reference). Specifically, the brightness of the light source is calculated on the basis of the Y value at the “chromaticity of the light source (LS CHROMATICITY)”, and the brightness of the transmitted light is calculated on the basis of the Y value at the “chromaticity of the transmitted light at the time of white display (WH Chromaticity)”. The x value and the y value may be expressed by using the X value, the Y value, and the Z value above described according to the following expressions (1) and (2). Similarly, the u′ and v′ values can also be expressed by using the X value, the Y value, and the Z value according to expressions (3) and (4).

[Expression 1]

x=X/(X+Y+Z) (1)

[Expression 2]

y=Y/(X+Y+Z) (2)

[Expression 3]

u′=4X/(X+15Y+3Z) (3)

[Expression 4]

v′=9Y/(X+15Y+3Z) (4)

The configuration of the edge light backlight unit 12 using the LEDs 24 as the light sources according to the first experiment example is as described above (see FIGS. 6 to 9). The configuration of the edge light backlight unit 12 using the cold cathode tubes 31 as the light sources according to the second experiment example is also as described above (see FIGS. 10 to 12). In the following, the configuration of the direct backlight unit 40 according to the third and forth experiment examples will be described.

First, the configuration of the direct backlight unit 40 according to the third experiment example using the LEDs 44 as the light sources will be described. The backlight unit 40, as shown in FIG. 21, includes a substantially box-shaped chassis 41 with an opening on the light output surface side (the side of the liquid crystal panel 11); a group of optical members 42 covering the opening of the chassis 41; and a frame 43 disposed along the outer edges of the chassis 41 to sandwich the outer edges of the optical members 42 with the chassis 41. Further, in the chassis 41, there are provided the LEDs 44 disposed immediately under the optical member 41 (liquid crystal panel 11) in an opposed manner; LED boards 45 on which the LEDs 44 are mounted; and diffuser lenses 46 attached to the LED boards 45 at positions corresponding to the respective LEDs 44. The chassis 41 further includes holding members 47 holding the LED boards 45 between the holding members 47 and the chassis 41, and a reflection sheet 48 reflecting the light in the chassis 41 toward the optical members 42. Thus, the backlight unit 40 according to the third experiment example is of the direct type without the light guide member 26 used in the edge light backlight unit 12 (FIGS. 6 to 12). The configuration of the optical members 42 may be similar to that of the edge light backlight unit 12 and therefore redundant description will be omitted. Description of the configuration of the frame 43 is omitted as it may be similar to that of the edge light backlight unit 12 except for the absence of the first reflection sheets 28. Next, the constituent components of the backlight unit 40 will be described in detail.

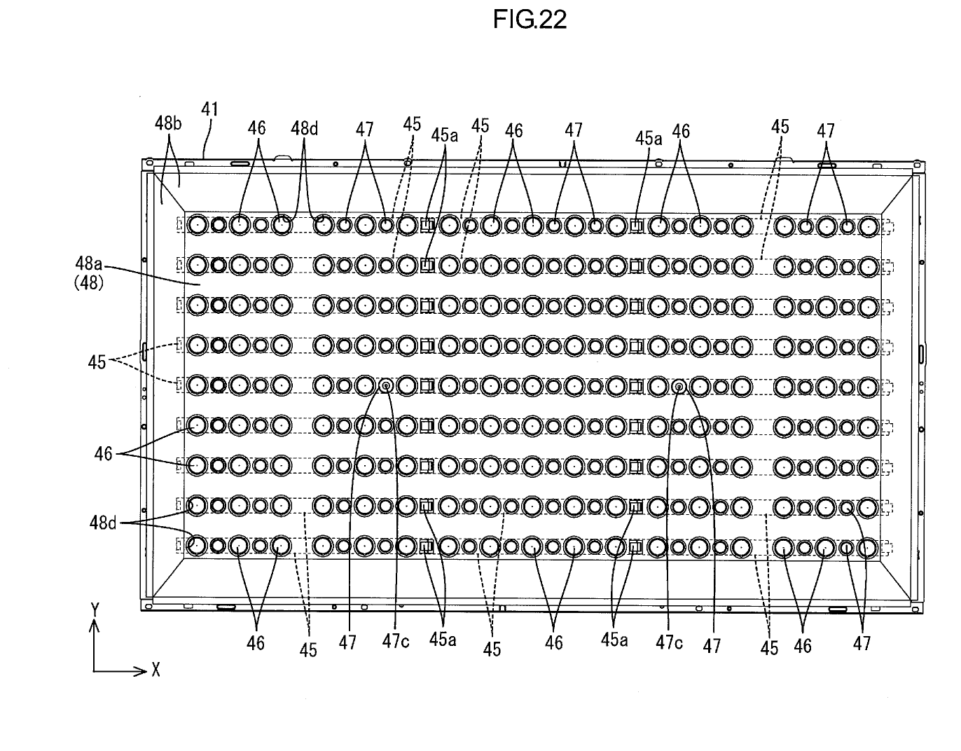

The chassis 41 may be made of a metal and include, as shown in FIGS. 22 to 24, a bottom plate 41a with a horizontally long square shape (rectangular shape; elongated square shape) similar to the liquid crystal panel 11; side plates 41b rising from the outer ends of the respective sides of the bottom plate 41a (a pair of long sides and a pair of short sides) toward the front side (light output side); and backing plates 41c extending outward from the rising ends of the side plates 41b. Thus, the chassis 41 as a whole has a shallow substantially box-like (substantially shallow dish-like) shape opening toward the front side. The chassis 41 has alongside direction aligned with the X-axis direction (horizontal direction) and a short side direction aligned with the Y-axis direction (vertical direction). The backing plates 41c of the chassis 41 are configured to receive the frame 43 and then the optical members 42, which will be described later, from the front side. The frame 43 is secured to the backing plates 41c by screws. The bottom plate 41a of the chassis 41 has open attaching holes attaching the holding members 47. Specifically, a plurality of the attaching holes is distributed on the bottom plate 41a at positions corresponding to the holding members 47.

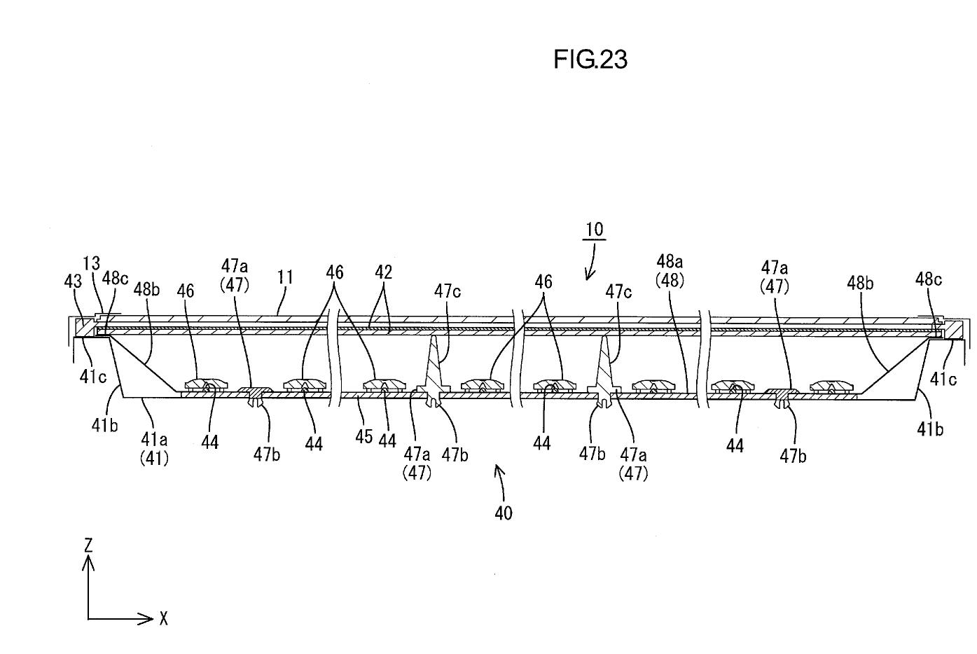

Next, the LED boards 45 on which the LEDs 44 are mounted will be described. The detailed configuration of the LEDs 44 may be similar to that of the LEDs 24 described with reference to the edge light backlight unit 12, and therefore redundant description will be omitted. The LED boards 45, as shown in FIG. 22, include base members with a horizontally long square shape in plan view. The LED boards 45 are housed in the chassis 41 along the bottom plate 41a, with a long side direction of the base members aligned with the X-axis direction and a short side direction thereof aligned with the Y-axis direction. The LEDs 44 are surface-mounted on one of the plate surfaces of the base members of the LED boards 45 that faces the front side (i.e., facing the optical members 42). The LEDs 44, as shown in FIG. 23, have a light emitting surface opposed to the optical members 42 (liquid crystal panel 11), with an optical axis aligned with the Z-axis direction, which is orthogonal to the display surface of the liquid crystal panel 11. A plurality of the LEDs 44, as shown in FIG. 22, is arranged linearly side by side along the long side direction of the LED boards 45 (X-axis direction), and which are connected in series by a wiring pattern formed on the LED boards 45. The respective LEDs 44 have a substantially constant arrangement pitch; namely, the LEDs 44 are arranged at regular intervals. At the ends of the LED boards 45 in the long side direction, connector portions 45a are provided.

A plurality of the LED boards 45 with the above-described configuration is arranged side by side along each of the X-axis direction and the Y-axis direction in the chassis 41, as shown in FIG. 22, with their long side directions and short side directions aligned with one another. Thus, the LED boards 45 and the LEDs 44 mounted thereon are arranged in rows and columns (i.e., in a matrix; planar arrangement) in the chassis 41, with the X-axis direction (the long side direction of the chassis 41 and the LED boards 45) corresponding to the row direction and the Y-axis direction (the short side direction of the chassis 41 and the LED boards 45) corresponding to the column direction. Specifically, a total of 27 LED boards 45, or three in the X-axis direction times nine in the Y-axis direction, are arranged side by side within the chassis 41. The LED boards 45 arranged along the X-axis direction to constitute an each single row are electrically connected to each other via fitting connection of the adjacent connector portions 45a. The connector portions 45a corresponding to the ends of the chassis 41 in the X-axis direction are electrically connected to an external control circuit, which is not shown. Thus, the LEDs 44 disposed on the LED boards 45 forming the each row are connected in series to control turning on or off of a number of the LEDs 44 included in each line at once with the single control circuit, thus contributing to a decrease in cost. The LED boards 45 disposed along the Y-axis direction have a substantially constant arrangement pitch. Thus, the LEDs 44 disposed along the bottom plate 41a in a planar manner within the chassis 41 are arranged at substantially regular intervals with respect to the X-axis direction and the Y-axis direction.

The diffuser lenses 46 are made of a substantially transparent (highly light transmissive) synthetic resin material (such as polycarbonate or acrylic material) with a refractive index higher than that of air. The diffuser lenses 46, as shown in FIGS. 22 and 23, have a predetermined thickness and are substantially circular in plan view. The diffuser lenses 46 are attached to the LED boards 45 in such a manner as to cover the LEDs 44 from the front side individually, i.e., to overlap with the individual LEDs 44 in plan view. The diffuser lenses 46 are configured to output the highly directional light emitted from the LEDs 44 while diffusing the light. Thus, the light emitted by the LEDs 44 has its directionality reduced through the diffuser lenses 46. Therefore, the regions between the adjacent LEDs 44 can be prevented from being visually recognized as dark portions even when the interval between the adjacent LEDs 44 is large. Accordingly, the installation number of the LEDs 44 can be decreased. The same number of the diffuser lenses 46 as the LEDs 44 installed on the LED boards 45 is installed at substantially concentric positions with the respective LEDs 44 in plan view.

The holding members 47 are made of a synthetic resin, such as polycarbonate resin, and has a white surface for excellent light reflectivity. The holding members 47, as shown in FIGS. 22 to 24, include main body portions 47a extending along the plate surface of the LED boards 45, and fixing portions 47b protruding from the main body portions 47a toward the rear side, i.e., toward the chassis 41 and fixed thereon. The main body portions 47a have a substantially circular plate-like shape in plan view, and are configured to sandwich the LED boards 45 and a reflection sheet 48, which will be described later, with the bottom plate 41a of the chassis 41. The fixing portions 47b are configured to be locked on the bottom plate 41a through the insertion holes and attaching holes formed in the LED boards 45 and the bottom plate 41a of the chassis 41 at positions corresponding to the holding members 47. As shown in FIG. 22, a number of the holding members 47 are arranged side by side in rows and columns in the plane of the LED boards 45. Specifically, the holding members 47 are disposed between the adjacent diffuser lenses 46 (LEDs 44) with respect to the X-axis direction.

A pair of the holding members 47 disposed at the center of the screen includes support portions 47c protruding from the main body portions 47a toward the front side, as shown in FIGS. 22 to 24 to support the optical members 42 from the rear side. Therefore, a constant positional relationship can be maintained between the LEDs 44 and the optical members 42 in the Z-axis direction and inadvertent deformation of the optical members 42 can be regulated.

The reflection sheet 48 is made of a synthetic resin and has a white surface for excellent light reflectivity. The reflection sheet 48, as shown in FIGS. 22 to 24, is dimensioned to be laid over substantially the entire area of the inner surface of the chassis 41 to cover all the LED boards 45 disposed in rows and columns in the chassis 41 at once from the front side. The reflection sheet 48 is configured to reflect the light in the chassis 41 toward the optical members 42. The reflection sheet 48 includes a bottom portion 48a extending along the bottom plate 41a of the chassis 41 and dimensioned to cover most of the bottom plate 41a; four rising portions 48b rising from the respective outer ends of the bottom portion 48a toward the front side and inclined with respect to the bottom portion 48a; and extension portions 48c extending outward from the outer ends of the rising portions 48b and placed on the backing plates 41d of the chassis 41. The bottom portion 48a of the reflection sheet 48 is disposed on the front side surface of the LED boards 45, i.e., on the front side with respect to the mounting surface for the LEDs 44. The bottom portion 48a of the reflection sheet 48 has lens insertion holes 48d inserting the diffuser lenses 46 at positions overlapping with the respective diffuser lenses 46 (LEDs 44) in plan view.

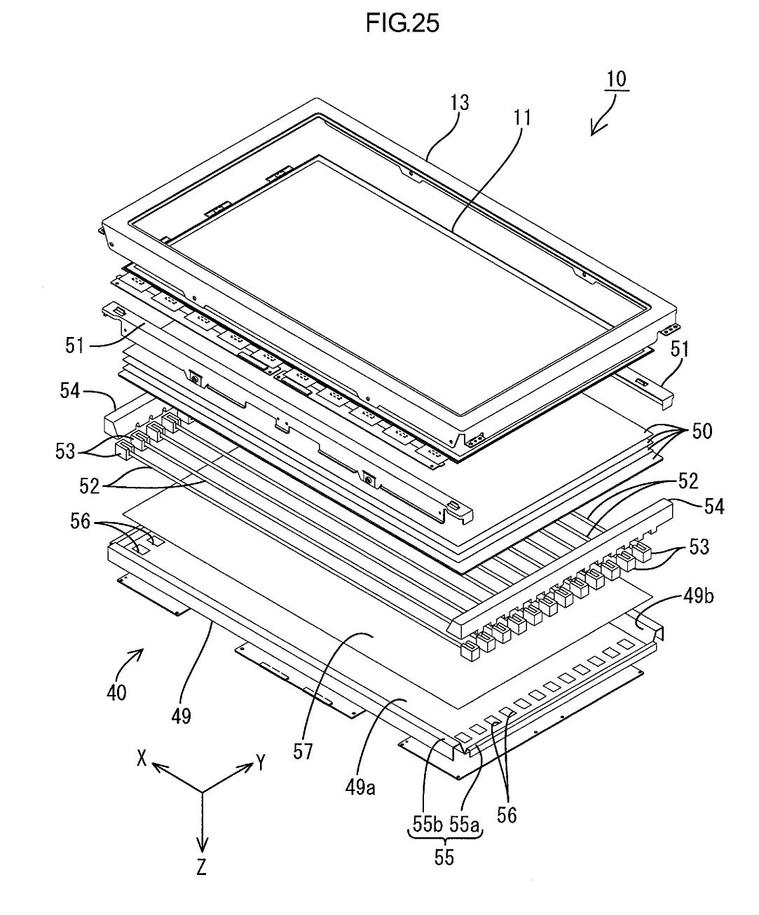

The configuration of the direct backlight unit 40 according to the fourth experiment example using the cold cathode tubes 52 as the light sources will be described. The backlight unit 40, as shown in FIG. 25, includes a substantially box-shaped chassis 49 opening on the light output surface side (the side of the liquid crystal panel 11); optical members 50 disposed in such a manner as to cover the opening 49b of the chassis 49; and frames 51 disposed along the long sides of the chassis 49 and holding the long side edges of the optical members 50 between the frames 51 and the chassis 49. Further, in the chassis 49, there are provided the cold cathode tubes 52 disposed immediately under the optical members 50 (liquid crystal panel 11) in an opposed manner; relay connectors 53 relaying electrical connection at the respective ends of the cold cathode tubes 52; and holders 54 covering the ends of the cold cathode tubes 52 and the relay connectors 53 all at once. The configuration of the optical members 50 may be similar to that of the edge light backlight unit 12; thus, redundant description of the configuration will be omitted.

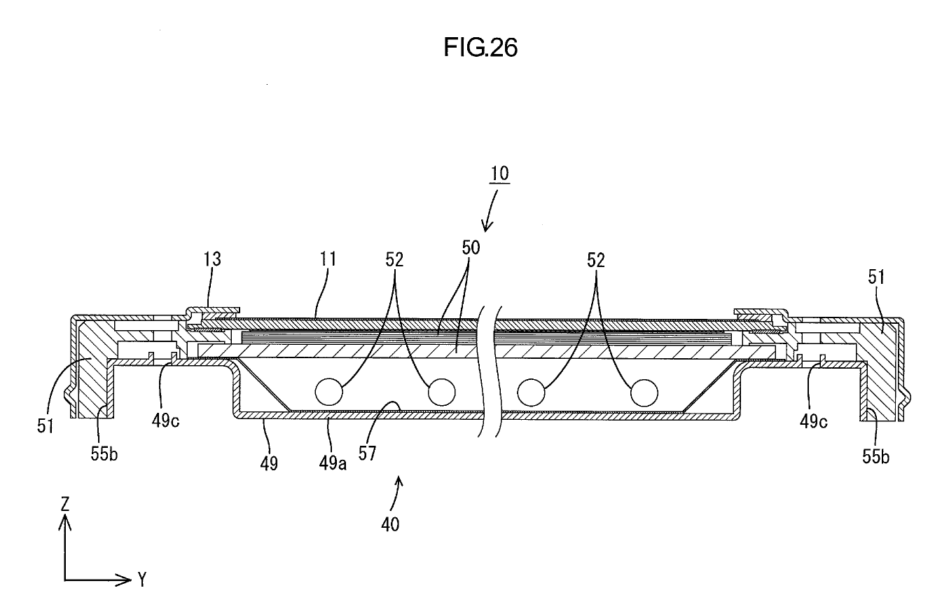

The chassis 49 is made of a metal and has a shallow substantially box-like shape formed by sheet metal forming, including a rectangular-shaped bottom plate 49a and folded outer edges 55 (including folded outer edges 55a in the short side direction and folded outer edges 55b in the long side direction) rising from the respective sides of the bottom plate 49a and folded into substantially U-shape. The bottom plate 49a of the chassis 49 has a plurality of connector attaching holes 56 attaching the relay connectors 53 at the ends in the long side direction. Further, in the upper surface of the folded outer edges 55b of the chassis 49, as shown in FIG. 26, fixing holes 49c are formed. Thus, the bezel 13, the frames 51, the chassis 49, and the like can be integrated by using screws, for example.

On the inner surface side of the bottom plate 49a of the chassis 49 (i.e., the side of the surface opposed to the cold cathode tubes 52 and a diffuser plate 53a; the front surface side), a reflection sheet 57 is disposed. The reflection sheet 57 is made of a synthetic resin and has a white surface for excellent reflectivity. The reflection sheet 57 is laid along and over substantially the entire area of the bottom plate surface of the chassis 49. The reflection sheet 57 constitutes a reflecting surface reflecting the light emitted by the cold cathode tubes 52 toward the diffuser plate 53a, in the chassis 49. The long side edges of the reflection sheet 57, as shown in FIG. 26, rise in such a manner as to cover the folded outer edges 55b of the chassis 49 and are sandwiched between the chassis 49 and the diffuser plate 53a. Thus, the light emitted by the cold cathode tubes 52 can be reflected by the reflection sheet 57 toward the diffuser plate 53a.

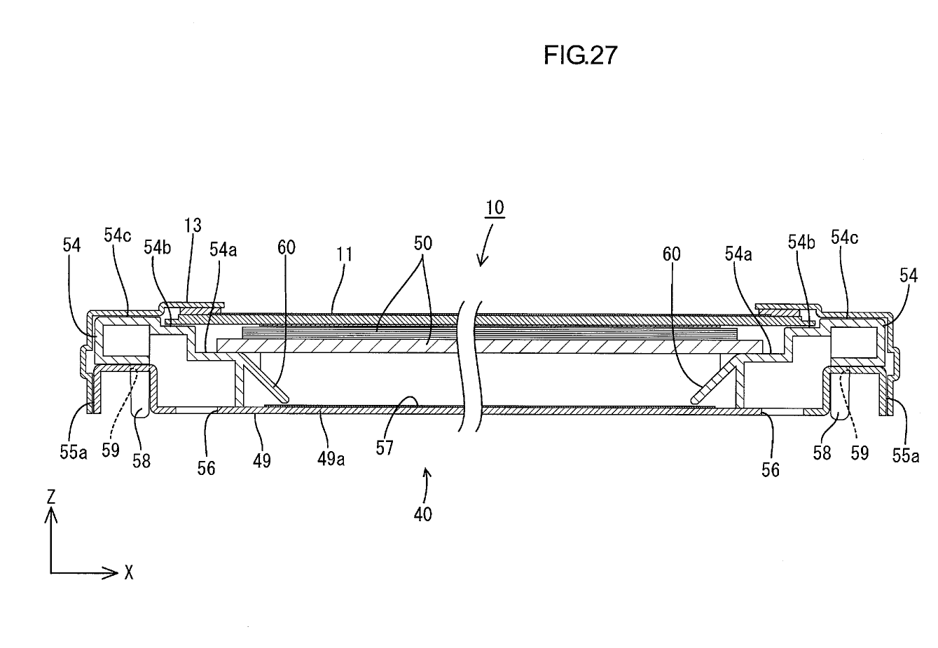

The cold cathode tubes 52, as shown in FIG. 25, have a long tubular shape and are housed in the chassis 49 with a length direction (axial direction) aligned with the long side direction of the chassis 49 (X-axis direction). The cold cathode tubes 52 are arranged at a predetermined interval along the short side direction of the chassis 49 (Y-axis direction) with the axes of the cold cathode tubes 52 aligned substantially in parallel with each other. The cold cathode tubes 52 are apart slightly from the bottom plate 49a of the chassis 49 (reflection sheet 57) with the ends thereof fitted in the relay connectors 53, on which the holders 54 are attached to cover the connectors 53. The relay connectors 53 are connected to an inverter substrate (not shown) supplying electric power for driving the cold cathode tubes 52. The detailed configuration of the cold cathode tubes 52 may be similar to that of the cold cathode tubes 31 described with reference to the edge light backlight unit 12; thus, redundant description of the configuration will be omitted. In FIG. 27, illustration of the cold cathode tubes 52 is omitted.

The holders 54 are made of a white synthetic resin and have a long substantially box-like shape covering the ends of the cold cathode tubes 52 and extending along the short side direction of the chassis 49. The holders 54, as shown in FIG. 27, have a stepped surface on the front side, on which the optical members 50 or the liquid crystal panel 11 can be placed at different levels. The holders 54 partially overlap with the folded outer edges 55a of the chassis 49 along the short side direction, thus forming the side walls of the backlight unit 40 together with the folded outer edges 55a. Insertion pins 58 protrude from the surface of the holders 54 opposed to the folded outer edges 55a of the chassis 49 to be inserted into insertion holes 59 formed in the upper surface of the folded outer edges 55a of the chassis 49. Thus, the holders 54 can be attached to the chassis 49.

The stepped surface of the holders 54 includes three surfaces parallel with the bottom plate surface of the chassis 49. On a first surface 54a, which is at the lowest position, the short side edges of the optical members 50 are placed. From the first surface 54a, inclined covers 60 extend toward the bottom plate surface of the chassis 49. On a second surface 54b of the stepped surface of the holders 54, the short side edges of the liquid crystal panel 11 are placed. A third surface 54c, which is at the highest position of the stepped surface of the holders 54, is disposed at a position overlapping with the folded outer edges 55a of the chassis 49, and is in contact with the bezel 13.

TABLE 2
FIRST EXPERIMENT EXAMPLE

| | | C. EX. 1 | C. EX. 2 | EX. | | | |
|---|---|---|---|---|---|---|---|
| LIGHT SOURCE | | LED | | | | | |
| AREA | | 1 | 1 | 1.1 | 1.2 | 1.3 | 1.4 |
| RATIO | | 0 | 1 | 1 | 1 | 1 | 1 |
| | | 1 | 1 | 1 | 1 | 1 | 1 |
| | | 1 | 1 | 1.1 | 1.2 | 1.3 | 1.4 |
| LS BRIGHTNESS | | 100.00% | 78.91% | 81.41% | 84.22% | 86.82% | 89.23% |
| (LED) | | | | | | | |
| TL BRIGHTNESS | | 100.00% | 109.52% | 110.09% | 111.08% | 111.73% | 112.10% |
| LS CHRO- | x | 0.2444 | 0.2074 | 0.2103 | 0.2128 | 0.215 | 0.2172 |
| MATICITY | y | 0.2067 | 0.1358 | 0.1423 | 0.1494 | 0.1562 | 0.1626 |
| (LED) | u′ | 0.1958 | 0.1968 | 0.1962 | 0.1949 | 0.1935 | 0.1923 |
| | v′ | 0.3727 | 0.29 | 0.2967 | 0.3079 | 0.3163 | 0.324 |
| | X | 201.9441 | 205.7999 | 205.4727 | 204.8423 | 204.1693 | 203.4973 |
| | Y | 170.8012 | 134.7787 | 139.0543 | 143.8548 | 148.2976 | 152.4046 |
| | Z | 453.3839 | 651.8115 | 832.6483 | 614.0281 | 597.0767 | 581.1379 |
| WH CHRO- | x | 0.2711 | 0.2711 | 0.272 | 0.2722 | 0.2723 | 0.2724 |
| MATICITY | y | 0.2771 | 0.2779 | 0.2761 | 0.2761 | 0.2761 | 0.2761 |
| | u′ | 0.1875 | 0.1872 | 0.1886 | 0.1887 | 0.1888 | 0.1889 |
| | v′ | 0.4312 | 0.4318 | 0.4307 | 0.4307 | 0.4308 | 0.4308 |
| | X | 1.754442 | 1.915593 | 1.9448 | 1.963885 | 1.975957 | 1.98386 |
| | Y | 1.79323 | 1.963968 | 1.974235 | 1.991949 | 2.003581 | 2.01029 |
| | Z | 2.924354 | 3.187331 | 3.231922 | 3.259436 | 3.27821 | 3.267619 |
| RED CHRO- | x | 0.6443 | 0.6383 | 0.6343 | 0.6345 | 0.6345 | 0.6345 |
| MATICITY | y | 0.341 | 0.3365 | 0.3374 | 0.3386 | 0.3397 | 0.3407 |
| | u′ | 0.4441 | 0.4389 | 0.4389 | 0.438 | 0.437 | 0.4361 |
| | v′ | 0.5288 | 0.5247 | 0.5253 | 0.5259 | 0.5264 | 0.5269 |
| | X | 0.670583 | 0.348747 | 0.378426 | 0.401522 | 0.421742 | 0.440616 |
| | Y | 0.354873 | 0.18529 | 0.201267 | 0.214255 | 0.225803 | 0.236629 |
| | Z | 0.015328 | 0.016637 | 0.016682 | 0.017033 | 0.017139 | 0.017195 |
| YELLOW | x | — | 0.4113 | 0.4113 | 0.4093 | 0.4073 | 0.4055 |
| CHRO- | y | — | 0.5687 | 0.5595 | 0.5621 | 0.5646 | 0.5668 |
| MATICITY | u′ | — | 0.1852 | 0.185 | 0.1834 | 0.1818 | 0.1804 |
| | v′ | — | 0.5661 | 0.5663 | 0.5667 | 0.5671 | 0.5674 |
| | X | — | 0.685097 | 0.658153 | 0.64919 | 0.638578 | 0.627577 |
| | Y | — | 0.903409 | 0.89528 | 0.891411 | 0.885205 | 0.877213 |
| | Z | — | 0.048443 | 0.04667 | 0.045308 | 0.044038 | 0.04281 |
| GREEN | x | 0.2967 | 0.2886 | 0.2692 | 0.2894 | 0.2895 | 0.2896 |
| CHRO- | y | 0.6524 | 0.6425 | 0.6442 | 0.6464 | 0.6483 | 0.65 |
| MATICITY | u′ | 0.116 | 0.1139 | 0.1139 | 0.1137 | 0.1136 | 0.1133 |
| | v′ | 0.5737 | 0.5707 | 0.5711 | 0.5716 | 0.572 | 0.5724 |
| | X | 0.550371 | 0.307739 | 0.304954 | 0.30402 | 0.302308 | 0.299935 |
| | Y | 1.210123 | 0.585226 | 0.679222 | 0.679003 | 0.677026 | 0.673274 |
| | Z | 0.09443 | 0.073537 | 0.070193 | 0.067457 | 0.064981 | 0.062623 |
| BLUE | x | 0.1514 | 0.1524 | 0.1523 | 0.1522 | 0.1521 | 0.152 |
| CHRO- | y | 0.0664 | 0.0488 | 0.0485 | 0.0504 | 0.0523 | 0.0542 |
| MATICITY | u′ | 0.1733 | 0.1872 | 0.1859 | 0.1845 | 0.1831 | 0.1817 |
| | v′ | 0.171 | 0.1293 | 0.1332 | 0.1374 | 0.1416 | 0.1458 |
| | X | 0.536788 | 0.569168 | 0.579512 | 0.586615 | 0.591997 | 0.595564 |
| | Y | 0.235484 | 0.174982 | 0.18451 | 0.194409 | 0.203756 | 0.212441 |
| | Z | 2.772155 | 2.990956 | 3.041105 | 3.073368 | 3.096698 | 3.110332 |
| | | EX. | | | | | |
| LIGHT SOURCE | | LED | | | | | |
| AREA | | 1.5 | 1.6 | 1.7 | 1.8 | 1.9 | 2 |
| RATIO | | 1 | 1 | 1 | 1 | 1 | 1 |
| | | 1 | 1 | 1 | 1 | 1 | 1 |
| | | 1.5 | 1.6 | 1.7 | 1.8 | 1.9 | 2 |
| LS BRIGHTNESS | | 91.44% | 93.51% | 95.46% | 97.27% | 98.96% | 100.56% |
| (LED) | | | | | | | |
| TL BRIGHTNESS | | 112.24% | 112.21% | 112.03% | 111.73% | 111.33% | 110.85% |
| LS CHRO- | x | 0.2192 | 0.2211 | 0.2228 | 0.2244 | 0.2259 | 0.2273 |
| MATICITY | y | 0.1688 | 0.1747 | 0.1804 | 0.1857 | 0.1909 | 0.1959 |
| (LED) | u′ | 0.1911 | 0.19 | 0.1888 | 0.1878 | 0.1867 | 0.1857 |
| | v′ | 0.3312 | 0.3378 | 0.344 | 0.3497 | 0.3551 | 0.3601 |
| | X | 202.8314 | 202.144 | 201.4231 | 200.6926 | 139.9873 | 199.236 |
| | Y | 156.1853 | 159.7225 | 163.0398 | 166.1393 | 169.0332 | 171.7613 |
| | Z | 566.213 | 552.3052 | 539.5449 | 527.6465 | 516.3861 | 505.7173 |
| WH CHRO- | x | 0.2727 | 0.2729 | 0.2729 | 0.2729 | 0.2729 | 0.2729 |
| MATICITY | y | 0.2761 | 0.2761 | 0.2761 | 0.2761 | 0.2761 | 0.2761 |
| | u′ | 0.1891 | 0.1893 | 0.1893 | 0.1893 | 0.1893 | 0.1893 |
| | v′ | 0.4308 | 0.4309 | 0.4309 | 0.4309 | 0.4309 | 0.4309 |
| | X | 1.98827 | 1.989062 | 1.986115 | 1.98071 | 1.973776 | 1.965323 |
| | Y | 2.012684 | 2.012102 | 2.008931 | 2.003535 | 1.69634 | 1.987881 |
| | Z | 3.289937 | 3.287157 | 3.281704 | 3.273262 | 3.261577 | 3.247302 |
| RED CHRO- | x | 0.6345 | 0.6344 | 0.6342 | 0.6339 | 0.6338 | 0.6333 |
| MATICITY | y | 0.3417 | 0.3426 | 0.3435 | 0.3443 | 0.3451 | 0.3459 |
| | u′ | 0.4352 | 0.4343 | 0.4334 | 0.4324 | 0.4315 | 0.4305 |
| | v′ | 0.5274 | 0.5278 | 0.5281 | 0.5284 | 0.5288 | 0.5291 |
| | X | 0.458223 | 0.473917 | 0.487186 | 0.498865 | 0.509574 | 0.519131 |
| | Y | 0.246766 | 0.255925 | 0.263688 | 0.270986 | 0.277574 | 0.283557 |
| | Z | 0.017215 | 0.017209 | 0.017187 | 0.017151 | 0.017097 | 0.017029 |
| YELLOW | x | 0.404 | 0.4024 | 0.4007 | 0.399 | 0.3975 | 0.396 |
| CHRO- | y | 0.5688 | 0.5706 | 0.5726 | 0.5745 | 0.5762 | 0.5779 |
| MATICITY | u′ | 0.1792 | 0.178 | 0.1767 | 0.1755 | 0.1744 | 0.1733 |
| | v′ | 0.5677 | 0.5679 | 0.5682 | 0.5684 | 0.5687 | 0.5689 |
| | X | 0.616267 | 0.604536 | 0.592235 | 0.579842 | 0.567654 | 0.555678 |
| | Y | 0.867705 | 0.857338 | 0.846319 | 0.834774 | 0.822853 | 0.810803 |
| | Z | 0.041629 | 0.040515 | 0.039474 | 0.038486 | 0.037537 | 0.036632 |
| GREEN | x | 0.2896 | 0.2897 | 0.2896 | 0.2896 | 0.2895 | 0.2894 |
| CHRO- | y | 0.6514 | 0.6528 | 0.654 | 0.6551 | 0.6561 | 0.6571 |
| MATICITY | u′ | 0.1132 | 0.113 | 0.1128 | 0.1127 | 0.1125 | 0.1123 |
| | v′ | 0.5727 | 0.573 | 0.5732 | 0.5734 | 0.5736 | 0.5738 |
| | X | 0.296997 | 0.293762 | 0.29032 | 0.286683 | 0.282886 | 0.279027 |
| | Y | 0.668005 | 0.662008 | 0.655585 | 0.648537 | 0.641178 | 0.633493 |
| | Z | 0.060429 | 0.058395 | 0.056522 | 0.054773 | 0.053121 | 0.051566 |
| BLUE | x | 0.1519 | 0.1518 | 0.1517 | 0.1516 | 0.1515 | 0.1515 |
| CHRO- | y | 0.058 | 0.0578 | 0.0596 | 0.0613 | 0.063 | 0.0647 |
| MATICITY | u′ | 0.1804 | 0.1791 | 0.1779 | 0.1767 | 0.1755 | 0.1745 |
| | v′ | 0.1496 | 0.1535 | 0.1572 | 0.1607 | 0.1642 | 0.1676 |
| | X | 0.597734 | 0.59888 | 0.599451 | 0.599395 | 0.598675 | 0.597415 |
| | Y | 0.220507 | 0.228132 | 0.235435 | 0.242355 | 0.248858 | 0.255025 |
| | Z | 3.116833 | 3.118024 | 3.116284 | 3.111375 | 3.103098 | 3.09209 |

TABLE 3
SECOND EXPERIMENT EXAMPLE

| | | C. EX. 1 | C. EX. 2 | EX. | | | |
|---|---|---|---|---|---|---|---|
| LIGHT SOURCE | | CCT | | | | | |
| AREA | R | 1 | 1 | 1.1 | 1.2 | 1.3 | 1.4 |
| RATIO | Y | 0 | 1 | 1 | 1 | 1 | 1 |
| | G | 1 | 1 | 1 | 1 | 1 | 1 |
| | B | 1 | 1 | 1.1 | 1.2 | 1.3 | 1.4 |
| LS BRIGHTNESS | | 100.0% | 77.88% | 81.07% | 84.14% | 87.07% | 89.86% |
| (CCT) | | | | | | | |
| TL BRIGHTNESS | | 100.0% | 106.11% | 107.97% | 109.50% | 110.75% | 111.74% |
| LS CHRO- | x | 0.2458 | 0.2081 | 0.2106 | 0.2128 | 0.2148 | 0.2167 |
| MATICITY | y | 0.2156 | 0.1461 | 0.1532 | 0.1601 | 0.1666 | 0.1729 |
| (CCT) | u′ | 0.193 | 0.1919 | 0.1907 | 0.1893 | 0.188 | 0.1868 |
| | v′ | 0.3808 | 0.3032 | 0.3121 | 0.3205 | 0.3281 | 0.3353 |
| | X | 280.0107 | 272.5129 | 273.6162 | 274.6766 | 275.6907 | 276.6586 |
| | Y | 245.6253 | 191.2968 | 199.1397 | 206.6779 | 213.863 | 220.7251 |
| | Z | 613.4152 | 845.5231 | 826.7283 | 809.6743 | 793.8454 | 779.2417 |
| WH CHRO- | x | 0.275 | 0.275 | 0.275 | 0.275 | 0.275 | 0.275 |
| MATICITY | y | 0.283 | 0.283 | 0.283 | 0.283 | 0.283 | 0.283 |
| | u′ | 0.1882 | 0.1882 | 0.1882 | 0.1882 | 0.1882 | 0.1882 |
| | v′ | 0.4357 | 0.4357 | 0.4357 | 0.4357 | 0.4357 | 0.4357 |
| | X | 2.520577 | 2.673469 | 2.721633 | 2.76031 | 2.791646 | 2.816553 |
| | Y | 2.593397 | 2.751807 | 2.80003 | 2.839841 | 2.872166 | 2.897824 |
| | Z | 4.050361 | 4.297726 | 4.373832 | 4.436331 | 4.486186 | 4.5264 |
| RED CHRO- | x | 0.6386 | 0.6333 | 0.6329 | 0.6323 | 0.6318 | 0.6313 |
| MATICITY | y | 0.3469 | 0.3399 | 0.3413 | 0.3427 | 0.344 | 0.3452 |
| | u′ | 0.434 | 0.4358 | 0.4343 | 0.4325 | 0.4309 | 0.4295 |
| | v′ | 0.5305 | 0.5263 | 0.5269 | 0.5274 | 0.5279 | 0.5284 |
| | X | 1.073341 | 0.586107 | 0.623798 | 0.657727 | 0.688827 | 0.717193 |
| | Y | 0.583149 | 0.314554 | 0.336463 | 0.356482 | 0.375053 | 0.392207 |
| | Z | 0.024385 | 0.024833 | 0.025424 | 0.025922 | 0.026336 | 0.026685 |
| YELLOW | x | — | 0.414 | 0.4114 | 0.4089 | 0.4065 | 0.4042 |
| CHRO- | y | — | 0.5288 | 0.5336 | 0.538 | 0.542 | 0.5456 |
| MATICITY | u′ | — | 0.1944 | 0.1918 | 0.1893 | 0.1871 | 0.185 |
| | v′ | — | 0.5587 | 0.5597 | 0.5605 | 0.5613 | 0.5619 |
| | X | — | 0.953308 | 0.942807 | 0.930695 | 0.917774 | 0.904146 |
| | Y | — | 1.2177 | 1.222725 | 1.224571 | 1.223688 | 1.220415 |
| | Z | — | 0.131687 | 0.126035 | 0.121002 | 0.116437 | 0.11228 |
| GREEN | x | 0.2842 | 0.2614 | 0.2639 | 0.2661 | 0.2679 | 0.2694 |
| CHRO- | y | 0.6205 | 0.5958 | 0.6003 | 0.6043 | 0.6078 | 0.6108 |
| MATICITY | u′ | 0.1151 | 0.1086 | 0.1091 | 0.1095 | 0.1098 | 0.1101 |
| | v′ | 0.5654 | 0.557 | 0.5584 | 0.5596 | 0.5606 | 0.5615 |
| | X | 0.76575 | 0.398389 | 0.403371 | 0.406966 | 0.409314 | 0.41057 |
| | Y | 1.672097 | 0.908083 | 0.917501 | 0.924371 | 0.928737 | 0.930912 |
| | Z | 0.256871 | 0.217689 | 0.207425 | 0.198312 | 0.19008 | 0.182618 |
| BLUE | x | 0.145 | 0.1451 | 0.145 | 0.145 | 0.1449 | 0.1449 |
| CHRO- | y | 0.0726 | 0.0594 | 0.0607 | 0.0621 | 0.0634 | 0.0647 |
| MATICITY | u′ | 0.162 | 0.1696 | 0.1687 | 0.1679 | 0.167 | 0.1662 |
| | v′ | 0.1825 | 0.1562 | 0.1589 | 0.1618 | 0.1644 | 0.167 |
| | X | 0.687942 | 0.701108 | 0.719052 | 0.73421 | 0.746832 | 0.757479 |
| | Y | 0.344669 | 0.286837 | 0.300991 | 0.314258 | 0.326632 | 0.338252 |
| | Z | 3.712537 | 3.844431 | 3.937721 | 4.015636 | 4.079588 | 4.13272 |
| | | EX. | | | | | |
| LIGHT SOURCE | | CCT | | | | | |
| AREA | R | 1.5 | 1.6 | 1.7 | 1.8 | 1.9 | 2 |
| RATIO | Y | 1 | 1 | 1 | 1 | 1 | 1 |
| | G | 1 | 1 | 1 | 1 | 1 | 1 |
| | B | 1.5 | 1.6 | 1.7 | 1.8 | 1.9 | 2 |
| LS BRIGHTNESS | | 92.54% | 95.11% | 97.57% | 99.94% | 102.21% | 104.43% |
| (CCT) | | | | | | | |
| TL BRIGHTNESS | | 112.52% | 113.15% | 113.60% | 113.93% | 114.17% | 114.32% |
| LS CHRO- | x | 0.2185 | 0.2202 | 0.2217 | 0.2232 | 0.2245 | 0.2258 |
| MATICITY | y | 0.1789 | 0.1847 | 0.1902 | 0.1955 | 0.2007 | 0.2056 |
| (CCT) | u′ | 0.1856 | 0.1844 | 0.1833 | 0.1822 | 0.1811 | 0.1801 |
| | v′ | 0.3419 | 0.3481 | 0.3538 | 0.3591 | 0.3642 | 0.3689 |
| | X | 277.5864 | 278.4797 | 279.3333 | 280.153 | 280.9443 | 281.7125 |
| | Y | 227.299 | 233.6254 | 239.668 | 245.4675 | 251.0644 | 256.4947 |
| | Z | 765.6144 | 752.8423 | 740.9193 | 729.7241 | 719.1354 | 709.1593 |
| WH CHRO- | x | 0.275 | 0.275 | 0.275 | 0.275 | 0.275 | 0.275 |
| MATICITY | y | 0.283 | 0.283 | 0.283 | 0.283 | 0.283 | 0.283 |
| | u′ | 0.1882 | 0.1882 | 0.1882 | 0.1882 | 0.1882 | 0.1882 |
| | v′ | 0.4357 | 0.4357 | 0.4357 | 0.4357 | 0.4357 | 0.4357 |
| | X | 2.836315 | 2.851791 | 2.863458 | 2.871983 | 2.877938 | 2.881578 |
| | Y | 2.918183 | 2.934313 | 2.946206 | 2.95476 | 2.960758 | 2.964775 |
| | Z | 4.558064 | 4.582511 | 4.60136 | 4.615326 | 4.624868 | 4.63106 |
| RED CHRO- | x | 0.6307 | 0.6302 | 0.6296 | 0.6291 | 0.6285 | 0.628 |
| MATICITY | y | 0.3464 | 0.3475 | 0.3485 | 0.3495 | 0.3504 | 0.3513 |
| | u′ | 0.4279 | 0.4266 | 0.4252 | 0.4239 | 0.4227 | 0.4215 |
| | v′ | 0.5288 | 0.5292 | 0.5296 | 0.5299 | 0.5302 | 0.5305 |
| | X | 0.743222 | 0.767109 | 0.789061 | 0.809266 | 0.827912 | 0.84494 |
| | Y | 0.408143 | 0.422959 | 0.436739 | 0.449582 | 0.46159 | 0.472741 |
| | Z | 0.026975 | 0.027216 | 0.027417 | 0.027585 | 0.027721 | 0.027833 |
| YELLOW | x | 0.4021 | 0.4 | 0.3981 | 0.3964 | 0.3946 | 0.393 |
| CHRO- | y | 0.5489 | 0.552 | 0.5549 | 0.5575 | 0.56 | 0.5623 |
| MATICITY | u′ | 0.1831 | 0.1813 | 0.1797 | 0.1782 | 0.1767 | 0.1754 |
| | v′ | 0.5625 | 0.563 | 0.5635 | 0.5639 | 0.5643 | 0.5647 |
| | X | 0.890219 | 0.876197 | 0.862061 | 0.847981 | 0.834106 | 0.820442 |
| | Y | 1.215382 | 1.209061 | 1.201393 | 1.1927773 | 1.183541 | 1.173939 |
| | Z | 0.108471 | 0.104967 | 0.101725 | 0.098715 | 0.095913 | 0.09331 |
| GREEN | x | 0.2707 | 0.2719 | 0.2729 | 0.2738 | 0.2746 | 0.2753 |
| CHRO- | y | 0.6135 | 0.6159 | 0.6181 | 0.62 | 0.6218 | 0.6234 |
| MATICITY | u′ | 0.1103 | 0.1104 | 0.1106 | 0.1107 | 0.1108 | 0.1109 |
| | v′ | 0.5622 | 0.5629 | 0.5635 | 0.5641 | 0.5646 | 0.565 |
| | X | 0.410982 | 0.410749 | 0.409858 | 0.408472 | 0.406732 | 0.40475 |
| | Y | 0.931372 | 0.930528 | 0.928312 | 0.925067 | 0.921092 | 0.916651 |
| | Z | 0.175807 | 0.169568 | 0.163819 | 0.158504 | 0.153575 | 0.149009 |
| BLUE | x | 0.1448 | 0.1448 | 0.1447 | 0.1447 | 0.1446 | 0.1446 |
| CHRO- | y | 0.066 | 0.0673 | 0.0685 | 0.0697 | 0.071 | 0.0722 |
| MATICITY | u′ | 0.1654 | 0.1646 | 0.1638 | 0.1632 | 0.1623 | 0.1617 |
| | v′ | 0.1696 | 0.1722 | 0.1745 | 0.1769 | 0.1794 | 0.1817 |
| | X | 0.766382 | 0.773803 | 0.780047 | 0.785262 | 0.789547 | 0.793102 |
| | Y | 0.349186 | 0.359524 | 0.369307 | 0.378597 | 0.387443 | 0.395937 |
| | Z | 4.176307 | 4.2118 | 4.240926 | 4.264487 | 4.28302 | 4.297621 |

TABLE 4
THIRD EXPERIMENT EXAMPLE

| | | C. EX. 1 | C. EX. 2 | EX. | | | |
|---|---|---|---|---|---|---|---|
| LIGHT SOURCE | | LED | | | | | |
| AREA | R | 1 | 1 | 1.1 | 1.2 | 1.3 | 1.4 |
| RATIO | Y | 0 | 1 | 1 | 1 | 1 | 1 |
| | G | 1 | 1 | 1 | 1 | 1 | 1 |
| | B | 1 | 1 | 1.1 | 1.2 | 1.3 | 1.4 |
| LS BRIGHTNESS | | 100.00% | 82.40% | 85.33% | 87.99% | 90.15% | 92.38% |
| (LED) | | | | | | | |
| TL BRIGHTNESS | | 100.00% | 116.08% | 116.99% | 117.48% | 117.28% | 117.19% |
| LS CHRO- | x | 0.2629 | 0.22 | 0.2229 | 0.2257 | 0.2285 | 0.2308 |
| MATICITY | y | 0.2354 | 0.1576 | 0.1661 | 0.1742 | 0.1813 | 0.1885 |
| (LED) | u′ | 0.1985 | 0.1977 | 0.1961 | 0.1946 | 0.1937 | 0.1923 |
| | v′ | 0.3988 | 0.3187 | 0.3287 | 0.338 | 0.3458 | 0.3534 |
| | X | 199.6314 | 205.5049 | 204.8535 | 203.783 | 203.0999 | 202.1953 |
| | Y | 178.7485 | 147.2838 | 152.5266 | 157.2895 | 161.1497 | 165.1324 |
| | Z | 380.8549 | 581.4801 | 560.8614 | 541.9679 | 524.5816 | 505.7764 |
| WH CHRO- | x | 0.2723 | 0.2717 | 0.2717 | 0.2717 | 0.2723 | 0.2723 |
| MATICITY | y | 0.2767 | 0.2773 | 0.2773 | 0.2773 | 0.2767 | 0.2767 |
| | u′ | 0.1886 | 0.1879 | 0.1879 | 0.1879 | 0.1886 | 0.1886 |
| | v′ | 0.4312 | 0.4315 | 0.4315 | 0.4315 | 0.4312 | 0.4312 |
| | X | 8.0691 | 9.318878 | 9.392176 | 9.433103 | 9.463459 | 9.4564 |
| | Y | 5.1966 | 9.51437 | 9.589127 | 9.629031 | 9.612967 | 9.60585 |
| | Z | 13.36228 | 15.47133 | 15.59309 | 15.65586 | 15.67039 | 15.65947 |
| RED CHRO- | x | 0.6486 | 0.6399 | 0.6398 | 0.6396 | 0.6398 | 0.6396 |
| MATICITY | y | 0.3409 | 0.3384 | 0.3396 | 0.3407 | 0.3415 | 0.3424 |
| | u′ | 0.4478 | 0.4428 | 0.4416 | 0.4404 | 0.4398 | 0.4389 |
| | v′ | 0.5296 | 0.5268 | 0.5274 | 0.5278 | 0.5282 | 0.5286 |
| | X | 2.970562 | 1.620234 | 1.723038 | 1.815625 | 1.915207 | 1.987997 |
| | Y | 1.561281 | 0.856948 | 0.914711 | 0.96722 | 1.022063 | 1.064394 |
| | Z | 0.048506 | 0.054936 | 0.055472 | 0.055802 | 0.055967 | 0.056033 |
| YELLOW | x | — | 0.4101 | 0.4078 | 0.4056 | 0.4048 | 0.4028 |
| CHRO- | y | — | 0.5574 | 0.5806 | 0.5634 | 0.5648 | 0.5673 |
| MATICITY | u′ | — | 0.185 | 0.183 | 0.1813 | 0.1806 | 0.179 |
| | v′ | — | 0.5657 | 0.5662 | 0.5666 | 0.5668 | 0.5672 |
| | X | — | 3.198684 | 3.144242 | 3.084358 | 3.025557 | 2.958698 |
| | Y | — | 4.347383 | 4.322188 | 4.283638 | 4.221083 | 4.166469 |
| | Z | — | 0.252928 | 0.244042 | 0.235683 | 0.226957 | 0.219672 |
| GREEN | x | 0.2999 | 0.2905 | 0.2907 | 0.2909 | 0.2912 | 0.2912 |
| CHRO- | y | 0.6459 | 0.6354 | 0.6382 | 0.6406 | 0.6423 | 0.6442 |
| MATICITY | u′ | 0.1182 | 0.1157 | 0.1154 | 0.1151 | 0.115 | 0.1148 |
| | v′ | 0.5727 | 0.5694 | 0.57 | 0.5705 | 0.5709 | 0.5713 |
| | X | 2.635646 | 1.557748 | 1.550112 | 1.537614 | 1.515631 | 1.497331 |
| | Y | 5.677146 | 3.406603 | 3.402727 | 3.386527 | 3.342611 | 3.311893 |
| | Z | 0.476765 | 0.39716 | 3.78968 | 0.362323 | 0.346005 | 0.332101 |
| BLUE | x | 0.1528 | 0.153 | 0.153 | 0.1529 | 0.1529 | 0.1528 |
| CHRO- | y | 0.0586 | 0.0424 | 0.044 | 0.0457 | 0.0471 | 0.0487 |
| MATICITY | u′ | 0.1798 | 0.1911 | 0.1899 | 0.1886 | 0.1876 | 0.1864 |
| | v′ | 0.1552 | 0.1191 | 0.1229 | 0.1268 | 0.1301 | 0.1337 |
| | X | 2.482465 | 2.79633 | 2.829743 | 2.851497 | 2.863801 | 2.870471 |
| | Y | 0.952413 | 0.774258 | 0.814521 | 0.851376 | 0.882381 | 0.913856 |
| | Z | 12.81343 | 14.70428 | 14.85498 | 14.94445 | 14.9862 | 14.99725 |
| | | EX. | | | | | |
| LIGHT SOURCE | | LED | | | | | |
| AREA | R | 1.5 | 1.6 | 1.7 | 1.8 | 1.9 | 2 |
| RATIO | Y | 1 | 1 | 1 | 1 | 1 | 1 |
| | G | 1 | 1 | 1 | 1 | 1 | 1 |
| | B | 1.5 | 1.6 | 1.7 | 1.8 | 1.9 | 2 |
| LS BRIGHTNESS | | 94.43% | 96.81% | 98.08% | 99.86% | 101.18% | 102.54% |
| (LED) | | | | | | | |
| TL BRIGHTNESS | | 116.90% | 116.77% | 115.86% | 115.17% | 114.40% | 113.57% |
| LS CHRO- | x | 0.2329 | 0.2345 | 0.2367 | 0.2384 | 0.24 | 0.2415 |
| MATICITY | y | 0.1953 | 0.2023 | 0.208 | 0.2139 | 0.2196 | 0.225 |
| (LED) | u′ | 0.191 | 0.1892 | 0.1885 | 0.1873 | 0.18 [symbol] 2 | 0.1852 |
| | v′ | 0.3 [symbol] 03 | 0.3672 | 0.3727 | 0.3782 | 0.3834 | 0.3882 |
| | X | 201.2808 | 200.1045 | 199.4378 | 198.5153 | 197.5947 | 196.6793 |
| | Y | 168.7918 | 172.695 | 175.2729 | 178.1496 | 180.8147 | 183.2857 |
| | Z | 494.1 [symbol] 58 | 480.8645 | 467.9179 | 456.0793 | 444.9841 | 434.5485 |
| WH CHRO- | x | 0.2723 | 0.2717 | 0.2723 | 0.2723 | 0.2723 | 0.2723 |
| MATICITY | y | 0.2767 | 0.2773 | 0.2767 | 0.2767 | 0.2767 | 0.2767 |
| | u′ | 0.1886 | 0.1879 | 0.1886 | 0.1886 | 0.1886 | 0.1886 |
| | v′ | 0.4312 | 0.4315 | 0.4312 | 0.4312 | 0.4312 | 0.4312 |
| | X | 9.432731 | 9.374632 | 9.348607 | 9.293087 | 9.230978 | 9.163895 |
| | Y | 9.581821 | 9.57117 | 9.496336 | 9.439901 | 9.376886 | 9.30868 |
| | Z | 15.62042 | 15.56378 | 15.4812 | 15.38907 | 15.28635 | 15.17503 |
| RED CHRO- | x | 0.6392 | 0.6383 | 0.6365 | 0.6381 | 0.6377 | 0.6373 |
| MATICITY | y | 0.3433 | 0.3446 | 0.345 | 0.3458 | 0.3466 | 0.3473 |
| | u′ | 0.4377 | 0.4358 | 0.4356 | 0.4346 | 0.4335 | 0.4326 |
| | v′ | 0.5289 | 0.5294 | 0.5296 | 0.5299 | 0.5302 | 0.5304 |
| | X | 2.052568 | 2.087965 | 2.160545 | 2.205471 | 2.2451 | 2.280185 |
| | Y | 1.102461 | 1.127056 | 1.167514 | 1.195253 | 1.220175 | 1.24265 |
| | Z | 0.056 | 0.055899 | 0.055709 | 0.05548 | 0.05521 | 0.054907 |
| YELLOW | x | 0.4009 | 0.3978 | 0.3974 | 0.3958 | 0.3943 | 0.3926 |
| CHRO- | y | 0.5696 | 0.5729 | 0.5737 | 0.5756 | 0.5773 | 0.579 |
| MATICITY | u′ | 0.1775 | 0.1753 | 0.1749 | 0.1737 | 0.1726 | 0.1715 |
| | v′ | 0.5675 | 0.5579 | 0.568 | 0.5683 | 0.5685 | 0.5687 |
| | X | 2.891002 | 2.817787 | 2.756347 | 2.690454 | 2.625916 | 2.563008 |
| | Y | 4.106928 | 4.057885 | 3.978795 | 3.912262 | 3.845078 | 3.777736 |
| | Z | 0.212812 | 0.207216 | 0.200219 | 0.194423 | 0.18893 | 0.18371 |
| GREEN | x | 0.2912 | 0.2909 | 0.2911 | 0.291 | 0.291 | 0.2908 |
| CHRO- | y | 0.6458 | 0.6478 | 0.6487 | 0.6499 | 0.6511 | 0.6521 |
| MATICITY | u′ | 0.1146 | 0.1142 | 0.1141 | 0.1139 | 0.1138 | 0.1136 |
| | v′ | 0.5717 | 0.572 | 0.5723 | 0.5725 | 0.5727 | 0.5729 |
| | X | 1.477188 | 1.461582 | 1.433413 | 1.41052 | 1.387322 | 1.36399 |
| | Y | 3.276107 | 3.255133 | 3.194199 | 3.149859 | 3.104213 | 3.05764 |
| | Z | 0.319262 | 0.308421 | 0.296291 | 0.285965 | 0.276312 | 0.267258 |
| BLUE | x | 0.1528 | 0.1527 | 0.1527 | 0.1527 | 0.1526 | 0.1526 |
| CHRO- | y | 0.0502 | 0.0518 | 0.0531 | 0.0546 | 0.056 | 0.0573 |
| MATICITY | u′ | 0.1854 | 0.1842 | 0.1833 | 0.1823 | 0.1813 | 0.1805 |
| | v′ | 0.137 | 0.1406 | 0.1434 | 0.1467 | 0.1497 | 0.1525 |
| | X | 2.871498 | 2.86879 | 2.860774 | 2.8506 | 2.838079 | 2.823611 |
| | Y | 0.94303 | 0.973729 | 0.995324 | 1.018801 | 1.040719 | 1.061179 |
| | Z | 14.97919 | 14.94013 | 14.87783 | 14.60287 | 14.71628 | 14.62018 |

[symbol]

indicates data missing or illegible when filed

TABLE 5
FOURTH EXPERIMENT EXAMPLE

| | | C. EX. 1 | C. EX. 2 | EX. | | | |
|---|---|---|---|---|---|---|---|
| LIGHT SOURCE | | CCT | | | | | |
| AREA | R | 1 | 1 | 1.1 | 1.2 | 1.3 | 1.4 |
| RATIO | Y | 0 | 1 | 1 | 1 | 1 | 1 |
| | G | 1 | 1 | 1 | 1 | 1 | 1 |
| | B | 1 | 1 | 1.1 | 1.2 | 1.3 | 1.4 |
| LS BRIGHTNESS | | 100.00% | 82.73% | 86.02% | 89.17% | 92.14% | 94.97% |
| (CCT) | | | | | | | |
| TL BRIGHTNESS | | 100.00% | 112.15% | 113.78% | 115.08% | 116.05% | 116.79% |
| LS CHRO- | x | 0.2677 | 0.2185 | 0.2214 | 0.2241 | 0.2265 | 0.2288 |
| MATICITY | y | 0.2331 | 0.1607 | 0.1686 | 0.1762 | 0.1834 | 0.1902 |
| (CCT) | u′ | 0.2035 | 0.1948 | 0.1933 | 0.1921 | 0.1908 | 0.1807 |
| | v′ | 0.3987 | 0.322 | 0.3313 | 0.3398 | 0.3477 | 0.3548 |
| | X | 279.5619 | 273.8694 | 274.9947 | 278.071 | 277.0897 | 278.0617 |
| | Y | 243.4168 | 201.377 | 209.3902 | 217.0438 | 224.2832 | 231.1851 |
| | Z | 521.3074 | 778.034 | 757.4742 | 738.9038 | 721.8011 | 706.051 |
| WH CHRO- | x | 0.272 | 0.272 | 0.272 | 0.272 | 0.272 | 0.272 |
| MATICITY | y | 0.277 | 0.277 | 0.277 | 0.277 | 0.277 | 0.277 |
| | u′ | 0.1882 | 0.1882 | 0.1882 | 0.1882 | 0.1882 | 0.1882 |
| | v′ | 0.4313 | 0.4313 | 0.4313 | 0.4313 | 0.4313 | 0.4313 |
| | X | 11.43807 | 12.82242 | 13.01491 | 13.16296 | 13.27584 | 13.35974 |
| | Y | 11.64587 | 13.06029 | 13.25069 | 13.40221 | 13.51619 | 13.60173 |
| | Z | 18.96502 | 21.26659 | 21.57866 | 21.82419 | 22.00894 | 22.14658 |
| RED CHRO- | x | 0.645 | 0.6369 | 0.6367 | 0.6363 | 0.636 | 0.6358 |
| MATICITY | y | 0.3438 | 0.3404 | 0.3415 | 0.3426 | 0.3437 | 0.3448 |
| | u′ | 0.4421 | 0.4384 | 0.4372 | 0.4359 | 0.4347 | 0.4338 |
| | v′ | 0.5302 | 0.5272 | 0.5277 | 0.5281 | 0.5285 | 0.5289 |
| | X | 4.938192 | 2.589223 | 2.758038 | 2.91036 | 3.05029 | 3.178133 |
| | Y | 2.631713 | 1.383681 | 1.479563 | 1.567097 | 1.648204 | 1.72305 [symbol] |
| | Z | 0.085633 | 0.092441 | 0.094486 | 0.096215 | 0.097657 | 0.09887 |
| YELLOW | x | — | 0.408 | 0.4061 | 0.4042 | 0.4024 | 0.4007 |
| CHRO- | y | — | 0.5231 | 0.5277 | 0.532 | 0.5358 | 0.5393 |
| MATICITY | u′ | — | 0.1929 | 0.1907 | 0.1885 | 0.1866 | 0.1849 |
| | v′ | — | 0.5564 | 0.5574 | 0.5583 | 0.5591 | 0.5598 |
| | X | — | 4.436464 | 4.38421 | 4.324545 | 4.260625 | 4.193935 |
| | Y | — | 5.68846 | 5.696741 | 5.69115 | 5.672457 | 5.644551 |
| | Z | — | 0.750052 | 0.714404 | 0.682849 | 0.654346 | 0.628576 |
| GREEN | x | 0.2876 | 0.2602 | 0.2628 | 0.265 | 0.2668 | 0.2684 |
| CHRO- | y | 0.6017 | 0.5758 | 0.5811 | 0.5856 | 0.5895 | 0.5931 |
| MATICITY | u′ | 0.1193 | 0.1109 | 0.1113 | 0.1116 | 0.1118 | 0.1121 |
| | v′ | 0.5615 | 0.5519 | 0.5536 | 0.5549 | 0.5561 | 0.5572 |
| | X | 3.482443 | 1.992569 | 2.006816 | 2.014973 | 2.01723 | 2.015229 |
| | Y | 7.285703 | 4.409845 | 4.437008 | 4.453181 | 4.457359 | 4.453139 |
| | Z | 1.340717 | 1.25579 | 1.19209 | 1.135825 | 1.085176 | 1.039509 |
| BLUE | x | 0.1466 | 0.1462 | 0.1461 | 0.1461 | 0.1461 | 0.146 |
| CHRO- | y | 0.0671 | 0.0549 | 0.0563 | 0.0576 | 0.059 | 0.0603 |
| MATICITY | u′ | 0.167 | 0.1737 | 0.1727 | 0.1719 | 0.1711 | 0.1702 |
| | v′ | 0.172 | 0.1468 | 0.1498 | 0.1525 | 0.15 [symbol] 5 | 0.1581 |
| | X | 3.18567 | 3.522879 | 3.596828 | 3.657356 | 3.705856 | 3.744865 |
| | Y | 1.45858 | 1.32243 | 1.384372 | 1.442302 | 1.496057 | 1.546456 |
| | Z | 17.08122 | 19.25458 | 19.62958 | 19.93096 | 20.1666 | 20.35053 |
| | | EX. | | | | | |
| LIGHT SOURCE | | CCT | | | | | |
| AREA | R | 1.5 | 1.6 | 1.7 | 1.8 | 1.9 | 2 |
| RATIO | Y | 1 | 1 | 1 | 1 | 1 | 1 |
| | G | 1 | 1 | 1 | 1 | 1 | 1 |
| | B | 1.5 | 1.6 | 1.7 | 1.8 | 1.9 | 2 |
| LS BRIGHTNESS | | 97.67% | 100.25% | 102.73% | 105.0 [symbol] % | 107.37% | 109.56% |
| (CCT) | | | | | | | |
| TL BRIGHTNESS | | 117.31% | 117.67% | 117.88% | 117.97% | 117.97% | 117.88% |
| LS CHRO- | x | 0.2309 | 0.2329 | 0.2347 | 0.2364 | 0.238 | 0.2395 |
| MATICITY | y | 0.1968 | 0.203 | 0.209 | 0.2148 | 0.2203 | 0.2257 |
| (CCT) | u′ | 0.1885 | 0.1874 | 0.1863 | 0.1852 | 0.1842 | 0.1832 |
| | v′ | 0.3615 | 0.3676 | 0.3733 | 0.3787 | 0.3837 | 0.3884 |
| | X | 278.9875 | 279. [symbol] 731 | 280.7239 | 281.5354 | 282.3181 | 283.0725 |
| | Y | 237.7539 | 244.0347 | 250.0634 | 255.8128 | 261.3552 | 256.6949 |
| | Z | 691.526 | 677.9775 | 565.4116 | 653.5673 | 542.456 [symbol] | 631.9531 |
| WH CHRO- | x | 0.272 | 0.272 | 0.272 | 0.272 | 0.272 | 0.272 |
| MATICITY | y | 0.277 | 0.277 | 0.277 | 0.277 | 0.277 | 0.277 |
| | u′ | 0.1882 | 0.1882 | 0.1882 | 0.1882 | 0.1882 | 0.1882 |
| | v′ | 0.4313 | 0.4313 | 0.4313 | 0.4313 | 0.4313 | 0.4313 |
| | X | 13.4194 | 13.45978 | 13.48347 | 13.49406 | 13.49333 | 13.48339 |
| | Y | 13.66233 | 13.70334 | 13.72858 | 13.73857 | 13.73817 | 13.72869 |
| | Z | 22.24698 | 22.31365 | 22.35621 | 22.3736 | 22.37292 | 22.35524 |
| RED CHRO- | x | 0.6352 | 0.6348 | 0.6344 | 0.634 | 0. [symbol] | 0.6332 |
| MATICITY | y | 0.3455 | 0.3464 | 0.3472 | 0.3479 | 0.3487 | 0.3494 |
| | u′ | 0.4324 | 0.4313 | 0.4303 | 0.4293 | 0.4283 | 0.4274 |
| | v′ | 0.5292 | 0.5296 | 0.5298 | 0.5301 | 0.5304 | 0.5306 |
| | X | 3.2950 [symbol] 1 | 3.402686 | 3.500885 | 3.592289 | 3.676254 | 3.75401 |
| | Y | 1.7922 | 1.85645 | 1.91570 | 1.971384 | 2.023069 | 2.071418 |
| | Z | 0.099899 | 0.10076 | 0.101497 | 0.102106 | 0.102518 | 0.10304 |
| YELLOW | x | 0.399 | 0.3974 | 0.3958 | 0.3944 | 0.393 | 0.391 [symbol] |
| CHRO- | y | 0.5425 | 0.5454 | 0.5482 | 0.5507 | 0.5531 | 0.5553 |
| MATICITY | u′ | 0.1832 | 0.1817 | 0.1802 | 0.1789 | 0.1776 | 0.1764 |
| | v′ | 0.5604 | 0.561 | 0.5615 | 0.562 | 0.5624 | 0.5628 |
| | X | 4.125397 | 4.056508 | 3.987461 | 3.919171 | 3.851846 | 3.785878 |
| | Y | 5.608779 | 5.567436 | 5.522032 | 5.472574 | 5.421138 | 5.368123 |
| | Z | 0.605127 | 0.583643 | 0.563969 | 0.545704 | 0.528821 | 0.513114 |
| GREEN | x | 0.2698 | 0.271 | 0.272 | 0.2729 | 0.2737 | 0.2744 |
| CHRO- | y | 0.5962 | 0.599 | 0.6015 | 0.6038 | 0.6059 | 0.6078 |
| MATICITY | u′ | 0.1122 | 0.1124 | 0.1125 | 0.1125 | 0.1126 | 0.1126 |
| | v′ | 0.5581 | 0.5589 | 0.5596 | 0.5802 | 0.5608 | 0.5613 |
| | X | 2.009543 | 2.001104 | 1.990592 | 1.977979 | 1.964179 | 1.949361 |
| | Y | 4.441482 | 4.424148 | 4.402717 | 4.376629 | 4.348142 | 4.317457 |
| | Z | 0.998086 | 0.960242 | 0.925676 | 0.89369 | 0.864196 | 0.836825 |
| BLUE | x | 0.146 | 0.146 | 0.1459 | 0.1459 | 0.1459 | 0.1458 |
| CHRO- | y | 0.0618 | 0.0629 | 0.0642 | 0.0655 | 0.0687 | 0.068 |
| MATICITY | u′ | 0.1694 | 0.1686 | 0.1678 | 0.167 | 0.1683 | 0.1655 |
| | v′ | 0.1608 | 0.1635 | 0.1661 | 0.1687 | 0.1711 | 0.1736 |
| | X | 3.776286 | 3.800826 | 3.820304 | 3.834662 | 3.845176 | 3.35212 |
| | Y | 1.593876 | 1.638546 | 1.681039 | 1.721069 | 1.759276 | 1.795676 |
| | Z | 20.49328 | 20.59903 | 20.67751 | 20.72855 | 20.75911 | 20.77067 |

[symbol]

indicates data missing or illegible when filed

A comparison between the first and second comparative examples in each of the experiment examples shows that, when chromaticity of each of the light sources is adjusted in response to change of the liquid crystal panel from the three-color type to the four-color type, chromaticity of the transmitted light can be appropriately corrected at the time of white display without a decrease of brightness. A comparison between the second comparative example and the exemplary example in each of the experiment examples shows that, in terms of the brightness of the transmitted light, the exemplary example is relatively higher than the second comparative example and, in terms of the chromaticity of the light source, the exemplary example is relatively shifted toward the yellow side compared to the second comparative example. This indicates that chromaticity of the light source does not need to be shifted, for chromaticity adjustment, toward blue because the ratio of blue light in the transmitted light through the color filter 19 becomes greater than the ratio of yellow light or green light when the area ratio of the blue color section B or the red color section R to the yellow color section Y or the green color section G is increased. Therefore, supposedly, the decrease in brightness due to the chromaticity and brightness characteristics of the light source (FIGS. 13 and 14) or the spectral characteristics is restrained. Thus, by increasing the area ratio of the blue color section B or the red color section R to the yellow color section Y or the green color section G, relatively higher brightness can be obtained than when the color sections R, G, B, and Y have the same area ratio.

With regard to the chromaticity of transmitted light at the each time of red, blue, or green display, a comparison between the first comparative example and the second comparative example in each of the experiment examples shows that the Y value is relatively smaller in the second comparative example than in the first comparative example. Particularly, the chromaticity of transmitted light at the time of red display has a significantly large rate of decrease of the Y value compared to the one at the time of blue or green display. This is supposedly due to the fact that in the four-color liquid crystal panel 11, compared to the three-color type, the number of sub-pixels constituting each pixel is increased from three to four. Therefore, the area of the individual sub-pixels is decreased, resulting in the decrease in color lightness of red light in particular. With regard to the chromaticity of transmitted light at the time of red display, a comparison between the second comparative example and the exemplary example in each of the experiment examples shows that the exemplary example has relatively higher Y value, i.e., higher color lightness of red light, than the second comparative example, and that the Y value tends to increase as the area ratio of the red color section R is increased. This is supposedly due to the fact that the amount of transmitted light of red light can be increased by increasing the area ratio of the red color section R, and thereby the decrease in the color lightness of red light is restrained.

A comparison between the first experiment example (Table 2) and the second experiment example (Table 3) with the third experiment example (Table 4) and the fourth experiment example (Table 5) shows that, with regard to the brightness of transmitted light, the first and second experiment examples are relatively lower than the third and fourth experiment examples, and that, with regard to the chromaticity of the light source, the first and second experiment examples are relatively shifted toward blue compared to the third and fourth experiment examples. This is supposedly due to the fact that the edge light backlight unit 12 has a longer optical path length that the light emitted by the light sources 24 or 31 must travel to reach the liquid crystal panel 11 than the direct backlight unit 40, and that, in that process, optical absorption by the light guide member 26 occurs as the light travels in the light guide member 26, resulting in a relatively large decrease in brightness. In addition, the light guide member 26 included in the edge light backlight unit 12 generally has wavelength dependency in the absorption amount of the transmitted light such that the absorption amount of the light on the shorter wavelength side, i.e., blue light, tends to be larger than the absorption amount of light on the longer wavelength side, i.e., yellow or red light. Therefore, the light transmitted through the light guide member 26 tends to become yellowish. Thus, in the edge light backlight unit 12, compared to the direct backlight unit 40, the chromaticity of the light source needs to be adjusted toward blue in order to correct the chromaticity of the display image. Therefore, supposedly, the relatively large decrease in brightness occurs as a result of chromaticity adjustment. This tendency is particularly pronounced in the second experiment example with the cold cathode tubes 31 used as the light sources, supposedly due to compatibility regarding the chromaticity and brightness characteristics (FIGS. 13 and 14) or spectral characteristics, as mentioned above. Thus, it is seen that the decrease in brightness of transmitted light due to the adjustment of the chromaticity of the light source is relatively larger in the first and second experiment examples using the edge light backlight unit 12 than in the third and fourth experiment examples using the direct backlight unit 40.

A detailed comparison of the first experiment example (Table 2) and the second experiment example (Table 3) with the third experiment example (Table 4) and the fourth experiment example (Table 5) in terms of the brightness of transmitted light shows that, with regard to the difference between the minimum brightness value of the second comparative example and the maximum brightness value of the exemplary example, the first and second experiment examples are relatively greater than the third and fourth experiment examples. Specifically, the difference (2.69%) between the minimum brightness value (109.52%) and the maximum brightness value (112.21%) of the transmitted light in the first experiment example is larger than the difference (1.4%) between the minimum brightness value (116.08%) and the maximum brightness value (117.48%) of the transmitted light in the third experiment example. Similarly, the difference (8.21%) between the minimum brightness value (106.11%) and the maximum brightness value (114.32%) of the transmitted light in the second experiment example is larger than the difference (5.82%) between the minimum brightness value (112.15%) and the maximum brightness value (117.97%) of the transmitted light in the fourth experiment example. The brightness difference can be considered to indicate the degree of increase in brightness obtained by increasing the area ratio of the blue color section B and the red color section R to the yellow color section Y and the green color section G. Thus, it is seen that the configuration in which the area ratio of the blue color section B and the red color section R is increased relative to the yellow color section Y and the green color section G provides an almost singular effect, and is very useful in a configuration with the edge light backlight unit 12. It is also seen that, because the brightness difference in the second experiment example is larger than the one in the first experiment example, greater brightness increasing effect can be obtained in the edge light backlight unit 12 using the cold cathode tubes 31 as the light sources. This also applies to the comparison between the third and fourth experiment examples.

It is seen that, in the first experiment example in which the LEDs 24 are used in the edge light backlight unit 12 as the light sources, as shown in Table 2 and FIG. 15, high brightness (substantially 110% or more) can be obtained in the range of the area ratio of the blue color section B or the red color section R between 1.1 and 2.0; that higher brightness (substantially 111.8% or more) can be obtained in the range of 1.3 to 1.8; and that the brightness has a peak value (112.24%) at 1.5. When the area ratio of the blue color section B or the red color section R is smaller than 1.46, the brightness of transmitted light is relatively higher in the first experiment example than in the second experiment example in which the cold cathode tubes 31 are used as the light sources. This means that, when the area ratio is relatively small at 1.46 or less, greater brightness increasing effect can be obtained by using the LEDs 24 as the light sources than the cold cathode tubes 31. The liquid crystal panel 11 has the configuration in which the liquid crystal layer 11c is sandwiched between the pair of substrates 11a and 11b. Thus, the magnitude of the capacitance formed between the substrates 11a and 11b plays an important factor in controlling the state of alignment of the liquid crystal molecules contained in the liquid crystal layer 11c. The capacitance is a value that depends on the interval between the substrates 11a and 11b and the area of the pixel electrodes 15. Thus, when the area of the individual pixel electrodes 15 is changed in accordance with the area ratio of the color sections R, G, B, and Y, the capacitance value is different on a pixel by pixel basis. Therefore, it becomes increasingly more difficult to control the liquid crystal molecules, i.e., the transmittance of light, as the difference is increased. In this respect, when the LEDs 24 are used as the light source as above described, a high brightness increasing effect can be obtained when the area ratio of the red color section R or the blue color section B is relatively small in the range of 1.1 to 1.46. Therefore, the problem of capacitance does not easily arise, which is advantageous in designing the liquid crystal panel 11. In view of the problem of capacitance, it is preferable, from the viewpoint of designing the liquid crystal panel 11, that the area ratio of the pixel electrodes 15 (the ratio of the area of the red color section R and the blue color section B to the area of the yellow color section Y and the green color section G) be in a range of 1.1 to 1.62.

It is seen that, in the second experiment example in which the cold cathode tubes 31 are used as the light source in the edge light backlight unit 12, as shown in Table 3 and FIG. 15, high brightness (substantially 108% or more) can be obtained when the area ratio of the blue color section B or the red color section R is in a range of 1.1 to 2.0; that higher brightness (substantially 110.8% or more) can be obtained in the range of 1.3 to 2.0; and that the brightness has a peak value (114.32%) at 2.0. When the area ratio of the blue color section B or the red color section R is greater than 1.46, the brightness of transmitted light is relatively higher in the second experiment example than in the first experiment example using the LEDs 24 as the light source. This means that, when the area ratio is relatively high at 1.46 or more, a higher brightness increasing effect can be obtained by using the cold cathode tubes 31 than the LEDs 24 as the light source.

A comparison of the brightness of transmitted light between the first and second experiment examples shows that, as shown in Tables 2 and 3 and in FIG. 15, high brightness (substantially 110.8% or more) can be obtained in both examples when the area ratio of the blue color section B or the red color section R is in a range of 1.3 to 2.0, and that higher brightness (substantially 112% or more) can be obtained in both examples in the range of 1.5 to 1.6. Particularly, when the area ratio is 1.6, substantially the highest brightness can be obtained in the first experiment example using the LEDs 24 as the light source, and also in the second experiment example, in which the cold cathode tubes 31 are used as the light source, higher brightness than when the area ratio is smaller than 1.6 can be obtained. Thus, a high brightness increasing effect is obtained in both examples. Because the problem of capacitance may arise when the area ratio exceeds 1.62, it may be preferable that the area ratio be not more than 1.6 from the viewpoint of ensuring the ease of design of the liquid crystal panel 11. Accordingly, the area ratio of 1.6 may be the best mode from the viewpoint of design of the liquid crystal panel 11 as well as an appropriate use of both light sources 24 and 31. It is seen that, when the area ratio is in a range of 1.4 to 1.5, the brightness difference between the first and second experiment examples is small. Therefore, substantially the same brightness can be obtained regardless of whether the LEDs 24 or the cold cathode tubes 31 are used as the light source. Particularly, when the area ratio is 1.46, the first and second experiment examples have substantially the same brightness. This means that the same level of brightness increasing effect can be obtained regardless of whichever the LEDs 24 or the cold cathode tubes 31 are used as the light source.

In the third experiment example in which the LEDs 44 are used as the light source in the direct backlight unit 40, as shown in Table 4 and FIG. 20, high brightness (substantially 116% or more) can be obtained in the range of the area ratio of the red color section R or the blue color section B between 1 and 1.7; that higher brightness (substantially 117% or more) can be obtained in the range of 1.1 to 1.5; and that the brightness has a peak value (117.48%) at 1.2. A comparison between the third experiment example and the first experiment example (FIG. 15) shows that the value of the area ratio at which the peak value of brightness can be obtained is relatively smaller in the third experiment example. This is supposedly due to the fact that, because the direct backlight unit 40 does not include the light guide member 26, the chromaticity of the LEDs 44 differs from that of the LEDs 24 of the edge light backlight unit 12.

In the fourth experiment example in which the cold cathode tubes 52 are used as the light source in the direct backlight unit 40, as shown in Table 5 and FIG. 20, high brightness (substantially 116% or more) can be obtained in the range of the area ratio of the red color section R or the blue color section B between 1.3 and 2.0; that higher brightness (substantially 117% or more) can be obtained in the range of 1.45 to 2.0; and that the brightness has a peak value (117.97%) at 1.8 to 1.9. A comparison between the fourth experiment example and the second experiment example (FIG. 15) shows that the fourth experiment example has a relatively smaller value of the area ratio at which the peak value of brightness is obtained. This is supposedly due to the fact that, because the direct backlight unit 40 does not include the light guide member 26, the chromaticity of the cold cathode tubes 52 differs from that of the cold cathode tubes 31 of the edge light backlight unit 12.

With regard to the chromaticity of the transmitted light at the each time of red, green, blue, and yellow display in the first and second experiment examples, as shown in Tables 2 and 3 and in FIGS. 16 to 19, all of the blue chromaticity (blue primary color point), the green chromaticity (green primary color point), the yellow chromaticity (yellow primary color point), and the red chromaticity (red primary color point) are outside the common region 34 in the corresponding chromaticity diagrams. As mentioned above, the common region 34 is a very important region for maintaining a certain level of display quality (color reproducibility) of the display image, and therefore it is preferable to include the common region 34 in the chromaticity region of the transmitted light as much as possible. In this respect, in the first and second experiment examples, the chromaticity of all of the colors is set to be outside the common region 34. Therefore, most or all of the common region 34 is within the chromaticity region of the transmitted light, and sufficient color reproducibility can be ensured when viewing on the liquid crystal display device 10. The chromaticity region of transmitted light herein refers to the quadrangular region with the vertices corresponding to the chromaticity of red, blue, yellow, and green of the transmitted light (primary color points) in the first experiment example and the second experiment example. On the basis of Tables 4 and 5, it may be said that the chromaticity of the respective colors in the third and fourth experiment examples is also outside the common region 34. Thus, effects similar to those of the first and second experiment examples can be obtained.

As described above, the liquid crystal display device 10 according to the present embodiment includes the liquid crystal panel 11 in which the pair of substrates 11a and 11b sandwich the liquid crystal layer 11c between, the liquid crystal layer 11c including liquid crystals as a substance of which the optical characteristics vary upon electric field application; and the backlight unit 12 irradiating the liquid crystal panel 11 with light. The backlight unit 12 includes the light guide member 26, of which the ends include the light sources 24 or 31 in an opposed manner. The light from the light sources 24 or 31 is guided toward the liquid crystal panel 11 through the light guide member 26. One of the pair of substrates 11a and 11b of the liquid crystal panel 11 includes the color filter 19 including a plurality of color sections R, G, B, and Y exhibiting the colors of blue, green, red, or yellow, respectively. The blue color section B or the red color section R have relatively large areas compared to the yellow color section Y or the green color section G.

Thus, the color filter 19 is formed in one of the pair of substrates 11a and 11b of the liquid crystal panel 11, and the color filter 19 includes the yellow color section Y in addition to the blue, green, and red color sections R, G, and B as the three primary colors of light. Thus, the color reproduction range that the human eye can perceive, i.e., the color gamut, can be expanded, and also the color reproducibility for the colors of objects in the natural world can be increased. Therefore, improved display quality can be obtained. In addition, the light that transmit through the yellow color section Y of the color sections R, G, B, and Y constituting the color filter 19 has wavelengths close to the peak of luminosity factor. Thus, the light tends to be perceived by the human eye as being bright, i.e., as having high brightness, even when the amount of energy of the light is small. Thus, sufficient brightness can be obtained even when the output of the light sources 24 or 31 is restrained, leading to the reduction of the electric power consumption by the light sources 24 or 31 and superior environmental friendliness. In other words, the resulting high brightness can be utilized for providing a sharp sense of contrast, thereby enabling further improvement in display quality.

On the other hand, when the yellow color section Y is included in the color filter 19, the transmitted light from the liquid crystal panel 11, i.e., the display image, tends to have yellowishness as a whole. In order to avoid this, the chromaticity of the light sources 24 or 31 used in the backlight unit 12 may be adjusted toward blue as a complementary color to yellow, to correct the chromaticity of the display image. However, the research by the present inventor indicates that, when the chromaticity of the light sources 24 or 31 is adjusted in accordance with the liquid crystal panel 11 having the yellow color section Y, sufficient brightness may not be obtained depending on the type of the light sources 24 or 31, due to compatibility regarding the chromaticity and brightness characteristics of the light sources 24 or 31 or the spectral characteristics with respect to the liquid crystal panel 11. In addition, the further research by the present inventor indicates that the problem may be exacerbated when the backlight unit 12 configured to irradiate the liquid crystal panel 11 with light is the so-called edge light type with the light guide member 26, at which the ends the light sources 24 or 31 is disposed in an opposed manner, is used. Namely, in the edge light backlight unit 12, compared to the direct backlight unit 40, the optical path length that the light emitted by the light sources 24 or 31 must travel to reach the liquid crystal panel 11 is long. During this process, optical absorption by the light guide member 26 may occur as the light travels in the light guide member 26, resulting in a decrease in brightness. In addition, the light guide member 26 generally has yellowishness, although very little. For this reason, as the light from the light sources 24 or 31 is transmitted through the light guide member 26, the transmitted light becomes yellowish, and then the liquid crystal panel 11 with the yellow color section Y is irradiated with the yellowish light. Thus, in order to correct the chromaticity of the display image, the chromaticity of the light sources 24 or 31 needs to be further adjusted toward blue, possibly resulting in a further decrease in brightness due to chromaticity adjustment.

In view of the above problems, according to the present embodiment, with regard to the color sections R, G, B, and Y included in the color filter 19, the blue color section B or the red color section R have relatively large areas compared to the yellow color section Y or the green color section G. In this way, the light transmitted through the color filter 19 of the liquid crystal panel 11 tends to contain relatively more of blue light than yellow or green light. Thus, with the configuration of the color filter 19 to transmit relatively much of blue light, of which color is the complementary color to yellow, the tone of the display image with yellowishness can be restrained even when the light from the light sources 24 or 31 becomes more or less yellowish upon transmission through the light guide member 26. Accordingly, the chromaticity of the light sources 24 or 31 does not need to be adjusted toward blue for correcting the chromaticity of the display image. As a result, the decrease in brightness of transmitted light due to chromaticity adjustment of the light sources 24 or 31 can be restrained. In this way, the various light sources 24 or 31 with different chromaticity and brightness characteristics or spectral characteristics, can be suitably used in the backlight unit 12, leading to higher configurational freedom, for example, in designing the backlight unit 12.

Further, according to the above configuration, the transmitted light through the color filter 19 of the liquid crystal panel 11 tends to contain relatively more red light than yellow or green light. Therefore, the decrease in color lightness of red light, which may be caused by using the four-color type of the liquid crystal panel 11, can be restrained. Thus, according to the present embodiment, high brightness can be obtained and the chromaticity of the display image can be appropriately corrected, based on the configuration of the backlight unit 12.

The area ratio of the blue color section B or the red color section R to the yellow color section Y or the green color section G is in the range of 1.1 to 2.0. When the area ratio of the blue color section B or the red color section R is less than 1.1, the brightness in the case where the cold cathode tubes 31 are used as the light source may become too low. When the area ratio is larger than 2.0, the brightness in the case where the LEDs 24 are used as the light source may become too low. According to the present embodiment, the area ratio is in the range of 1.1 to 2.0 to obtain high brightness in the case of using either the LEDs 24 or the cold cathode tubes 31 as the light sources.

The area ratio may be in the range of 1.1 to 1.62. In the liquid crystal panel 11 according to the present embodiment, the optical characteristics of the liquid crystal layer 11c disposed between the pair of substrates 11a and 11b are changed by applying an electric field so as to control the transmittance of light with respect to each of the color sections R, G, B, and Y. For example, when the area ratio of the blue color section B or the red color section R is greater than 1.62, control of the transmittance may become difficult. In addition, when the area ratio is greater than 1.62, brightness may decrease when the LEDs 24 are used as the light source. According to the present embodiment, by limiting the area ratio within the range of 1.1 to 1.62, the transmittance of light with respect to each of the color sections R, G, B, and Y can be appropriately controlled, and therefore the LEDs 24 can be suitably used as the light sources.

The area ratio may be in the range of 1.3 to 1.62. In this way, higher brightness can be obtained when either the LEDs 24 or the cold cathode tubes 31 are used as the light sources.

The area ratio may be in the range of 1.5 to 1.6. In this way, extremely high brightness can be obtained when the LEDs 24 are used as the light sources. Further, sufficiently high brightness can be obtained when the cold cathode tubes 31 are used as the light sources.

The area ratio may be 1.6. In this way, extremely high brightness can be obtained when either the LEDs 24 or the cold cathode tubes 31 are used as the light sources. Further, the liquid crystal panel 11 can be advantageously designed.

The area ratio may be 1.5. In this way, the highest brightness can be obtained when the LEDs 24 are used as the light sources.

The area ratio may be in the range of 1.4 to 1.5. In this way, substantially the same brightness can be obtained when either the LEDs 24 or the cold cathode tubes 31 are used as the light sources.

The area ratio may be 1.46. In this way, the same level of brightness can be obtained when either the LEDs 24 or the cold cathode tubes 31 are used as the light sources.

The area ratio may be in the range of 1.1 to 1.46. In this way, relatively high brightness can be obtained when the LEDs 24 are used as the light sources compared to when the cold cathode tubes 31 are used as the light sources.

The area ratio may be in the range of 1.46 to 2.0. In this way, relatively high brightness can be obtained when the cold cathode tubes 31 are used as the light sources compared to when the LEDs 24 are used as the light sources.

The area ratio may be 2.0. In this way, the highest brightness can be obtained when the cold cathode tubes 31 are used as the light sources.

The area of the blue color section B may be the same as the area of the red color section R. In this way, the capacitance formed between the substrates 11a and 11b can be made substantially the same in the blue color section B and the red color section R. As a result, the optical characteristics of the liquid crystal layer 11c provided between the substrates 11a and 11b can be more easily controlled by the application of an electric field. Thus, the transmittance of light with respect to the blue color section B or the red color section R can be more easily controlled. Therefore, the circuit design of the liquid crystal panel 11 can be made extremely simple while high color reproducibility is obtained.

The yellow color section Y and the green color section G may have the same area. In this way, in the yellow color section Y and the green color section G, the capacitance formed between the substrates 11a and 11b can be made substantially the same. Thus, the optical characteristics of the liquid crystal layer 11c provided between the substrates 11a and 11b can be more easily controlled by application of an electric field. Accordingly, the transmittance of light with respect to the yellow color section Y or the green color section G can be more easily controlled. As a result, the circuit design of the liquid crystal panel 11 can be made extremely simple while high color reproducibility is obtained.

The color sections R, G, B, and Y may have substantially the same film thickness. In this way, the capacitance formed between the substrates 11a and 11b becomes substantially the same among the color sections R, G, B, and Y. Therefore, the optical characteristics of the liquid crystal layer 11c provided between the substrates 11a and 11b can be more easily controlled by application of an electric field. Accordingly, the transmittance of light with respect to each of the color sections R, G, B, and Y can be more easily controlled, leading to an extreme simple circuit design of the liquid crystal panel 11 with high color reproducibility.

The light source may be the cold cathode tubes 31. In this way, when adjusting the chromaticity of the cold cathode tubes 31 in accordance with the liquid crystal panel 11 having the yellow color section Y, the chromaticity of the cold cathode tubes 31 can be shifted more toward yellow, which is the complementary color to blue, as the area ratio of the blue color section B or the red color section R to the yellow color section Y or the green color section G is increased. In this way, the decrease in brightness as a result of chromaticity adjustment of the cold cathode tubes 31 can be restrained. Further, cost reduction can be achieved compared to the case where the LEDs 24 are used as the light source.

The light source may be the LEDs 24. In this way, when adjusting the chromaticity of the LEDs 24 in accordance with the liquid crystal panel 11 having the yellow color section Y, the chromaticity of the LEDs 24 be can be shifted more toward yellow, which is the complementary color of blue, as the area ratio of the blue color section B or the red color section R to the yellow color section Y or the green color section G is increased. In this way, the decrease in brightness as a result of the chromaticity adjustment of the LEDs 24 can be restrained. Further, electric power consumption can be reduced compared to the case where the cold cathode tubes 31 are used as the light source, for example.

The LEDs 24 include the LED elements 24a as the light emitting sources and a phosphor that emits light upon excitation by the light from the LED elements 24a. Thus, by appropriately adjusting the type, amount, or the like of the phosphor included in the LEDs 24, the chromaticity of the LEDs 24 can be finely adjusted and thereby made more adapted to the liquid crystal panel 11 having the yellow color section Y.

The LED elements 24a include the blue LED elements 24a that emit blue light, whereas the phosphor include a green phosphor that emits green light upon excitation by the blue light and a red phosphor that emits red light upon excitation by the blue light. In this way, the LEDs 24 as a whole can emit a predetermined color based on the blue light emitted by the blue LED elements 24a, the green light emitted by the green phosphor upon excitation by the blue light from the blue LED elements 24a, and the red light emitted by the red phosphor upon excitation by the blue light from the blue LED elements 24a. In this configuration of the LEDs 24, the blue light can be emitted with extremely high efficiency because of the use of the blue LED elements 24a as the light emitting source. Thus, the chromaticity of the LEDs 24 can be adjusted toward blue in accordance with the liquid crystal panel 11 having the yellow color section Y without much decrease in brightness, and accordingly, high brightness can be maintained.

The green phosphor may be a SiAlON-based phosphor. By thus using a SiAlON-based phosphor, which is a nitride, as the green phosphor, light emission with high efficiency can be obtained compared to the case where, for example, a sulfide or oxide phosphor is used. In addition, the light emitted by a SiAlON-based phosphor has high color purity compared to a YAG-based phosphor, for example. Therefore, chromaticity adjustment of the LEDs 24 can be more easily performed.

The green phosphor may be a β-SiAlON. In this way, green light can be emitted with high efficiency. In addition, the light emitted by a β-SiAlON has particularly high color purity. Therefore, the chromaticity adjustment of the LEDs 24 can be even more easily performed.

The red phosphor may be a CASN-based phosphor. By using a CASN-based phosphor, which is a nitride, as the red phosphor, red light can be emitted with high efficiency compared to the case where a sulfide or oxide phosphor, for example, is used.

The red phosphor may be a CASN (CaAlSiN3:Eu). In this way, red light can be emitted with high efficiency.

The green phosphor may be a YAG-based phosphor. By using a YAG-based phosphor as the green phosphor, extremely high brightness of the LEDs 24 can be obtained compared to the case where other types of phosphor are used.

The light guide member 26 includes the elongated light entrance surfaces 26b on the ends facing the LEDs 24. The LEDs 24 include the lens members 30 that cover the light output side of the LEDs 24 and diffuse light. The lens members 30 are opposed to the light entrance surfaces 26b of the light guide member 26 and curved along the longitudinal direction of the light entrance surfaces 26b to be convex toward the light guide member 26. In this way, the light emitted by the LEDs 24 is caused to spread in the longitudinal direction of the light entrance surfaces 26b by the lens members 30. Therefore, the dark portions that could be formed at the light entrance surfaces 26b of the light guide member 26 can be reduced. Thus, even when the distance between the LEDs 24 and the light guide member 26 is short and the number of the LEDs 24 is small, light with uniform brightness can be incident on over the entire light entrance surfaces 26b of the light guide member 26.

The color filter 19 is configured such that the chromaticity of the blue, green, red, or yellow transmitted light obtained by transmitting the light from the light sources 24 or 31 through the respective color sections R, G, B, or Y in the color filter 19 is outside the common region 34 of the NTSC chromaticity region 32 according to the NTSC standard and the EBU chromaticity region 33 according to the EBU standard in both the CIE1931 chromaticity diagram and the CIE1976 chromaticity diagram. In this way, the common region 34 can be substantially contained in the chromaticity region of the transmitted light. Therefore, sufficient color reproducibility can be ensured.

the light guide member 26 includes the elongated light entrance surfaces 26b on the ends facing the light sources 24 or 31. The backlight unit 12 includes, between the light sources 24 or 31 and the light guide member 26, the reflection sheets 28 and 29 along the longitudinal direction of the light entrance surfaces 26b. In this way, the light emitted by the light sources 24 or 31 can be reflected by the reflection sheets 28 and 29 to be incident on the light entrance surfaces 26b of the light guide member 26 efficiently. Thus, the incident efficiency of the light emitted by the light sources 24 or 31 on the light guide member 26 can be increased.

The light guide member 26 may include a substance with a higher refractive index than that of air. In this way, the light entering the light guide member 26 from the light sources 24 or 31 can be caused to travel efficiently toward the liquid crystal panel 11.

The display panel may be the liquid crystal panel 11 including the liquid crystal layer 11c as the substance of which the optical characteristics vary by application of an electric field. In this way, the display panel can be applied for various purposes, such as for television or personal computer displays, particularly for large screens.

The television receiver TV according to the present embodiment includes the liquid crystal display device 10 and the tuner T as a reception unit configured to receive a television signal. According to such a television receiver TV, the liquid crystal display device 10, which displays a television image based on the television signal, can appropriately correct the chromaticity of the display image while high brightness is obtained. Therefore, the television image can be displayed with high display quality.

The television receiver TV further includes the image conversion circuit VC that converts the television image signal output from the tuner T into an image signal of the respective colors of red, green, blue, or yellow. In this way, the television image signal is converted by the image conversion circuit VC into the image signal corresponding to the respective color sections R, G, B, or Y of the red, green, blue, or yellow included in the color filter 19. Therefore, the television image can be displayed with high display quality.

While the first embodiment of the present invention has been described above, the present invention is not limited to the embodiment and may include the following modifications. In the following modifications, components similar to those of the embodiment will be designated by similar reference signs and their description and illustration may be omitted.

<First Modification of the First Embodiment>

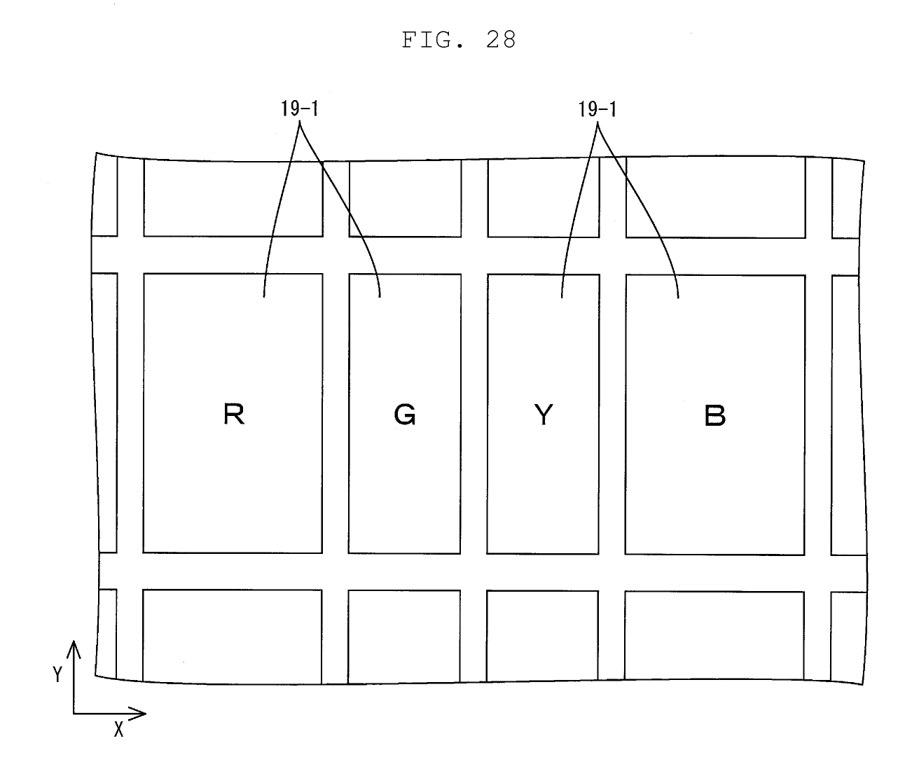

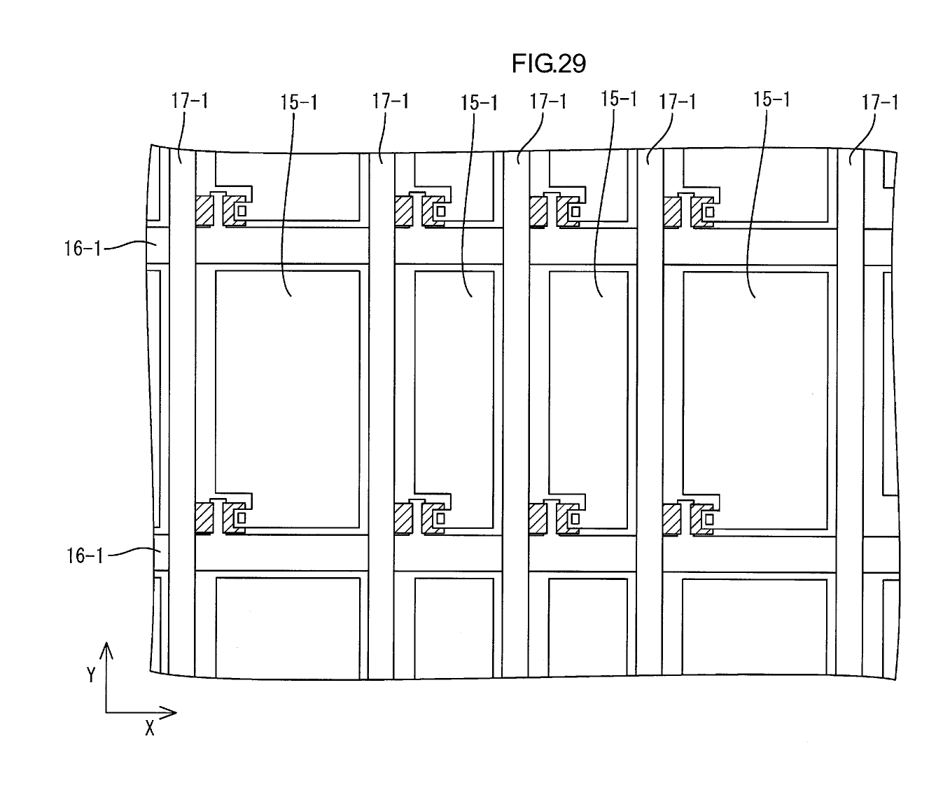

A first modification of the first embodiment will be described with reference to FIG. 28 or 29, showing modified shape of color sections R, G, B, and Y included in a color filter 19-1, and correspondingly modified shapes of pixel electrodes.

The color sections R, G, B, and Y included in the color filter 19-1 are, as shown in FIG. 28, arranged in rows and columns, the X-axis direction corresponding to the row direction and the Y-axis direction to the column direction. The color sections R, G, B, and Y have the same dimension in the column direction (Y-axis direction) and different dimension in the row direction (X-axis direction).

Specifically, the color sections R, G, B, and Y are arranged such that the yellow color section Y and the green color section G are sandwiched between the red color section R and the blue color section B with respect to the row direction, with the red color section R or the blue color section B relatively larger than the yellow color section Y or the green color section G in the row direction dimension. Thus, two first columns including the color sections R and B with the relatively large row direction dimension and two second columns including the color sections Y and G with the relatively small row direction dimension are alternately and repeatedly disposed with respect to the row direction. Thus, the area of the red color section R or the blue color section B is larger than the area of the yellow color section Y or the green color section G. In the row direction, the color sections R, G, B, and Y are arranged in order of, from the left side of FIG. 28, the red color section R, the green color section G, the yellow color section Y, and the blue color section B. In accordance with the arrangement of the color filter 19-1, pixel electrodes 15-1 have different row direction dimension in an array substrate 11b depending on the columns, as shown in FIG. 29. Specifically, of the pixel electrodes 15-1, the area of those overlapping with the red color section R or the blue color section B is larger than the area of those overlapping with the yellow color section Y or the green color section G. All of source wires 17-1 are arranged at regular pitches, while gate wires 16-1 are arranged at two different pitches depending on the dimension of the pixel electrodes 15-1. FIGS. 28 and 29 show the case where the area of the red color section R or the blue color section B is about 1.6 times that of the yellow color section Y or the green color section G.

<Second Modification of the First Embodiment>

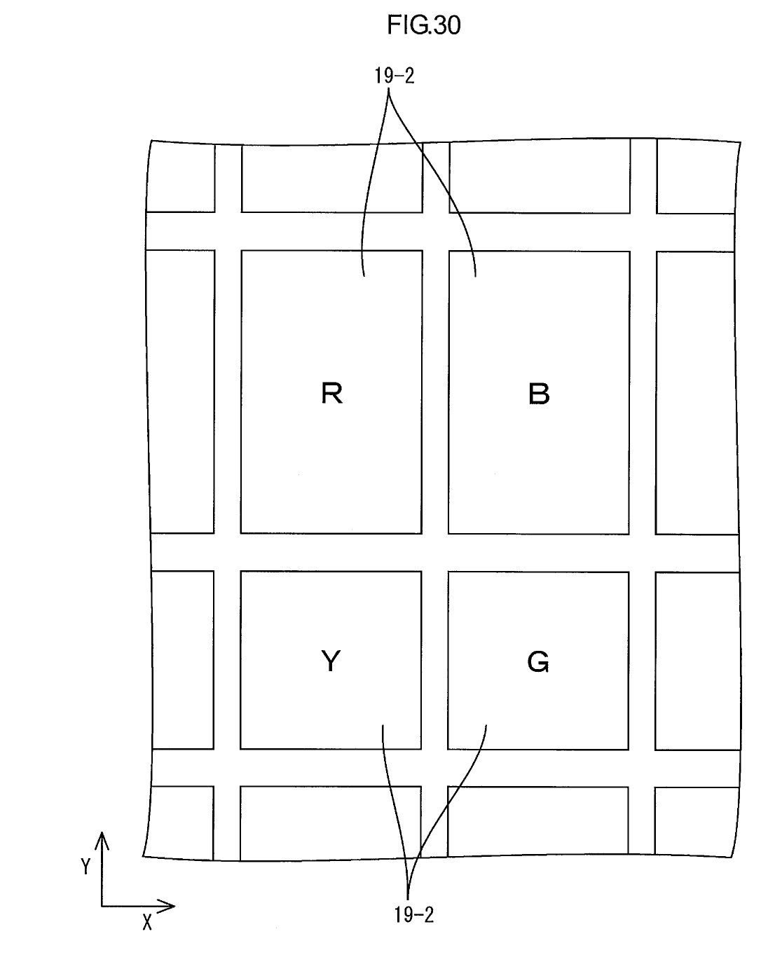

A second modification of the first embodiment will be described with reference to FIG. 30, showing a color filter 19-2 with color sections arranged in the modified order from that of the first embodiment.

The color filter 19-2 according to the present modification, as shown in FIG. 30, is configured such that the yellow color section Y is disposed adjacent to the red color section R in the column direction, and the green color section G is disposed adjacent to the blue color section B in the column direction.

<Third Modification of the First Embodiment>

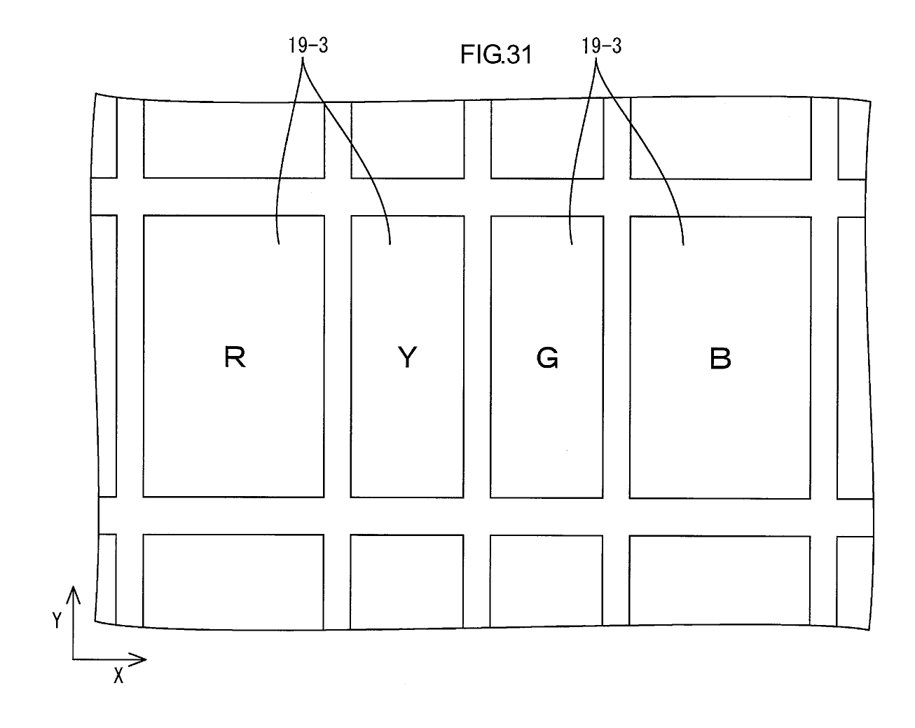

A third modification of the first embodiment will be described with reference to FIG. 31, showing a color filter 19-3 with color sections arranged in an order modified from that of the first modification.

In the color filter 19-3 according to the present modification, as shown in FIG. 31, the color sections are arranged in the row direction in order of, from the left side of FIG. 31, the red color section R, the yellow color section Y, the green color section G, and the blue color section B.

### Second Embodiment

A second embodiment of the present invention will be described. According to the second embodiment, a yellow phosphor is used in the LEDs, instead of a green phosphor. Redundant description of structures, operations, and effects similar to those of the first embodiment will be omitted.

According to the present embodiment, the LEDs include blue LED chips and a red phosphor similar to those of the first embodiment, and further a yellow phosphor that emits yellow light upon excitation by blue light from the blue LED chip. According to the present embodiment, the yellow phosphor has a dominant emission peak in a yellow wavelength region of 570 nm to 600 nm. Preferably, α-SiAlON, which is a SiAlON-based nitride, may be used as the yellow phosphor. Therefore, yellow light can be emitted with high efficiency compared to the case where a sulfide or oxide phosphor, for example, is used. Specifically, α-SiAlON uses Eu (europium) as an activator and is expressed by the general formula, Mx (Si, Al)12(O, N)16:Eu (M is a metal ion, and x is the amount of solid solution). For example, when calcium is used as the metal ion, α-SiAlON is expressed by Ca(Si, Al)12(O, N)16:Eu. Preferably, as the yellow phosphor other than α-SiAlON, a BOSE-based BOSE may be used. BOSE uses Eu (europium) as an activator and is expressed by (Ba.Sr)2SiO4:Eu). The yellow phosphor may be other material than α-SiAlON and BOSE. Particularly, (Y, Gd)3Al3O12:Ce, which is a YAG-based phosphor, may be preferably used to obtain high efficiency emission. (Y, Gd)3Al3O12:Ce has a substantially flat dominant emission peak extending from the green wavelength region to the yellow wavelength region; thus, it may be regarded as either a green phosphor or a yellow phosphor. In addition, Tb3Al5O12:Ce may be used as the yellow phosphor. Thus, when the yellow phosphor is used instead of the green phosphor, similar effects to those of the first embodiment can be obtained.

As described above, according to the present embodiment, the yellow phosphor may comprise α-SiAlON. In this way, yellow light can be emitted with high efficiency.

The yellow phosphor may be a BOSE-based phosphor. Thus, as the yellow phosphor, a BOSE-based phosphor containing barium and strontium may be used.

The yellow phosphor may be a YAG-based phosphor. Thus, as the yellow phosphor, a YAG-based phosphor containing yttrium and aluminum may be used to obtain higher efficiency emission.

### Third Embodiment

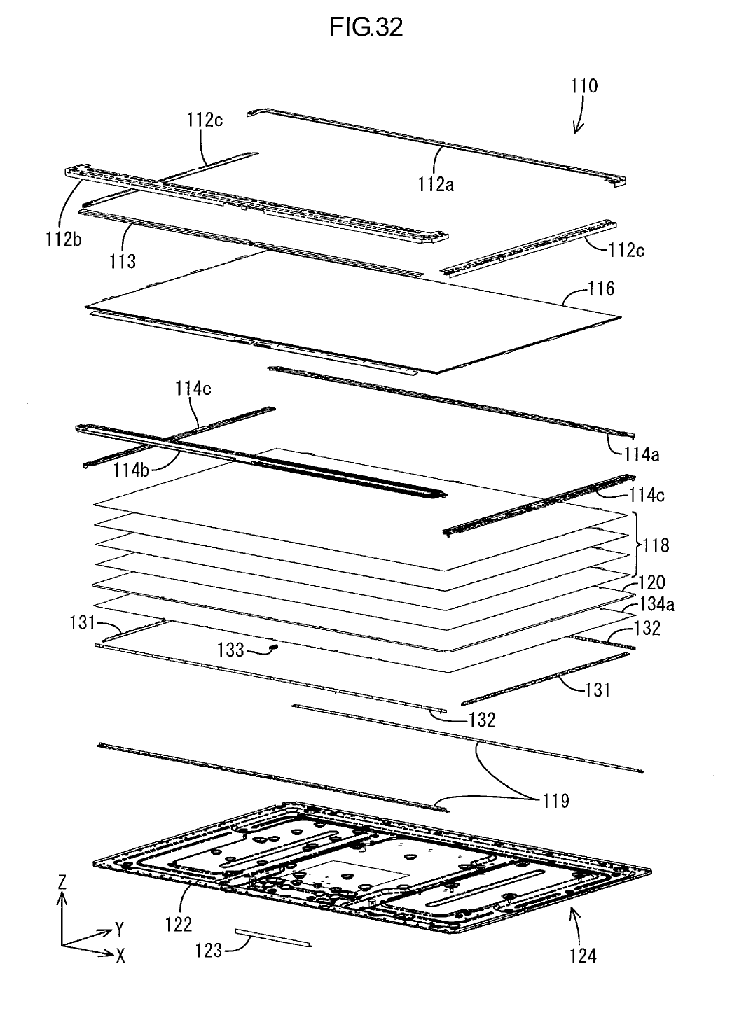

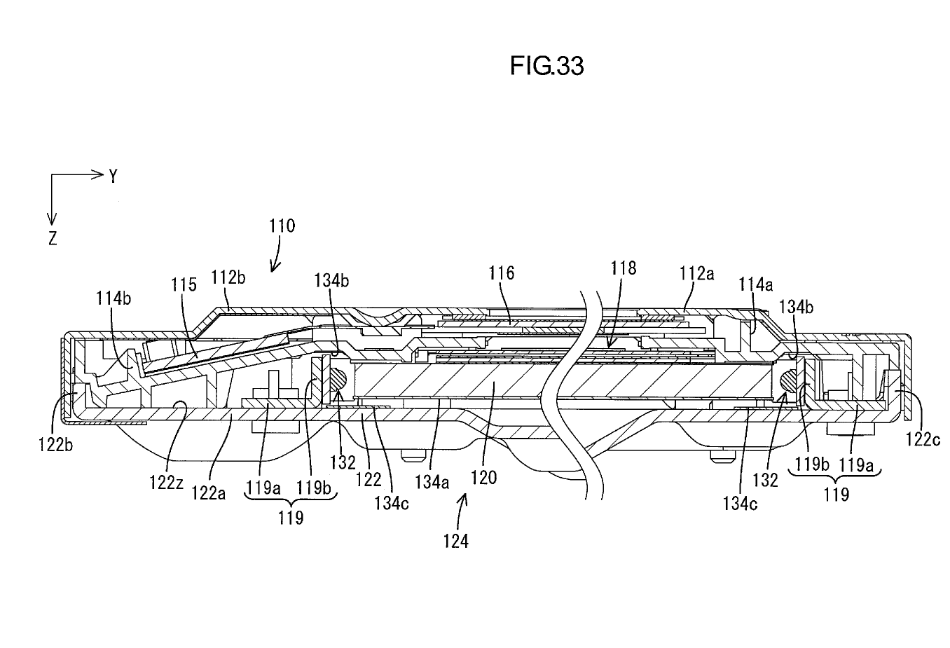

A third embodiment of the present invention will be described with reference to FIG. 32 or 33. According to the third embodiment, a liquid crystal display device 110 has constituent components modified from those according to the first embodiment. Redundant description of structures, operations, and effects similar to those of the first embodiment will be omitted.

FIG. 32 is an exploded perspective view of the liquid crystal display device 110 according to the present embodiment. In FIG. 32, the upper side corresponds to the front side and the lower side corresponds to the rear side. As shown in FIG. 32, the liquid crystal display device 110 as a whole has a horizontally long square shape, and include a liquid crystal panel 116 as a display panel and a backlight unit 124 as an external light source, which are configured to be integrally retained by a top bezel 112a, a bottom bezel 112b, side bezels 112c (hereafter referred to as a group of bezels 112a to 112c), and the like. The liquid crystal panel 116 may have a configuration similar to that according to the first embodiment; thus, redundant description of the configuration will be omitted.

In the following, the backlight unit 124 will be described. As shown in FIG. 32, the backlight unit 124 includes a backlight chassis (sandwiching member; support member) 122; optical members 118; a top frame (sandwiching member) 114a; a bottom frame (sandwiching member) 114b; side frames (sandwiching members) 114c (hereafter referred to as the frames 114a to 114c); and a reflection sheet 134a. The liquid crystal panel 116 is sandwiched by the group of bezels 112a to 112c and the frames 114a to 114c. Reference sign 113 indicates an insulating sheet insulating a display control circuit board 115 (see FIG. 33) that drives the liquid crystal panel 116. The backlight chassis 122 is open on the front side (the light output side; the side of the liquid crystal panel 116), and has a substantially box-like shape with a bottom surface. The optical members 118 are disposed on the front side of the light guide plate 120. The reflection sheet 134a is disposed on the rear side of the light guide plate 120. Further, the backlight chassis 122 houses a pair of cable holders 131; a pair of heat dissipating plates (attached heat dissipating plates) 119; a pair of LED units 132; and a light guide plate 120. The LED units 132, the light guide plate 120, and the reflection sheet 134a are supported with respect to each other by a rubber bush 133. On the back surface of the backlight chassis 122, a power supply circuit board (not shown) supplying electric power to the LED units 132, a protection cover 123 protecting the power supply circuit board, and the like are attached. The pair of cable holders 131 is disposed along the short side direction of the backlight chassis 122 and houses wires electrically connecting the LED units 132 and the power supply circuit board.

FIG. 33 is a horizontal cross sectional view of the backlight unit 124. As shown in FIG. 33, the backlight chassis 122 is constituted by a bottom plate 122a with a bottom surface 122z, and side plates 122b and 122c shallowly rising from the outer edges of the bottom plate 122a. The backlight chassis 122 supports at least the LED units 132 and the light guide plate 120. The heat dissipating plate 119 is configured from a bottom surface portion (second plate portion) 119a and a side surface portion (first plate portion) 119b rising from the outer edges of the bottom surface portion 119a on one long side thereof, forming an L-shape in horizontal cross section. Each of the heat dissipating plates 119 is disposed along the long sides of the backlight chassis 122. The bottom surface portions 119a of the heat dissipating plates 119 are fixed to the bottom plate 122a of the backlight chassis 122. Each of the pair of LED units 132 extends along the long sides of the backlight chassis 122, and is fixed to the corresponding side surface portions 119b of the heat dissipating plates 119 with the light output sides of the LED units 132 opposed to each other. Thus, the pair of LED units 132 is supported by the bottom plate 122a of the backlight chassis 122 via the heat dissipating plates 119. The heat dissipating plates 119 dissipate the heat generated in the LED units 132 outside the backlight unit 124 via the bottom plate 122a of the backlight chassis 122.

As shown in FIG. 33, the light guide plate 120 is disposed between the pair of LED units 132. The pair of LED units 132, the light guide plate 120, and the optical members 118 are sandwiched by the frames (first sandwiching members) 114a to 114c and the backlight chassis (second sandwiching member) 122. Further, the light guide plate 120 and the optical members 118 are fixed by the frames 114a to 114c and the backlight chassis 122. The LED units 132, the light guide plate 120, and the optical members 118 may have configurations similar to those according to the first embodiment; thus, redundant description of the configurations will be omitted.

As shown in FIG. 33, the drive circuit board 115 is disposed on the front side of the bottom frame 114b. The drive circuit board 115 is electrically connected to the display panel 116 and supplies image data and various control signals necessary for image display to the liquid crystal panel 116. A first reflection sheet 134b is disposed on the surface of the top frame 114a at a location that is exposed to the LED units 132, along the long side direction of the light guide plate 120. Another first reflection sheet 134b is disposed on the surface of the bottom frame 114b at a location that is opposed to the LED unit 132, along the long side direction of the light guide plate 120.

### Other Embodiments

The present invention is not limited to the embodiments above described and illustrated with reference to the drawings, and the following embodiments may be included in the technical scope of the present invention.

(1) While in the first comparative experiment according to the first embodiment, when the area of the red or blue color section is one to two times the area of the yellow or green color section, the area ratio may be more than two.

(2) While in the foregoing embodiments the LEDs and the cold cathode tubes are used as the light source, other types of light source, such as organic EL or hot cathode tubes may be used. Namely, light sources other than the LEDs and the cold cathode tubes may be used because the spectral characteristics when the chromaticity of the light source is adjusted for correcting the chromaticity of the display image tend to be favorable regardless of the type of light source, as long as the area of the red or blue color section in the color filter is greater than the area of the yellow or green color section.

(3) While the phosphors that may be used in the LEDs have been listed in detail in the first and the second embodiments, the same phosphors may be used in a cold cathode tube.

(4) While the blue color section and the red color section have the same area ratio according to the first embodiment, the blue color section and the red color section may have different area ratios. In this case, the blue color section may have a larger area than the red color section or, conversely, the blue color section may have a smaller area than the red color section. In either case, it is only necessary that the blue or red color section has larger areas than the yellow or green color section.

(5) While the yellow color section and the green color section have the same area ratio according to the first embodiment, the yellow color section and the green color section may have different area ratios. In this case, the yellow color section may have a larger area than the green color section or, conversely, the yellow color sections may have a smaller area than the green color section. In either case, it is only necessary that the blue or red color section have larger areas than the yellow or green color section.

(6) While each one type of the green and the red phosphors is used as the phosphors contained in the LEDs according to the first embodiment, a plurality of types of the same color may be used for one or both of the green and the red phosphors, and such configuration is also included in the present invention. This technique may be applied to the case where the yellow and the red phosphors are used as the phosphors, as according to the second embodiment.

(7) For the phosphors contained in the LEDs, the green and the red phosphors are used in the first embodiment while the yellow and the red phosphors are used in the second embodiment. However, the present invention also includes a configuration in which, as the phosphors contained in the LEDs, the green, the yellow, and the red phosphors are used in combination. Preferably, β-SiAlON as the green phosphor, BOSE-based phosphor, α-SiAlON or YAG-based phosphor as the yellow phosphor, and a CASN-based phosphor as the red phosphor may be used in combination. Also in this case, the technique of (6) may be adopted; i.e., a plurality of types of the phosphors of the same color may be used.

(8) Other than the configurations according to the first and the second embodiments and (7), as the phosphors contained in the LEDs, for example, a configuration may be adopted in which the green and the yellow phosphors are used but the red phosphor is not used. Further, as the phosphor contained in the LEDs, only the yellow phosphor may be used and the green phosphor and the red phosphor may not be used.

(9) In the foregoing embodiments, the LEDs are of the type including a blue LED chip that emits the single color of blue and configured to emit substantially white light (including white light and substantially white and yet bluish light) by using a phosphor. The present invention also includes a configuration in which the LEDs are of the type including an LED chip that emits the single color of ultraviolet light (blue-violet light) and configured to emit substantially white light by using a phosphor. Also in this case, the chromaticity of the LEDs can be adjusted by appropriately adjusting the contained amount of the phosphor in the LEDs.

(10) In the foregoing embodiments, the LEDs are of the type including an LED chip that emits the single blue color and configured to emit substantially white light (including white light and substantially white and yet bluish light) by using a phosphor. However, the present invention also includes a configuration in which the LEDs are of the type including three types of LED chips that emit the single color of red, green, or blue, respectively. In addition, the present invention also includes a configuration in which the LEDs are of the type including three types of LED chips that emit the single colors of C (cyan), M (magenta), or Y (yellow), respectively. In this case, the chromaticity of the LEDs can be adjusted by appropriately controlling the amount of electric current to the LED chips when turned on.

(11) In the first embodiment, a pair of LED boards (LEDs) is disposed at the ends of the chassis (light guide member) on the long sides thereof. However, the present invention also includes a configuration in which a pair of LED boards (LEDs) is disposed at the ends of the chassis (light guide member) on the short sides thereof.

(12) Other than (11), the present invention also includes a configuration in which each one pair of LED boards (LEDs) is disposed at the ends of the chassis (light guide member) on the long sides and on the short sides thereof. Conversely, one LED board (LED) may be disposed at the end of the chassis (light guide member) on only one of the long sides or one of the short sides thereof.

(13) According to the first embodiment, the cold cathode tubes are disposed at regular intervals in the chassis by way of example. However, the present invention also includes a configuration in which the cold cathode tubes are disposed at irregular intervals. The specification of the number, the arranged interval, and the like for the cold cathode tubes to be installed may be appropriately modified.

(14) While according to the first embodiment, CASN (CaAlSiN3:Eu) is used as the red phosphor by way of example, other CASN-based phosphors may be used. Further, as the red phosphor, materials other than CASN-based phosphors may be used.

(15) While according to the first embodiment, the LED chips have the dominant emission wavelength of 451 nm, the present invention also includes configurations in which the dominant emission wavelength is shifted from the 451 nm toward the longer wavelength side or toward the shorter wavelength side. Also in these cases, the dominant emission wavelength of the LED chips may preferably be set in the range of 420 nm to 500 nm.

(16) According to the first embodiment, the color filter is configured such that the chromaticity of the respective color sections providing the blue, red, green, or yellow transmitted light is outside the common region of the NTSC chromaticity region according to the NTSC standard and the EBU chromaticity region according to the EBU standard in both the CIE1931 chromaticity diagram and the CIE1976 chromaticity diagram. However, the chromaticity of the respective color sections may be outside the common region in either one of the CIE1931 chromaticity diagram and the CIE1976 chromaticity diagram.

(17) In the foregoing embodiments, the light guide member is made of a synthetic resin. The material (substance) used in the light guide member may be other than synthetic resin material.

(18) In the foregoing embodiments, the liquid crystal panel and the chassis are vertically disposed with their short side directions aligned with the vertical direction, by way of example. The present invention also includes a configuration in which the liquid crystal panel and the chassis are vertically disposed with their long side directions aligned with the vertical direction.

(19) In the foregoing embodiments, as the switching elements of the liquid crystal display device, TFTs are used. The present invention, however, may be applied to liquid crystal display devices using switching elements other than TFTs (such as thin-film diodes (TFD)). Further, the present invention may be applied not only to a liquid crystal display device for color display but also to a liquid crystal display device for monochrome display.

(20) While in the foregoing embodiments liquid crystal display devices using a liquid crystal panel as a display panel has been described by way of example, the present invention may be applied to display devices using other types of display panels.

(21) While in the foregoing embodiments a television receiver with a tuner has been described by way of example, the present invention may be applied to a display device without a tuner.

### EXPLANATION OF SYMBOLS

10, 110: Liquid crystal display device (Display device)
11, 116: Liquid crystal panel (Display panel)
11a: CF substrate (Substrate)
11b: Array substrate (Substrate)
11c: Liquid crystal layer (Substance; Liquid crystal)
12, 124: Backlight unit (Lighting device)
19: Color filter
24, 224: LED (Light source)
24a: Blue LED chip (LED element; Blue LED element)
26: Light guide member
26b: Light entrance surface
28: First reflection sheet (Reflection member)
29: Second reflection sheet (Reflection member)
30: Lens member
31: Cold cathode tube (Light source)
32: NTSC chromaticity region
33: EBU chromaticity region
34: Common region
120: Light guide plate (Light guide member)
132: LED unit (Light source; LED)
R: Red color section
G: Green color section
B: Blue color section
Y: Yellow color section
T: Tuner (Reception unit)
TV: Television receiver
VC: Image conversion circuit

1. A display device comprising:
a display panel including a pair of substrates with a substance therebetween, the substance having optical characteristics that vary according to application of an electric field; and
a lighting device including a light source and configured to emit light toward the display panel,
wherein:
the lighting device includes a light guide member with an end opposed to the light source;
the light guide member is configured to guide the light from the light source toward the display panel; and
one of the substrates in the display panel includes a color filter including a plurality of respective blue, green, red, and yellow color sections, the blue or red color section having a relatively large area compared to the yellow or green color section.

2. The display device according to claim 1, wherein the blue or red color section has an area ratio in a range from 1.1 to 2.0 to the yellow or green color section.

3. The display device according to claim 2, wherein the area ratio is in the range from 1.1 to 1.62.

4. The display device according to claim 3, wherein the area ratio is in the range from 1.3 to 1.62.

5. The display device according to claim 4, wherein the area ratio is in the range from 1.5 to 1.6.

6. The display device according to claim 5, wherein the area ratio is 1.6.

7. The display device according to claim 5, wherein the area ratio is 1.5.

8. The display device according to claim 4, wherein the area ratio is in the range from 1.4 to 1.5.

9. The display device according to claim 8, wherein the area ratio is 1.46.

10. The display device according to claim 3, wherein the area ratio is in the range from 1.1 to 1.46.

11. The display device according to claim 2, wherein the area ratio is in the range from 1.46 to 2.0.

12. The display device according to claim 11, wherein the area ratio is 2.0.

13. The display device according to claim 1, wherein the area of the blue color section is the same as the area of the red color section.

14. The display device according to claim 1, wherein the area of the yellow color section is the same as the area of the green color section.

15. The display device according to claim 13, wherein the respective color sections have substantially the same film thickness.

16. The display device according to claim 1, wherein the light source is a cold cathode tube.

17. The display device according to claim 1, wherein the light source is an LED.

18. The display device according to claim 17, wherein the LED includes an LED element as a light configured to emit source and a phosphor emitting light upon excitation by light from the LED element.

19. The display device according to claim 18, wherein:
the LED element includes a blue LED element configured to emit blue light; and
the phosphor includes at least one of a green phosphor emitting green light upon excitation by the blue light and a yellow phosphor emitting yellow light upon excitation by the blue light, and a red phosphor emitting red light upon excitation by the blue light.

20. The display device according to claim 19, wherein at least one of the green phosphor and the yellow phosphor includes a SiAlON-based phosphor.

21. The display device according to claim 20, wherein the green phosphor includes a β-SiAlON.

22. The display device according to claim 20, wherein the yellow phosphor includes an α-SiAlON.

23. The display device according to claim 19, wherein the red phosphor includes a CASN-based phosphor.

24. The display device according to claim 23, wherein the red phosphor includes a CASN (CaAlSiN3:Eu).

25. The display device according to claim 19, wherein at least one of the green phosphor and the yellow phosphor includes a YAG-based phosphor.

26. The display device according to claim 19, wherein the yellow phosphor includes a BOSE-based phosphor.

27. The display device according to claim 17, wherein:
the light guide member includes an elongated light entrance surface on an end facing the LED;
the LED includes a lens member covering a light output side of the LED and diffusing light; and
the lens member is opposed to the light entrance surface of the light guide member and curved along the longitudinal direction of the light entrance surface to be convex toward the light guide member.

28. The display device according to claim 1, wherein the color filter is configured such that the chromaticity of blue, green, red, or yellow transmitted light obtained by passing the light from the light source through the color sections of the color filter is outside a common region of a NTSC chromaticity region according to a NTSC standard and a EBU chromaticity region according to a EBU standard in at least one of a CIE1931 chromaticity diagram and a CIE1976 chromaticity diagram.

29. The display device according to claim 1, wherein:
the light guide member includes an elongated light entrance surface on an end facing the light source; and
the lighting device includes a reflection sheet between the light source and the light guide member along the longitudinal direction of the light entrance surface.

30. The display device according to claim 1, wherein the light guide member includes a substance with a refractive index higher than that of air.

31. The display device according to claim 1, wherein the display panel is a liquid crystal panel including liquid crystal as the substance of which the optical characteristics vary by application of an electric field.

32. A television receiver comprising:
the display device according to claim 1; and
a reception unit configured to receive a television signal.

33. The television receiver according to claim 32, further comprising an image conversion circuit configured to convert a television image signal output from the reception unit into an image signal for the respective colors of blue, green, red, or yellow.
